(19) United States
(12) Patent Application Publication
(10) Pub. No.: US 2021/0216928 A1
(43) Pub. Date: Jul. 15, 2021

(54) SYSTEMS AND METHODS FOR DYNAMIC RISK ANALYSIS

(71) Applicant: Johnson Controls Technology Company, Auburn Hills, MI (US)

(72) Inventors: Eamonn O'Toole, Ballincollig (IE); Leon Frans Van Gendt, Cork (IE); Jane Delaney, Ballyphehane (IE); Andrew Keane, Killarney (IE); Geentanjali Singh, Cork (IE); Timothy Flood, Auburn Hills, MI (US); Aidan Casey, Cork (IE)

(73) Assignee: Johnson Controls Technology Company, Auburn Hills, MI (US)

(21) Appl. No.: 17/147,328

(22) Filed: Jan. 12, 2021

Related U.S. Application Data
(60) Provisional application No. 62/960,605, filed on Jan. 13, 2020.
(60) Provisional application No. 63/039,167, filed on Jun. 15, 2020.

(51) Int. Cl. G06Q 10/06; G06F 16/2457; G06F 16/28; G06F 16/29

(52) U.S. Cl. CPC G06Q 10/0635; G06F 16/29; G06F 16/287; G06F 16/24575

(57) ABSTRACT

A risk management system includes one or more computer-readable storage media having instructions stored thereon that, when executed by one or more processors, cause the one or more processors to perform natural language processing to categorize threats to assets and perform correlated risk analyses for threats. The instructions cause the one or more processors generate risk scores for assets using threat data and one or more asset risk profiles reflecting characteristics of the assets, the risk scores weighted based on impact weights of threats. Furthermore, the instructions cause one or more processors to generate a plurality of graphic user interfaces including one or more of a map providing visual representations of the assets, locations of the assets, asset risk scores, and threats to assets, a forecast of asset risk scores, an asset summary, an asset risk profile editor, and a consolidated view of rank ordered assets and threats.

### CROSS-REFERENCE TO RELATED PATENT APPLICATIONS

This application claims the benefit of and priority to U.S. Provisional Application No. 62/960,605 filed Jan. 13, 2020 and U.S. Provisional Application No. 63/039,167 filed Jun. 15, 2020, the entirety of each of which is incorporated by reference herein.

### BACKGROUND

The present disclosure relates generally to risk management systems for assets (e.g., buildings, building sites, building spaces, people, cars, equipment, etc.). The present disclosure relates more particularly to risk management systems and methods for responding to alerts, analysis of alerts as indications of threats affecting assets, asset risk analytics, and mitigation of risks to assets.

Many risk management platforms provide threat information to operators and analysts monitoring all the activities and data generated from building sensors, security cameras, access control systems, fire detection systems, media reporting etc. The data may be an alert, or may be indicative of an event that may pose a risk to a class of assets, or even a particular asset (e.g., a bomb threat). Furthermore, the data may be external, e.g., data from data sources reporting potential threats e.g., violent crimes, weather and natural disaster reports, traffic incidents, robbery, protests, etc. However, due to the volume of data for the activities and the dynamic nature of the activities, a large amount of resources are required by the risk management platform to process the data. Since there may be many alerts and threat events, not only does the security platform require a large amount of resources, a high number of security operators and/or analysts are required to review and/or monitor the various different alerts and threat events to assess risks posed to assets.

### SUMMARY

One implementation of the present disclosure is a risk management system including one or more computer-readable storage media having instructions stored thereon that, when executed by one or more processors, cause the one or more processors to: receive threat data indicating potential threats to one or more of a plurality of assets located in a plurality of geographic locations, the plurality of assets comprising at least one of buildings, spaces, equipment, or people; calculate asset risk scores for the plurality of assets indicating estimated risk levels for the assets using asset risk profiles for the assets and using the threat data, the asset risk profiles reflecting characteristics of their respective assets; and generate a graphical user interface comprising a map providing visual representations of one or more of the assets, the visual representations of the one or more of the assets indicating locations of the assets and asset risk scores of the assets.

In some embodiments, the risk management system includes one or more computer-readable storage media having instructions stored thereon that, when executed by one or more processors, cause the one or more processors to: receive threat data indicating potential threats to one or more of a plurality of assets located in a plurality of geographic locations, the plurality of assets comprising at least one of buildings, spaces, equipment, or people; calculate asset risk scores for the plurality of assets indicating estimated risk levels for the assets using asset risk profiles for the assets and using the threat data, the asset risk profiles reflecting characteristics of their respective assets; and generate a graphical user interface comprising a map providing visual representations of one or more of the assets, the visual representations of the one or more of the assets indicating locations of the assets and asset risk scores of the assets.

In some embodiments, the map includes a visual representation of one or more of the potential threats, the visual representation of the one or more potential threats comprising a radius representing an estimated spatial impact of the threat.

In some embodiments, graphical user interface includes a portion providing an asset summary for a first asset of the plurality of assets, the asset summary providing the asset risk score of the first asset and a trend indicating a change in the asset risk score of the first asset.

In some embodiments, the graphical user interface includes a portion providing a current asset risk score for the asset and a risk score trend for the asset illustrating the asset risk scores for one or more prior times of the plurality of times of the timeframe

In some embodiments, the graphical user interface further includes a portion displaying an ordered list of one or more of the potential threats, the list comprising a threat location and a risk score of the potential threats in relation to the assets affected by the potential threats.

In some embodiments, the asset risk score for the asset is calculated over a plurality of times over a timeframe, the asset risk score indicating estimated risk levels for the asset at the plurality of times, the asset risk profile reflecting characteristics of the asset.

Another implementation of the present disclosure is a risk management system including one or more computer-readable storage media having instructions stored thereon that, when executed by one or more processors, cause one or more processors to: receive threat data indicating a plurality of potential threats to an asset, the asset comprising a building, space, equipment, or person; generate, using the threat data and an asset risk profile for the asset, an asset risk score for the asset at a plurality of times over a timeframe, the asset risk score indicating estimated risk levels for the asset at the plurality of times, the asset risk profile reflecting characteristics of the assets; and generate a graphical user interface comprising, within a single screen, a current asset risk score for the asset and a risk score trend for the asset illustrating the asset risk scores for one or more prior times of the plurality of times of the timeframe.

Another implementation of the present disclosure is a risk management system including one or more computer-readable storage media having instructions stored thereon that, when executed by one or more processors, cause one or more processors to: receive threat data indicating potential threats to one or more of a plurality of assets, the potential threats associated with a plurality of threat categories and the plurality of assets comprising at least one of buildings, spaces, equipment, or people; generate risk scores indicating estimated risk levels for the plurality of assets using the threat data, wherein the risk scores are calculated based on data registered in one or more asset risk profiles configured for each of the plurality of assets, the one or more asset risk profiles containing a plurality of characteristics of the asset, the plurality of characteristics of the asset being parameterized in a risk score calculation process; and generate a graphical user interface comprising, within a single interface, a consolidated view of risks and threats displaying two or more of the plurality of threat categories and, for each of the two or more categories, a list of one or more assets impacted by a potential threat associated with the threat category and a risk score for each of the one or more assets, the list of one or more assets ordered based on the risk scores of the assets.

Another implementation of the present disclosure is a risk management system including one or more computer-readable storage media having instructions stored thereon that, when executed by one or more processors, cause one or more processors to: create an asset risk profile for an asset comprising a plurality of threat types and an impact weight for each threat type, the risk profile reflecting characteristic of the asset, the asset comprising a building, space, equipment, or person; receive a user modification of a first impact weight for a first threat type of the plurality of threat types; modify the first impact weight according to the user modification to generate a first modified impact weight; receive threat data indicating potential threats to the asset, the potential threats associated with a set of two or more of the plurality of threat types, the set of two or more threat types including the first threat type; and generating an asset risk score for the asset using the threat data and the asset risk profile, the asset risk score reflecting characteristics of the asset, by weighting risk scores associated with the potential threats based on the impact weights of the threat types of the set of two or more threat types, including the first modified impact weight.

Another implementation of the present disclosure is a risk management system including one or more computer-readable storage media having instructions stored thereon that, when executed by one or more processors, cause one or more processors to: receive threat data indicating a plurality of potential threats to an asset predicted to occur at a future time, the asset comprising a building, space, equipment, or person; generate, using the threat data and an asset risk profile for the asset, risk scores for the asset at a future time associated with the potential threats, the risk scores indicating an estimated risk level for the asset based on the potential threats at the future time, the asset risk profile reflecting characteristics of an asset; and generate a graphical user interface comprising, for a particular timeframe including the future time, a list of the potential threats and the associated risk scores of the potential threats for the asset.

Another implementation of the present disclosure is a risk management system including one or more computer-readable storage media having instructions stored thereon that, when executed by one or more processors, cause one or more processors to: receive event data indicating a plurality of future events occurring at a future time; generate, using the event data and an asset risk profile, risk scores for an asset at the future time associated with the future events, the risk scores indicating an estimated risk level for the asset based on the future events, the asset comprising a building, space, equipment, or person, the asset risk profile reflecting characteristics of the asset; and generate a graphical user interface comprising, for a particular timeframe including the future time, a list of the future events and the associated risk scores of the future events for the asset.

Another implementation of the present disclosure is a risk management system including one or more computer-readable storage media having instructions stored thereon that, when executed by one or more processors, cause one or more processors to generate a user interface for asset security posture assessment, within a single interface, comprising one or more of: a portion displaying an assessment status, a portion displaying an asset summary; a portion displaying a risk summary, wherein the risk summary includes one or more asset risk profiles, the asset risk profiles containing a plurality of characteristics of the asset, the plurality of characteristics of the asset being parameterized in a risk score calculation process; a risk score trend visualization comprising indications of events corresponding to particular historic risk scores under a selected risk profile; a portion displaying an incident summary; a portion displaying a mitigation task list; or a portion displaying a review and approval assignment list.

In some embodiments, the risk trend visualization comprising indications of events corresponding to particular historic risk scores under a selected risk profile displays indications of events corresponding to particular historic risk scores are correlated to peaks in a graph of the risk score as a function of time displayed.

Another implementation of the present disclosure is a method of assigning a relative threat impact ranking to an asset threat, including: aggregating threat scores and risk scores for a set of asset threats to calculate threat impact scores; defining a set of percentile ranges from a frequency distribution of the threat impact scores; determining a set of threshold impact scores corresponding to the set of percentile ranges, the thresholds defining ranges of threat impact scores; associating each range of threat impact scores to a value on an ordinal scale of threat impacts; determining that a threat has a particular relative threat impact, based on a determination that the threat's impact score falls within the impact score range of a corresponding value on the ordinal scale; ranking each threat for relative threat impact by its value on the ordinal scale; and displaying the relative threat impacts of a set of threats in a user interface.

Another implementation of the present disclosure is a method for scoring a threat to an asset including receiving data for an alert relating to an asset threat; identifying an external data source of the data for the alert data relating to the asset threat; mapping, based on the identification of the data source, a metadata element of the data for the alert relating to the asset threat to an internal data property of a threat model; and associating a value of the metadata element with a pre-determined value for the internal data property of the threat model, wherein the internal data property of the threat model relates to a likelihood of a threat being real.

In some embodiments, the method includes determining a relative threat impact score to the asset threat by aggregating threat scores and risk scores for a set of asset threats.

In some embodiments, the method includes grouping of alert data from a plurality of received alerts relating to an asset to define a single threat to the asset, wherein a first received alert is grouped with a second received alert according to a clustering analysis of one or more of an alert spatial parameter and an alert temporal parameter of each received alert.

In some embodiments, the method includes constraining the clustering analysis by applying a set of neighbor parameters, the set of neighbor parameters defined in respect of a pre-defined threat category.

Another implementation of the present disclosure is a method of aggregating a set of threat and risk scores relating to assets including: ranking the set of scores by descending order of magnitude; ranking the set of scores by descending order of magnitude; assigning each score a numerical value, starting at zero for the highest ranked score and increasing by 1 for each subsequent lower ranked score; multiplying each score by e^{-rank}-rank, where rank is a score's assigned numerical value; and summing each product to calculate a single amalgamated score.

Another implementation of the present disclosure is method of grouping alert data to define a single threat to an asset including: defining, in respect of a pre-defined threat sub-category, a set of neighbor parameters consisting of a spatial parameter and a time parameter; extracting from a received alert, a threat sub-category, a location data, and a time data; applying the neighbor parameters to constrain a clustering analysis of the alert with previously processed alerts in the same sub-category; determining, by the clustering analysis, the number of neighbor alerts; and assigning the alert to a group of alerts, based on the determined number of neighbor alerts.

In some embodiments, the method includes creating a group for the alert, based on a determination that the number of neighbors is zero.

In some embodiments, the method includes assigning the alert to an existing alert group, based on a determination that the alert has one neighbor.

In some embodiments, the method includes, upon a determination that an alert has more than one neighbor, performing a further analysis of grouping options based on finding the lowest total error value for different clusters representing alternative alert group assignments.

Another implementation of the present disclosure is a method for categorizing alerts of threats to assets using natural language processing, including defining a set of main keywords from a set of alerts; from the set of main keywords, associating a set of generic keywords with each of a set of pre-defined threat sub-categories; from the set of main keywords, associating a set of stemmed keywords with each of the set of pre-defined threat sub-categories; searching the text of a received alert to identify a match with a generic keyword; based on generic keyword matches, identifying a subset of the set of pre-defined threat sub-categories; for each of the subset of pre-defined threat sub-categories, searching the text of the received alert to identify matches to one or more of the stemmed keywords associated with the pre-defined threat sub-category; for each of the subset of pre-defined threat sub-categories, performing a cosine similarity analysis on the alert text using the set of stemmed keywords associated with the pre-defined threat sub-category as a vector embedding sentence and the set of main keywords as a document; from the cosine similarity analysis, determining that one of the pre-defined threat sub-categories has the highest cosine similarity score in respect of the received alert; and classifying the alert as belonging to the pre-defined threat sub-category with the highest cosine similarity score.

In some embodiments, the method includes associating the set of stemmed keywords based on user defined keywords related to each of the set of pre-defined threat sub-categories.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of a system including a risk analytics system for handling threats via a risk analysis system including a data ingestion service, a geofence service, and a risk analytics pipeline (RAP), according to an exemplary embodiment.

FIG. 2 is a block diagram illustrating the data ingestion service of the risk analytics system of FIG. 1 in greater detail, according to an exemplary embodiment.

FIG. 3 is a flow diagram of a process that can be performed by the data ingestion service of FIG. 2 to ingest threats received from multiple different data sources, according to an exemplary embodiment.

FIG. 4 is a block diagram illustrating the RAP of the risk analysis system of FIG. 1 in greater detail, according to an exemplary embodiment.

FIG. 5 is a block diagram illustrating the mapping of threats from multiple different data sources to a standardized category format, according to an exemplary embodiment.

FIG. 6 is a block diagram of a natural language processing (NLP) engine of the data ingestion service of FIG. 2, according to an exemplary embodiment.

FIG. 7 is a flow diagram of a process that can be performed by the NLP engine of FIG. 6 of training a classification model for the NLP engine, according to an exemplary embodiment.

FIG. 8 is a schematic diagram of an interface for labelling data for training the NLP engine of FIG. 6, according to an exemplary embodiment.

FIG. 9 is a schematic diagram of an interface for logging a user into a labelling tool for tracking the labeling of users for training the NLP engine of FIG. 6, according to an exemplary embodiment.

FIG. 10 is a flow diagram of a process for assigning threats to threat categories by performing a similarity analysis that can be performed by the NLP engine of FIG. 6, according to an exemplary embodiment.

FIG. 10A is a diagram of an example of a set of alert categories from an alert data provider, according to an exemplary embodiment.

FIG. 10B is a flow diagram of a process for building an NLP classifier for matching alerts with system sub-categories, according to an exemplary embodiment.

FIG. 10C is a diagram showing an example of a classification analysis of an alert, according to an exemplary embodiment.

FIG. 10D is a further diagram showing an example of a classification analysis of an alert, according to an exemplary embodiment.

FIG. 11 is a flow diagram of a process for training a model for predicting an expiry time for a threat that can be performed by the data ingestion service of FIG. 2, according to an exemplary embodiment.

FIG. 12 is a chart illustrating a number of recorded threats with different expiry time classes, according to an exemplary embodiment.

FIG. 13 is a block diagram of a cross-correlator of the data ingestion service of FIG. 2 grouping similar threats reported by different data sources, according to an exemplary embodiment.

FIG. 14 is a flow diagram of a process for cross-correlating similar threats reported by different data sources that can be performed by the cross-correlator of FIG. 13, according to an exemplary embodiment.

FIG. 14A is a block diagram of a system for risk analysis and alert grouping, according to an exemplary embodiment.

FIG. 14B is a process flow diagram illustrating an overall process for assigning alerts to alert groups based on alert sub-category, according to an exemplary embodiment.

FIG. 14C is a process flow diagram illustrating a more detailed process for assigning a new alert to an alert group based on alert sub-category and the spatial and temporal data of an alert, according to an exemplary embodiment.

FIG. 14D is a process flow diagram illustrating in more detail a process for analyzing clusters of spatial and temporal data of alerts in order to assign a new alert to a neighbor alert group, according to an exemplary embodiment.

FIG. 15 is a flow diagram of a process for performing geofencing to determine whether a threat affects an asset that can be performed by the geofence service of FIG. 1, according to an exemplary embodiment.

FIG. 16 is a schematic drawing of a city with multiple assets and threats, each asset being associated with a geofence, according to an exemplary embodiment.

FIG. 17 is a vulnerability-threat (VT) matrix illustrating vulnerability levels for particular assets based on different types of threats, according to an exemplary embodiment.

FIG. 18A is a block diagram of a risk engine for determining risk values with a threat, vulnerability, and cost (TVC) model, according to an exemplary embodiment.

FIG. 18B is a block diagram of the RAP of FIG. 1 including a weather service configured to adjust threat parameters of dynamically generated risk scores based on weather data, according to an exemplary embodiment.

FIG. 18C is a block diagram of the RAP of FIG. 1 including the weather service of FIG. 18B and a weather threat analyzer, the weather threat analyzer configured to generate a combined risk score for multiple weather threat, according to an exemplary embodiment.

FIG. 18D is a block diagram of the RAP of FIG. 1 including the weather service of FIG. 18B and a weather threat analyzer, the weather threat analyzer configured to analyze historical data to generate a risk score for anomalous weather threat events, according to an exemplary embodiment;

FIG. 18E is a flow diagram of a process for generating a risk score based on multiple weather threat events that can be performed by the weather service of FIG. 18B, according to an exemplary embodiment.

FIG. 18F is a flow diagram of a process for generating a risk score for an anomalous weather threat event based on historical data analysis that can be performed by the weather threat analyzer of FIG. 18D, according to an exemplary embodiment.

FIG. 19 is a schematic drawing of a user interface for modifying the VT matrix of FIG. 17, according to an exemplary embodiment.

FIG. 20 is a flow diagram of a process for decaying risk values over time and determining a baseline risk value that can be performed by the RAP of FIG. 4, according to an exemplary embodiment.

FIG. 21 is a chart illustrating risk scores over time without decaying the risk values, according to an exemplary embodiment.

FIG. 22 is a chart illustrating risk scores being decayed over time, according to an exemplary embodiment.

FIG. 23 is a chart illustrating an exponential risk decay model for decaying risk that can be used in the process of FIG. 20, according to an exemplary embodiment.

FIG. 24 is a chart illustrating a polynomial risk decay model for decaying risk that can be used in the process of FIG. 20, according to an exemplary embodiment.

FIG. 25 is a schematic drawing of a user interface including information for an asset and a threat, a dynamic risk score, and a baseline risk score, according to an exemplary embodiment.

FIG. 26 is a schematic drawing of a user interface providing information for an asset and threats affecting the asset, according to an exemplary embodiment.

FIG. 27 is a schematic drawing of a risk card for a user interface, the risk card indicating dynamic risk score and a baseline risk score, according to an exemplary embodiment.

FIG. 28 is a schematic drawing of a user interface including multiple threats dynamically sorted by risk score, according to an exemplary embodiment.

FIG. 29 is another schematic drawing of the user interface of FIG. 28 illustrating threats being dynamically sorted over other threats based on risk score, according to an exemplary embodiment.

FIG. 30 is a schematic drawing of a user interface for a global risk dashboard including threat metrics, geographic risk, threat information, and asset information, according to an exemplary embodiment.

FIG. 31 is a schematic drawing of a user interface including a dynamic risk score trend and a baseline risk score trend, according to an exemplary embodiment.

FIG. 32 is a schematic drawing of a user interface of a risk dashboard indicating threats impacting assets by grouping, sorting, and forecasting, according to an exemplary embodiment.

FIG. 33 is a schematic drawing of a user interface including comments from other security advisors and a list of top assets impacted by threats, according to an exemplary embodiment.

FIG. 34 is a schematic drawing of a user interface for a risk visualization indicating threats impacting assets by location of assets and magnitude of risk score, according to an exemplary embodiment.

FIG. 35 is a schematic drawing of the user interface of FIG. 34, showing a separate overlay viewing area of the key risk details and threat event information generated in response to a user selection of an asset from the map, according to an exemplary embodiment.

FIG. 36 is a schematic drawing of a user interface for an asset details overview showing asset risk score, threats to the asset, graphic depiction of asset threat timeline, and asset points of contact, according to an exemplary embodiment.

FIG. 37 is a schematic drawing of a user interface for an asset details overview showing a separate viewing area of threat event details generated in response to a user selection of a threat event on the asset threat timeline, according to an exemplary embodiment.

FIG. 38 is a schematic drawing of a user interface for a top asset risk score overview ordered by magnitude of risk score, according to an exemplary embodiment.

FIG. 39A is schematic drawing of an alternate user interface, optimized for display on a mobile device, for a top asset risk overview ordered by magnitude of risk score, according to an exemplary embodiment.

FIG. 39B is a schematic drawing of an asset summary card for a user interface generated as a separate viewing area by a user selection of an asset displayed within the top asset risk overview user interface, according to an exemplary embodiment.

FIG. 40 is a schematic drawing of a user interface for top threats overview ordered by severity of threat, according to an exemplary embodiment.

FIG. 40A is a schematic drawing of a user interface including information for a set of threats ranked by threat impact, according to an exemplary embodiment.

FIG. 41. is a schematic drawing of a user interface for a threat summary card, according to an exemplary embodiment.

FIG. 42. is a schematic drawing of a user interface for an asset summary generated as a separate viewing area by a user interaction with the top threats overview user interface, according to an exemplary embodiment.

FIG. 43 is a schematic drawing of a user interface for a threat information panel generated as a separate viewing area by a user interaction with the threat summary card user interface, according to an exemplary embodiment.

FIG. 44 is a schematic drawing of a user interface for a risk forecast, according to an exemplary embodiment.

FIG. 45 is a schematic drawing of a user interface for a risk forecast upcoming event summary, according to an exemplary embodiment.

FIG. 46 is a schematic drawing of a user interface for a risk forecast forecasted threat summary, according to an exemplary embodiment.

FIG. 47 is a flow diagram of a process for generating a risk profile, according to an exemplary embodiment.

FIG. 48 is a schematic drawing of a user interface for a risk profile editor, according to an exemplary embodiment.

FIG. 49 is a schematic drawing of a user interface for a security posture assessment of an asset, according to an exemplary embodiment.

FIG. 50 is a another schematic drawing of the user interface of FIG. 49 illustrating an expanded mitigation tasks section for a security posture assessment of an asset, according to an exemplary embodiment.

FIG. 51 is a flow diagram of a process for calculation of a risk score for an asset, according to an exemplary embodiment.

FIG. 52 is a flow diagram process for calculation of a risk score for an asset of FIG. 51 in greater detail, according to an exemplary embodiment.

FIG. 53 is a flow diagram of a set of sub-processes for mapping alert metadata to internal data values, according to an exemplary embodiment.

FIG. 54 is a flow diagram of a process for mapping alert metadata to internal threat model properties through the use of a decision tree, according to an exemplary embodiment.

FIG. 55 is a flow diagram of a process to amalgamate scores for alerts, threats, and risks, according to an exemplary embodiment.

FIG. 56 is a process flow diagram of an example process for calculating an amalgamated data score, according to an exemplary embodiment.

### DETAILED DESCRIPTION

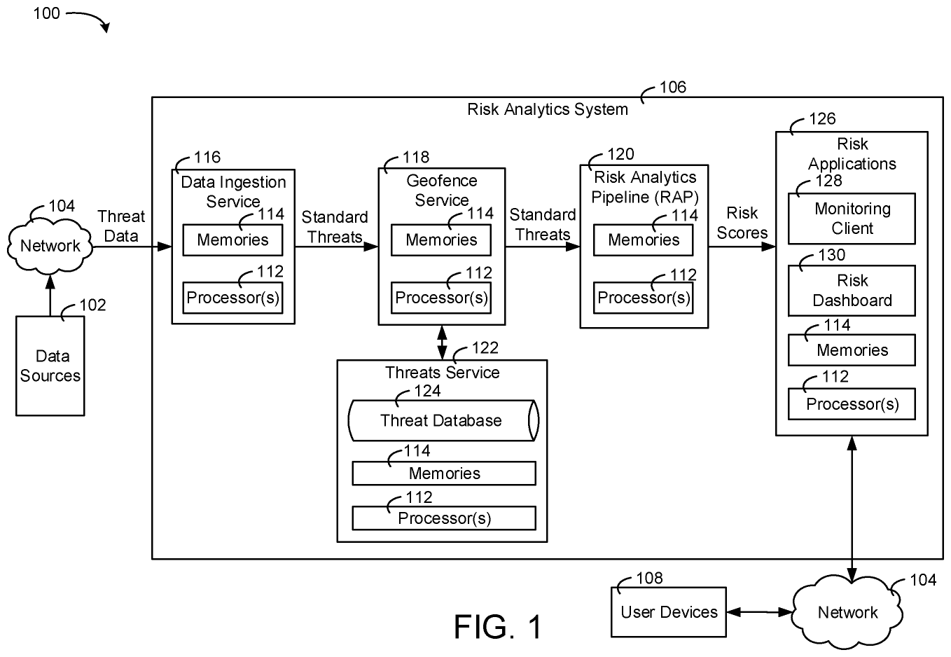

FIG. 1 is a drawing of an example user interface for regional risk view 100. A region may be a global region, a country, or a smaller area, such as a state or city. Regional risk view 100 includes a region map 101, a top threats list 102, displaying the top threats affecting assets in the selected region, and a panel displaying key location summary cards 103 relating to locations a user may select for ongoing monitoring.

Map 101 displays asset location points 106 and 107 corresponding to the locations of each asset in the selected region, together with one or more threat location points 104 and 105. Asset location points 106 and 107 and threat location points 104 and 105 may be displayed in different colors, indicating different risk levels (for example, using a RAG coloring system). Asset location points 106 and 107 also include risk scores, which may be displayed as text (such as a numerical risk score or other description of risk) or icons. Threat location points 104 and 105 may include graphical indications 108 and 109 of a radius surrounding the threat. The size of a radius is determined by the maximum area of influence for the threat. Different methods of displaying assets, threats, and risk scores in a regional map view are possible: the primary function of the regional risk view is to give monitoring personnel a single-pane overview of the risk position across a region. In other embodiments of the UI, other functionality may be provided, such as a time slider to view the risk and threat position on the map at different points in time, the ability to turn on or off hidden threats, and functionality for a user to adjust or relax the criteria for overlapping alerts and threats.

Asset risk scores are determined by a risk analysis platform, which uses various techniques to correlate threat data with an asset and aggregate the threat data to calculate a risk score.

Top threats list 102, displays a list of the threats associated with assets that have the highest risk score in the selected region. This list of threats associated with assets is an output of the risk analysis platform. The information on the list includes a description of the threat 110 (e.g., chemical spill, thunderstorm, violent crime etc.), the location (e.g., city and country) of the threat 111, the number of assets affected by the threat 112, the distance of the threat from the nearest asset 113, and an amalgamated risk score for the affected assets 114, together with a graphical element indicating a risk score 115, which may be a colored icon (e.g., using a RAG methodology) or some other iconographic representation of risk level. The list of threats 102 may be ordered in different ways, for example, in order of descending risk score, number of assets affected, alphabetically, by threat type, or may not be in any particular order.

A user may select an individual listed threat 116, and expand the entry to view the list of assets affected by the threat. In this expanded view, the user may view the asset type or description 117, a selectable link to view detailed information about the asset in question 118, the distance of the asset from the relevant threat 119, and the asset's risk score 120. Alternative embodiments of the display may use iconography to indicate threat categories and asset types. Regional risk view 100 may also include useful interactive features, such as a hover-over, transient information element 121 showing an elapsed time since threat data was received.

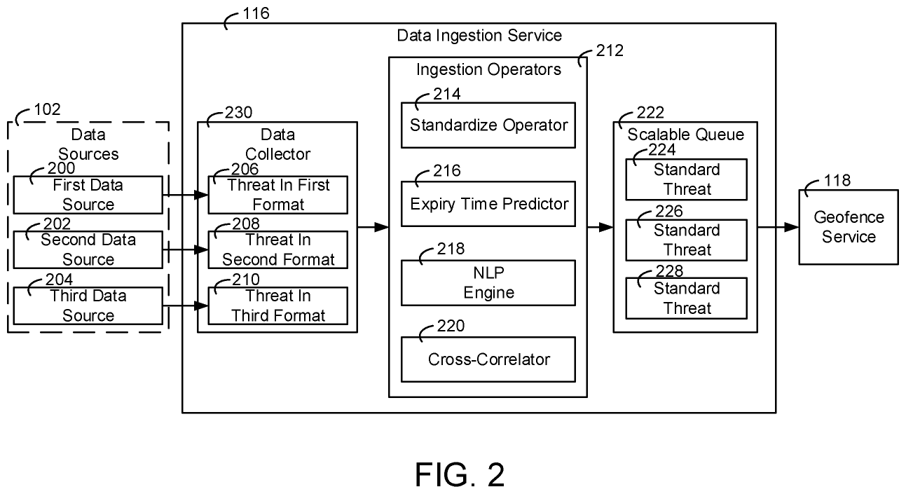

FIG. 2 is a further drawing of the user interface 100 of FIG. 1, showing a user's cursor hovering over asset location icon 200 in the regional risk view, causing asset risk summary panel 201 to display. Asset risk summary panel 201 includes the asset's name 202, type (e.g., office, employee, etc.) 203, the current time in the time zone applicable to the asset 204, the asset's location 205, information about the main threat contributing to that asset's risk score (e.g., the category of the threat, such as ‘security’, and the type of threat, such as ‘planned protest’) 206, the asset's risk score 207, which may include various graphical indicators of risk level or change, and the distance of the asset from the threat that the risk analysis platform has determined to be the most significant 208.

Key location summary cards 209 are the same key location summary cards 103 of FIG. 1. The disclosed system allows a user to configure the regional user interface view so that summary risk information about one or more key locations is maintained in the display. A user may ‘pin’ and ‘unpin’ key location summary cards 209 to the display, depending on the information they want to see. This allows the user to navigate through the regional map view, while key location summary cards 209 remain on screen, displaying location risk information, such as, location name (e.g., city, country) 210 and a current risk score for the location 211. Location risk score 211 may be an average of the risk scores of all assets in the location, the highest asset risk score for the location, or it may be calculated on some other basis using the asset risk scores for that location. The risk analysis platform scores assets for risk using different risk profiles. Risk profiles are different vulnerabilities of an asset to particular types of outcome (vulnerability*consequence). Examples of risk profiles include life safety, asset protection, business continuity, and business reputation. Location risk score 211 may be a general score or a score for a particular risk profile. Key location summary cards 209 also display risk trend information 212, indicating changes in location risk by using icons (e.g., arrows), numbers, text, or colors. A graphical or textual indication of a risk profile is displayed for each location. For example, a user may have configured the view to show risk information for some locations in the life safety risk profile category 213, for other locations in the asset protection category 214, and for yet other locations in the asset protection category 215.

In relation to moving assets, a local or regional map view may include a route plan showing anticipated risk at key points along the route, a reroute (plan B) with anticipated risk at key points along the route, a periodic update to the current map location of the moving asset, an overlay of traffic congestion areas on the map, an overlaid transit layer on the map showing nearby public transport stations, and other features useful for travelers and other moving assets. Data from external map provider services may be used.

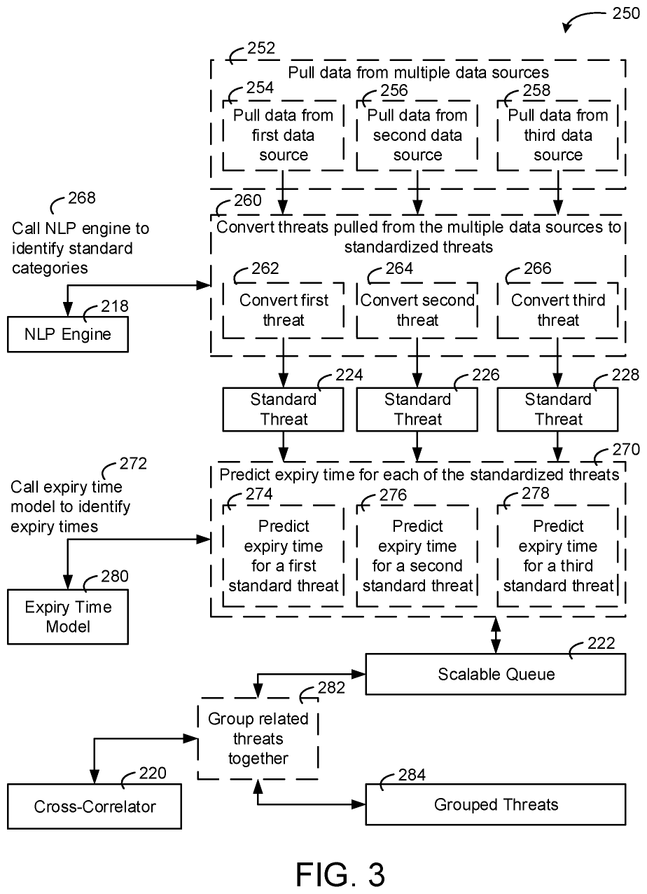

FIG. 3 is a drawing of a user interface displaying detailed risk information about a monitored asset. A user may select link 118 of FIG. 1 to access a detailed view of the relevant asset, or select the asset details view in some other manner through the UI.

Asset risk view 300 displays comprehensive and detailed risk information for the selected asset. Relevant data is taken from the risk analysis platform and presented on cards displaying the asset's details 301, information about the top threats affecting the asset 302, a summary of the asset's current risk status 303, asset risk timeline information 304, asset point of contact details 305, and information about planned or forecast events affecting the asset 306.

Asset detail card 301 contains information such as asset name, asset image, asset type, asset location or address, current local time, and asset occupancy (e.g., a maximum occupancy value or a dynamic relative occupancy value from an occupancy model).

Top threats card 302 displays information relating to the top external and internal threats (including alarms) affecting the asset and the asset's general risk scores associated with those threats, as well as risk trend information. Alternatively, top threat information could be filtered by risk profile, so that only top threats relating to, say, life safety could be displayed.

Asset risk card 303 contains a current asset risk score (which may be the highest of a number of different risk scores for different risk profiles), one or more risk profile icons (indicating a risk profile, such as life safety, business continuity etc.), risk scores for each risk profile, and risk trend information, using icons (e.g., arrows), numbers, colors, or text. Various graphics and iconography may be used, such as risk profile icons and graphical indications of risk level.

Asset risk timeline card 304 contains a line graph of historical, current, and upcoming threats affecting the asset that impacted the asset's risk score. Asset risk timeline card 304 shows the changes in an asset's risk score over time, with significant threats marked. Each threat is associated with an asset risk score. A user can filter the information to show risk for one or more risk profiles. For example, a user may wish to view an asset's risk timeline with an interest in understanding the asset's business continuity risk. Alternatively, a user may wish to compare the asset's risk history for business continuity with the same asset's general risk history, or its history in another risk profile, such as life safety. In such cases, the risk timeline card 304 may show two or more lines on the same graph, for comparison of risk histories. In the example timeline card shown, the current date is to the right hand side of the graph (i.e., Nov. 10, 2019) and the information displayed is historical. In alternative embodiments, the graph may also display future forecast or predicted risk scores and associated threats. The current date may be indicated on such a graph by means of a horizontal line or other indication. The timeline window may be configured by the user. A horizontal dotted line (or some other indication) on the graph may indicate the asset's typical risk score. This could be the asset's mean or median daily risk score for a relevant period. The indication of typical risk score provides the user with information of where an asset's current risk stands in relation to past and future risk. Alternatively, the graph may show a line or other indication showing an asset's minimum or maximum risk score over a relevant period, again for comparison. The user may click on a point on the timeline and the user interface changes to reflect the risk and threat data at that point in time.

Asset point of contact details card 305 contains information about points of contact, such as photos, names, roles, whether available, contact information with links, etc. Points of contact could include employees or external agencies, such as emergency services or police. In alternative embodiments of card 305, points of contact could be presented in order of availability or working hours.

Upcoming events card 306 contains information about future events affecting the asset. Information such as date of event, distance of event from asset, event description, etc., are displayed. This information may be limited to key events in a short time window, such as a week, or may be configured to show information over a longer time period.

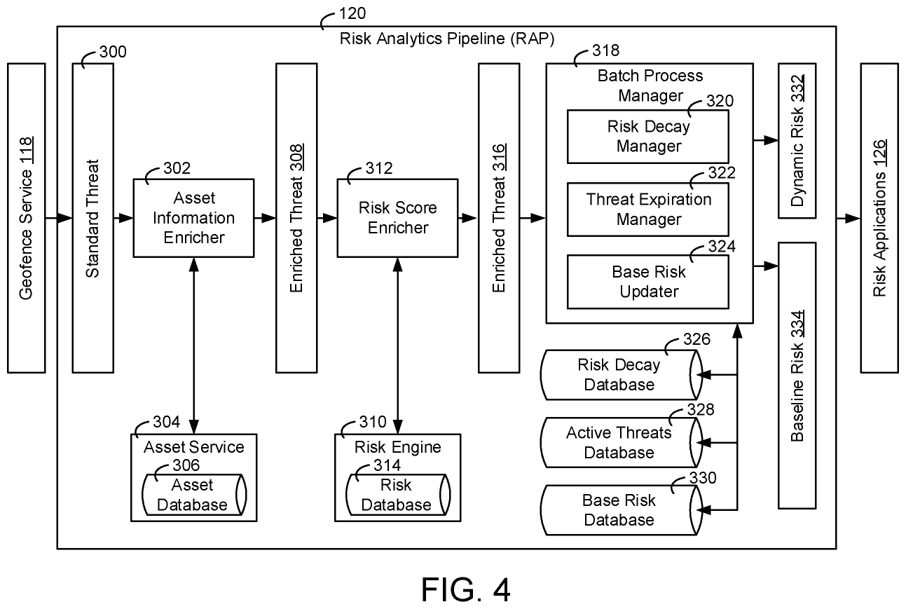

FIG. 4 is a drawing of the user interface of FIG. 3, showing a threat summary information element that displays when a user's cursor is hovered over an individual threat on asset risk timeline card 304. A threat summary panel 401 displays, giving a user more information about the key events that contributed to the risk score of the asset at that point in time. For example, threat summary panel 401 shows a text and icon description 402 of the threat referred to on the graph and associated with an asset risk score. The panel displays a threat location 403, a category of threat (e.g., security), a description of the threat 404, the source of the threat information 405, and an elapsed time since the last update 406.

Other useful information may be displayed to the user in the asset risk view of FIG. 3, such as an indication of the threats an asset is most vulnerable to, an asset's normal risk score, a top list of risk scores and associated threats for the past twelve months or other period, a link to a standard operating procedure (SOP) for different threats (e.g., suspicious package, bomb threat, etc.). This information may be derived from the risk analysis platform and displayed in the UI. In addition, the user interface could display links to other systems or information sources that may be configured for each asset or asset type.

UI systems and methods for various aggregated views of risk are presented as an output of a dynamic risk analysis platform. A list of the top assets organized by risk score provides security monitors with a single-pane view of their enterprise assets that are most at risk. Security operations center (SOC) and virtual security operations center (VSOC) staff may view the information displayed on a display monitor in the VSOC and respond using their desktop computers or mobile devices.

FIG. 1 is a drawing of a user interface view 100 showing a list of enterprise assets sorted by descending risk score 101. Display data may be filtered 102 in various ways, such as by region or by risk profile category. Each asset or asset class has been mapped in the risk analysis platform to one or more of a set of risk profiles. Asset risk profiles associate an asset with a vulnerability factor in relation to different categories of loss (or cost) arising from different types of threat. Examples of risk profile categories include life safety, asset protection, business continuity, and reputational damage. An asset's risk score in each risk profile category is calculated by the risk analysis platform. These scores may also be aggregated into a single, general risk score for the asset.

The risk analysis platform continually re-calculates risk for each monitored asset. As new risk scores are calculated, the displayed list of assets may update periodically as risk scores and key threat events change.

UI view 100 displays each listed asset's name 103, type 104 (such as office, laboratory, data center, retail premises, employee, service vehicle, employee vehicle etc.), address or location 105 (City, State, Country), region 106, current local time 107, and (where the asset can be occupied) occupancy 108. The occupancy number may be a static maximum or may be a relative occupancy, calculated from live building data by a relative occupancy model of the risk analysis platform.

The risk column may include various graphical indicators providing additional information about an asset's risk score. For example, icons may indicate a risk profile category, such as life safety 110, asset protection 111, or business continuity 112. The displayed risk profile category, in this example, matches the asset's risk category with the highest risk score. The risk analysis platform has scored the asset for risk across all its risk profile categories, but the highest scoring category is displayed as the asset's risk score. An arrow icon 109 or other visual indication of risk trend indicates a rising, falling, or stable risk. A numerical risk score 113 for the asset is displayed. Risk scores and icons may feature colors, such as those used in a RAG system, to indicate levels of risk and changes in risk levels. Each asset list element includes an expansion icon 114, with functionality allowing users to select a more detailed asset risk view.

FIG. 2A is a drawing of a user interface view 200 showing an alternative presentation of the list of FIG. 1. This more compact presentation may be displayed on a user's mobile device. Each asset list element is displayed in the form of a card 201. The list of cards may be filtered in various ways 202, as described in the description of FIG. 1. FIG. 2B is a detail view of card element 201 of FIG. 2A showing the types of information that may be displayed. Asset card shows the asset's numerical risk score 203, a visual indication of a risk trend, such as an arrow, 204, a graphical indication of a risk profile category 205, such as asset protection, the asset's name 206, its location or address 207, the asset's type (data center, office, etc.), the asset's occupancy 209, the local time for the asset 210, the asset's region 211, and an expansion icon allowing a user to view the asset's information in more detail.

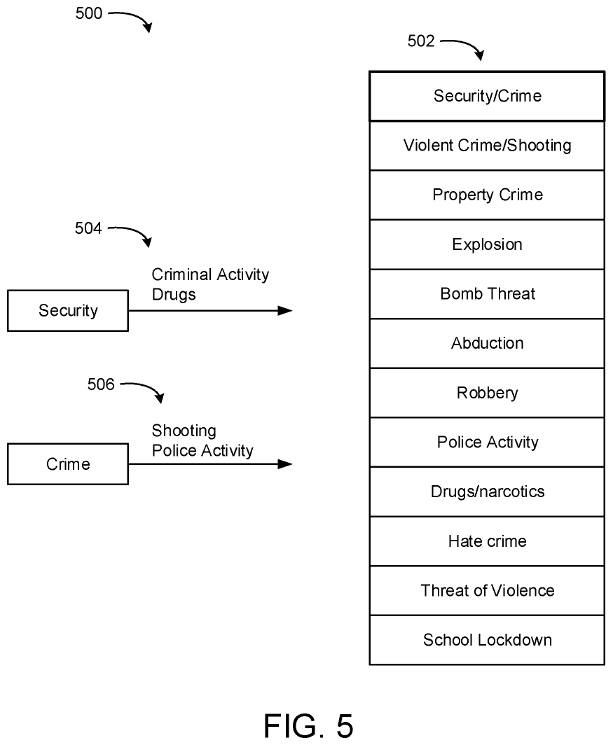

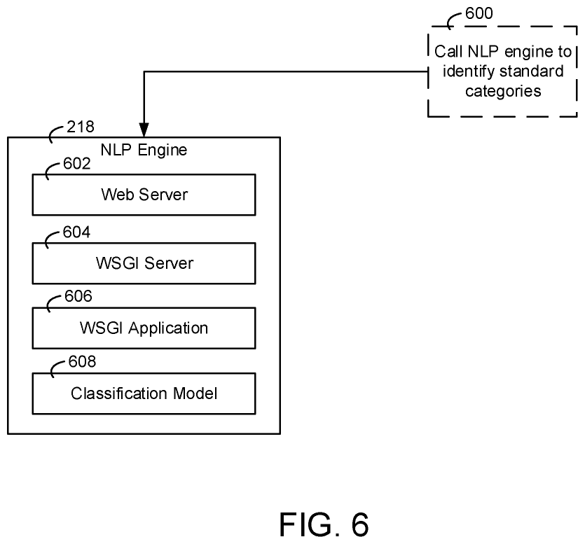

FIG. 3, FIG. 4, FIG. 5, and FIG. 6 are drawings showing various presentations of a list of the top threats that contribute to overall risk to an enterprise and all its assets, ranked in descending order of its share of asset risk score. Each threat is ranked by the risk analysis platform by calculating the extent to which the threat contributes to the risk scores of the assets it affects. In other words, each threat's shares of individual asset risk scores are aggregated and used to rank the threat against other threats in order to generate a top threats list. For example, Building A has an overall risk score of 70 and there are two threats affecting it: ‘tropical storm’ and ‘labor strike’. Tropical storm threat contributes 65 points to the overall risk score, whereas labor strike threat contributes 5 points. In determining the priority of each of these threats, 65 points are attributed to tropical storm threat. Those points are aggregated with its share of the risk scores of any other affected assets. Similarly, labor strike threat is allotted 5 points from Building A and those points are aggregated with its share of the risk scores of other assets it affects.

FIG. 3 is an example of a top threats user interface display 300. Top threats may be filtered in various ways, for example, by region 301, city 302, or building 303. Other filter categories may be applied, such as risk profile category (e.g., life safety, business continuity), threat type (e.g., cyber-security threats, weather and natural disaster threats), asset type, etc. For example, a user may filter top threats by selecting to view only ‘top bomb threats in EMEA’ or ‘top cyber-security threats affecting data centers’. The top threats with those attributes will be displayed in the UI. The top threats are displayed vertically in the form of threat summary cards 304. Top threats may be displayed in order of descending severity. Alternative methods of ordering the list of top threats may also be used, such as ordering threats according to the number of assets affected, in order of threat radius, number of assets affected, type or value of assets affected, expected threat duration, or current threat duration.

For each threat summary card, a list of affected assets is displayed horizontally, in the form of asset summary cards 305. Asset summary cards 305 may be displayed in left-to-right order of descending risk score. A scrolling function 306 allows a user to scroll back and forth through each list of affected assets.

The list of top threats is an output of the risk analysis platform that ingests and processes alert and threat data, associates threats with monitored assets, aggregates the threat data, and calculates a risk score for each affected asset. Threats processed by the risk analysis platform may come from external data (representing an external threat, such as a threatening weather event) or internal data (representing an internal threat, such as the presence of a VIP in a building asset). The examples of assets shown in FIG. 3 are building assets, however the risk analysis platform may also calculate risk for other assets, such as people, mobile assets, machinery, or intangible assets.

FIG. 4 is a detail view of threat summary cards 304 of FIG. 3. Threat summary card 400 displays important information about the relevant threat. This information includes a severity indication 401. Threat severity may be pre-determined in the system or derived by the risk analysis platform from threat data containing severity metadata. Threat summary card 400 also displays a threat category indication 402, which may be derived from a pre-determined list of threat categories that have been mapped to one or more threat types, and a threat type 403, which may also be derived from mapping threat data to a pre-determined list of threat types. Examples of threat categories include ‘weather and natural disasters’ and ‘security and crime’. Examples of threat types include ‘hurricane’ and ‘bomb threat’. Threat summary card 400 also includes an indication of a data source 404, such as an online threat alert data provider like Dataminr. Also included in threat summary card 400 is an indication of an elapsed time since the threat data was received 405, a threat location 406, and a threat radius 407. Threat location and radius data may be derived by the risk analysis platform from threat data. Threat summary card 400 also includes a graphical indication that one or more system users have added comments about the threat 408. In the example shown, the graphic indicates that two comments have been added in relation to the threat.

FIG. 5 is a detail view of an asset summary card 305 of FIG. 3. Asset summary card 500 displays an icon 501 indicating a risk profile category (e.g., asset protection), being the risk profile category with the highest risk score applicable to that asset. A numerical risk score 502 is displayed for the relevant asset. A graphical indication of a risk trend 503 is also displayed. In the example shown, an upwards arrow is used to indicate that the risk score of the relevant asset is increasing. Asset risk scores and trend information are derived from the risk analysis platform. Asset summary card 500 also displays an asset name 504. Assets can be buildings, moving assets (e.g., vehicles), people, or intangible assets, such as goodwill or intellectual property. Also displayed are the asset's location 505 and the distance of the asset from the threat 506, being the threat summarized in the corresponding threat summary card 304 of FIG. 3. The asset's type 507 (such as building, vehicle, or employee category) and, where relevant to the type of asset, occupancy 508 are also displayed. For a building asset, occupancy figures are provided by the risk analysis platform and may be a static maximum building occupancy or a dynamic relative occupancy, calculated by an occupancy model. An icon 509 indicates that the asset summary card may be selected by a user to access a detailed view of the asset's risk score and other information. The detailed asset view is described further in another invention disclosure.

FIG. 6 is a detail view of a threat information panel that may be accessed by a user from interacting with the threat summary card 304 of FIG. 3. A user may hover a cursor 601 over a comments icon of the threat summary card (indicating a number of comments) and view a threat information panel 600 showing important information about the threat. The information displayed in threat information panel 600 is taken from the risk analysis platform, and includes the threat type 602, threat category 603, the time elapsed since the threat information was received 604, the source of the threat data 605, the severity of the threat 606, and the location of the threat 607. In addition, threat information panel 600 displays a comments section 608. A comment is displayed with a user identity 609, an elapsed time since the comment was entered 610, and the text of the comment 611. Comments section 608 also includes an input field for a user to enter a comment 612. Finally, threat information panel 600 displays buttons to dismiss 613 or escalate 614 the relevant threat. A link 615 to a more detailed view of the threat is also displayed.

Interface 300 of FIG. 3 may alternatively be displayed to users on mobile devices in a mobile-optimized fashion. Threat insight information may be viewed on a mobile device by impacted staff, travelers, visitors, and vehicles. The user interface may additionally allow a user to tag a threat to indicate that it is being watched.

The forecasting of risk helps VSOCs to pre-emptively determine a suitable security posture. They can plan for future events, rather than react to events as they occur. Data is gathered from multiple sources, and then processed to both categorize and quantify future risks to assets from threats. Discrete time windows can be defined, e.g. individual days, and the future threats can be further analyzed in reference to these time windows.

An example user interface for the presentation of risk forecasts is shown in FIG. 2. The risk forecast can be part of a system that monitors a large number of assets that are geographically dispersed. Users may want to see risk forecasts for all assets, or they may want to only see the information that applies to specific geographical regions or individual assets. In some embodiments, filtering options are provided in the user interface to select a geographical region 201, a specific city 202, or a specific building 203. In some embodiments, filtering options may include limiting the displayed forecasts to asset types other than buildings, to an individual asset, to user-definable regions, to user-definable lists of assets, to assets within a specified time zone, or to use other criteria. Filtering may be applied in the user interface through the use of drop-down lists, groups of radio buttons or check boxes, or another user interface element. After a user selects filtering options, the user interface may refresh immediately to present the filtered information, or may require the user to manually apply the filters by interacting with a user interface element.

In some embodiments, the risk forecasts are grouped by calendar date. This may be presented in the user interface by a horizontal list of calendar dates 204, where each calendar date is presented in a date format appropriate for the user's region 206. The currently selected day may be indicated by a horizontal bar that is placed directly above the date 206, by using color to shade or highlight the foreground or background, by changing properties of the font used to display the date, or by some other method. In some embodiments, the user clicks a date to view the risk forecast for that day.

In some embodiments, the list of dates 204 includes only those dates that have relevant data associated with them. For example, days that do not have either events or threats associated with them may be removed from the list. In this way, the user does not need to navigate through the calendar to look for significant information. Instead, the user interface displays only significant information.

In some embodiments, the list of dates 204 includes only dates that are in the future, at the time when the list is viewed. In some embodiments, the current date is included, and may be included even if there are no associated events or threats. In some embodiments, one or more dates in the past may be included, as compared to the time when the list is viewed. The user interface may include clear indication of which dates are past, present, and future, through the use of color, shading, labelling, or other visual method.

In some embodiments, the list of dates 204 is scrollable, such that the list of dates can move either horizontally or vertically to display additional dates. The user controls this scrolling through interaction with the UI. For example, the user may click and drag the dates to scroll them. In some embodiments, the user can adjust the number of dates that are included in the list, either by quantity of dates to include, specifying a date range, or through some other method. In some embodiments, there is a representation of a larger time period, which includes an indication of which dates have relevant data associated with them, and also indicates which portion of the larger time period the list of dates 204 currently represents.

In some embodiments, the user interface features distinct sections to display upcoming events 207 and forecasted threats 208 that are associated with the selected date. The functionality of these sections is described in further detail below.

Events are planned occurrences, which are known about in advance. Examples may include board meetings, conferences, political rallies, elections, festivals, or sports matches. Having an awareness of events can aide in planning for and responding to threats. For example, if the road in front of a building will be closed for a parade, fire wardens can be instructed to evacuate people through side and rear exits if the need arises.

An example presentation of upcoming event information is shown in FIG. 3. The information may be presented in a tabular format, with a row for each event, and columns for data that may include the type of event 302, a title for the event 303, a description of the event 304, the scheduled time that the event will begin and end 305, the asset that the event affects 306, and what the forecasted risk score is for the duration of the event. In some embodiments, the user is able to configure which columns are displayed. In some embodiments, the risk score 307 is the maximum score that is predicted to occur during the event. The risk score may also be derived from an average of predicted risk scores during the event, or through some other mathematical method. If the event is scheduled across more than one day, the calculation of the risk score may be limited to the portion of the event that will occur on the selected day. In some embodiments, in addition to a numerical risk score, the user interface displays a graphical representation of risk 301. For example, a colored rectangle may be displayed, where the color used is chosen from a gradient color scale.

A forecasted threat is a threat for which there is prior warning. These may be scheduled or forecasted events that are determined to result in a calculable change in the risk score of an asset, and may have an external or internal source. An example presentation of forecasted threat information is shown in FIG. 4. In some embodiments, forecasted threats may be presented in a tabular format, with a threat on each row, and columns for information that may include threat categorization 405, the number of assets that are affected by the threat 406, the data source that provided the threat information 407, the forecasted start date and time 408, the distance between the threat and the asset 409, and the forecasted risk score 410. In some embodiments, in addition to a numerical risk score, the user interface displays a graphical representation of risk 411. For example, a colored rectangle may be displayed, where the color used is chosen from a gradient color scale.

Forecasted risk scores are calculated with regard to affected assets. The system determines which assets are affected by each threat type. The distance 409 and risk 410 attributes for a forecasted threat are derived from the assets associated with that threat. The attributes may be taken from the asset with the highest risk score, the closest asset, or from an asset selected by another means. One or more attributes may also be derived mathematically from the attributes of the associated assets. For example, the attributes displayed for the forecasted threat may be averages of the attribute values of the associated assets.

Temporal decay may be calculated as occurring between the anticipated start time of a threat and the start of the date that is being viewed, the anticipated start time of a threat and the middle of the date that is being viewed, the anticipated start time of a threat and the midpoint of the overlap between the threat and the date that is being viewed, or two other temporal points.

In some embodiments, the table of forecasted threats displays a fixed number of threats. The threats may be selected for inclusion based on their forecasted risk scores for the assets with which they are associated. For example, the table may display the ten threats that have the highest forecasted asset risk scores.

In some embodiments, rows for threats 403 are grouped by threat category, and displayed under a heading for that threat category, for example, 402. The order of threat categories in the table may be determined from the forecasted risk scores of threat types within that category, and be based on summing the risk scores, averaging the risk scores, taking the highest value risk score, or use some other mathematical method.

In some embodiments, the user interface includes a feature to display information about the assets that are affected by the forecasted threat. The user may click on an icon 401 adjacent to the asset count to toggle the display of the asset data, or they may use some other user interface element. A table that contains information about the assets 404 may be displayed. This table may be nested within the forecasted threats table and placed adjacent to the forecasted threat that the assets are associated with. The information included in the nested table may include the asset's name, the asset's type, the asset's location, the distance between the asset and the threat, and the forecasted risk score.

The forecasting of risk helps VSOCs to pre-emptively determine a suitable security posture. They can plan for future events, rather than react to events as they occur. Data is gathered from multiple sources, and then processed to both categorize and quantify future risks to assets from threats. Discrete time windows can be defined, e.g. individual days, and the future threats can be further analyzed in reference to these time windows.

An example user interface for the presentation of risk forecasts is shown in FIG. 2. The risk forecast can be part of a system that monitors a large number of assets that are geographically dispersed. Users may want to see risk forecasts for all assets, or they may want to only see the information that applies to specific geographical regions or individual assets. In some embodiments, filtering options are provided in the user interface to select a geographical region 201, a specific city 202, or a specific building 203. In some embodiments, filtering options may include limiting the displayed forecasts to asset types other than buildings, to an individual asset, to user-definable regions, to user-definable lists of assets, to assets within a specified time zone, or to use other criteria. Filtering may be applied in the user interface through the use of drop-down lists, groups of radio buttons or check boxes, or another user interface element. After a user selects filtering options, the user interface may refresh immediately to present the filtered information, or may require the user to manually apply the filters by interacting with a user interface element.

In some embodiments, the risk forecasts are grouped by calendar date. This may be presented in the user interface by a horizontal list of calendar dates 204, where each calendar date is presented in a date format appropriate for the user's region 206. The currently selected day may be indicated by a horizontal bar that is placed directly above the date 206, by using color to shade or highlight the foreground or background, by changing properties of the font used to display the date, or by some other method. In some embodiments, the user clicks a date to view the risk forecast for that day.

In some embodiments, the list of dates 204 includes only those dates that have relevant data associated with them. For example, days that do not have either events or threats associated with them may be removed from the list. In this way, the user does not need to navigate through the calendar to look for significant information. Instead, the user interface displays only significant information.

In some embodiments, the list of dates 204 includes only dates that are in the future, at the time when the list is viewed. In some embodiments, the current date is included, and may be included even if there are no associated events or threats. In some embodiments, one or more dates in the past may be included, as compared to the time when the list is viewed. The user interface may include clear indication of which dates are past, present, and future, through the use of color, shading, labelling, or other visual method.

In some embodiments, the list of dates 204 is scrollable, such that the list of dates can move either horizontally or vertically to display additional dates. The user controls this scrolling through interaction with the UI. For example, the user may click and drag the dates to scroll them. In some embodiments, the user can adjust the number of dates that are included in the list, either by quantity of dates to include, specifying a date range, or through some other method. In some embodiments, there is a representation of a larger time period, which includes an indication of which dates have relevant data associated with them, and also indicates which portion of the larger time period the list of dates 204 currently represents.

In some embodiments, the user interface features distinct sections to display upcoming events 207 and forecasted threats 208 that are associated with the selected date. The functionality of these sections is described in further detail below.

Events are planned occurrences, which are known about in advance. Examples may include board meetings, conferences, political rallies, elections, festivals, or sports matches. Having an awareness of events can aide in planning for and responding to threats. For example, if the road in front of a building will be closed for a parade, fire wardens can be instructed to evacuate people through side and rear exits if the need arises.

An example presentation of upcoming event information is shown in FIG. 3. The information may be presented in a tabular format, with a row for each event, and columns for data that may include the type of event 302, a title for the event 303, a description of the event 304, the scheduled time that the event will begin and end 305, the asset that the event affects 306, and what the forecasted risk score is for the duration of the event. In some embodiments, the user is able to configure which columns are displayed. In some embodiments, the risk score 307 is the maximum score that is predicted to occur during the event. The risk score may also be derived from an average of predicted risk scores during the event, or through some other mathematical method. If the event is scheduled across more than one day, the calculation of the risk score may be limited to the portion of the event that will occur on the selected day. In some embodiments, in addition to a numerical risk score, the user interface displays a graphical representation of risk 301. For example, a colored rectangle may be displayed, where the color used is chosen from a gradient color scale.

A forecasted threat is a threat for which there is prior warning. These may be scheduled or forecasted events that are determined to result in a calculable change in the risk score of an asset, and may have an external or internal source. An example presentation of forecasted threat information is shown in FIG. 4. In some embodiments, forecasted threats may be presented in a tabular format, with a threat on each row, and columns for information that may include threat categorization 405, the number of assets that are affected by the threat 406, the data source that provided the threat information 407, the forecasted start date and time 408, the distance between the threat and the asset 409, and the forecasted risk score 410. In some embodiments, in addition to a numerical risk score, the user interface displays a graphical representation of risk 411. For example, a colored rectangle may be displayed, where the color used is chosen from a gradient color scale.

Forecasted risk scores are calculated with regard to affected assets. The system determines which assets are affected by each threat type. The distance 409 and risk 410 attributes for a forecasted threat are derived from the assets associated with that threat. The attributes may be taken from the asset with the highest risk score, the closest asset, or from an asset selected by another means. One or more attributes may also be derived mathematically from the attributes of the associated assets. For example, the attributes displayed for the forecasted threat may be averages of the attribute values of the associated assets.

Temporal decay may be calculated as occurring between the anticipated start time of a threat and the start of the date that is being viewed, the anticipated start time of a threat and the middle of the date that is being viewed, the anticipated start time of a threat and the midpoint of the overlap between the threat and the date that is being viewed, or two other temporal points.

In some embodiments, the table of forecasted threats displays a fixed number of threats. The threats may be selected for inclusion based on their forecasted risk scores for the assets with which they are associated. For example, the table may display the ten threats that have the highest forecasted asset risk scores.

In some embodiments, rows for threats 403 are grouped by threat category, and displayed under a heading for that threat category, for example, 402. The order of threat categories in the table may be determined from the forecasted risk scores of threat types within that category, and be based on summing the risk scores, averaging the risk scores, taking the highest value risk score, or use some other mathematical method.

In some embodiments, the user interface includes a feature to display information about the assets that are affected by the forecasted threat. The user may click on an icon 401 adjacent to the asset count to toggle the display of the asset data, or they may use some other user interface element. A table that contains information about the assets 404 may be displayed. This table may be nested within the forecasted threats table and placed adjacent to the forecasted threat that the assets are associated with. The information included in the nested table may include the asset's name, the asset's type, the asset's location, the distance between the asset and the threat, and the forecasted risk score.

FIG. 1 is a drawing of an example user interface 100 for a security posture assessment of an asset. The tool provides functionality enabling a user to initiate and edit an assessment, which automatically uses and displays the relevant data and calculations from a risk analysis platform. In the disclosed example, the asset is a building, but other types of assets may be assessed using the tool.

Example user interface 100 displays the following sections of a security posture assessment: Asset summary 101, risk summary 102, incident summary 103, mitigation tasks 104, and review and approval 105.

Asset summary section 101 is not shown in an expanded form in user interface 100, but may include relevant information about the asset, such as asset name, asset description and key attributes, a summary of key changes for the asset since the last risk review, user comments on asset summary changes (e.g., “sublet floors one and two from July”, “reduction in staff of 100 PAX”, “new security turnstiles requiring employees to use badges on entry and exit”.), and other risk-relevant information. For a building asset, an asset summary section may also include information such as the number of direct employees and contractors, total square footage of the building, the percentage of space occupied by the enterprise in a shared building, whether there is branded signage on or in a building. The summary may also include information about the activities carried on in the building, such as trading, financial, call center, datacenter, etc. Information may also include details about physical risk mitigation factors, such as vehicle barriers, pedestrian barriers, security offices, security dog patrol, and other similar information. Technical risk mitigation information may be included, such as the number of access controls on a perimeter and the number and locations of CCTV cameras. Information about a facility's preparedness may be included, such as evacuation procedures, device health data (e.g., security blind spots), and whether equipment inspections are up to date. Such information may be taken from various systems, such as the building access control system, security system, business data and records, as well as from security operators, who may enter such asset details using the tool.

The tool allows a user to select an asset to assess, select a review type (e.g., annual, half-yearly, interim.), configure basic security posture assessment attributes, and set a status of the security posture assessment (e.g., ‘in progress’, ‘paused’, ‘ready for approval’, ‘completed’.). The tool automatically records who is conducting the review (based on a user's account), when it started, when it completed, and the date of the last security posture assessment for the relevant asset.

An assessment status card 106 displays high level details about the assessment and asset under review. For example, assessment status card 106 shows the progress of the review, the period assessed, the start date of the assessment, the period of any previous assessment and elapsed time since it took place, the asset name, type, location, occupancy (and trend), value (and trend), and business impact. An asset value may be a number representing the monetary value of an asset and may be normalized and be accompanied by some graphical indication of a change in value, e.g., a downward arrow indicating depreciation.

Risk summary section 102 may present historical risk data aggregated by campus, city, country, region, or asset geofence, over a given date range, broken down by risk profile (e.g., asset protection). A user may select a risk profile category (e.g., asset protection risk) from the drop down menu 107. A list of risk profiles 108 is displayed. A risk profile may be for a region 109, country, city, campus, or asset 110. For each listed profile, summary information is displayed, such as the date the profile was applied 109, profile status 110 (e.g., ‘active’), a risk score range applicable to the profiles 111, and the elapsed times since the lowest 112, medium 113, and highest 114 risk scores were recorded.

Risk summary section 102 displays a line graph 115 showing historical risk summary information about the asset over a pre-defined or user-selectable period. Line graph 115 displays key risk scores for the asset over the selected time period, and each key risk score is labelled with an associated top threat (see 116, 117, and 118). By hovering a cursor over a risk score point, such as risk score 118, a risk and threat summary panel 119 is displayed. Summary panel 119 displays the risk score 120, basic information about its associated top threat 121, threat information source 122, distance between asset and threat 123, and a selectable link to information about other threats 124, if applicable. Risk summary section 102 additionally displays a list of the applicable risk scores and associated top threats for the asset 125, showing the threat description, date of threat, reported risk, and notes or narratives from users.

Risk summary section 102 also displays assessment notes 126 that can be entered by users, giving more information or context to a building's risk review. The information display of risk summary section 102 is shown only as an example. In other embodiments, risk summary section 102 may also display other useful information about risk, such as average actual risk scores over a period for different risk profiles, indications of whether actual risk scores were higher or lower than an average for another period, benchmark comparisons of actual average risk for an asset compared to other assets in the same or other regions, data relating to current risk profiles for an asset and when they were applied, information showing when and why a risk profile changed for an asset, etc.

Incident summary section 103, allows a user to search and view single incident history, search closed incidents by date and location to find and select an incident, view an incident's history and how it was responded to, view a summary of all incidents and threats for a single building, campus, city, country, or arbitrary geofence (which may be selected through a map view). Summary incident information may be selected by a user within a date range, with breakdown by incident type and outcome. A user can access the history from an incident list (closed incidents) or from a building profile page that shows summary information for a selected building.

Mitigation tasks section 104 allows a user to review the risk mitigation tasks for an asset, and is described further below in relation to FIG. 2.

Review and approval section 105, may contain a section allowing a user to mark the security assessment as reviewed and approved, record who reviewed and approved the assessment, change the status to ‘completed’, record who reviewed and approved the security assessment, and download a copy of or email a link to the security assessment review.

FIG. 2 is a drawing of the same user interface as FIG. 1, showing the expanded mitigation tasks section 104. Mitigation tasks section 104 allows a user to review a list of risk mitigation tasks for an asset, review comments on those tasks, view or edit the status of tasks (e.g., drop down list with values ‘noted’, ‘completed’, ‘not implemented’, ‘not required’, ‘reviewed’, ‘rejected’), enter comments on tasks (e.g., ‘N/A’, ‘implemented on mm/dd/yy’, etc.), and add new risk mitigation tasks. A user may also enter comments about the risk assessment for the asset.

Other information delivered through the security posture assessment tool includes the number and type of incidents in a building, national crime index scores, breakdowns of events in different crime categories, information about points of interest and their proximity, information about nearby infrastructure (e.g., fire stations, hospitals, police stations), transportation information (e.g., bridge or tunnel, bus station, ferry terminal, train station), and nearby facilities.

The components that contribute to the calculation of risk scores for assets are shown in FIG. 1, according to some embodiments. A risk score is calculated by multiplying the factors for threat 102, vulnerability 108, and cost 109, as they apply to an asset 101. This is termed the threat-vulnerability-cost (TVC) model.

Alerts and other threat-related data are ingested from a variety of data sources 110. These may include police reports, traffic reports, and social media posts. The data may be ingested directly from the source or obtained from a third-party provider, which may process and amalgamate the data in advance.

Alerts are mapped to a preconfigured threat type 107. The system may use natural language processing (NLP) to analyze the description of the alert, and then identify an appropriate corresponding threat type. In some embodiments, similar threat types are grouped into threat categories. For example, the threat types of robbery, bomb threat, and drug seizure may be grouped into a threat category named Security and Crime.

The threat model 104 calculates a threat score based on the likelihood that the threat referred to by the alert is real, and the severity of the threat that it poses. Both likelihood and severity parameters may be normalized to a scale between 0 and 1, such that they can be multiplied together to calculate a threat score in the range of 0 to 1. The threat model deduces appropriate values for the likelihood and severity parameters by analyzing the alert metadata.

Threat scores may decay according to multiple factors. Threat scores may decay spatially, such that as the distance between the asset and the threat referred to by the alert increases, the amount of decay increases. Threat scores may decay temporally, such that as more time passes since the alert was generated, the amount of decay increases. Each decay factor may include a lower boundary, below which there is no decay. Each decay factor may include an upper boundary, above which the decay is absolute, and the resulting threat score is zero. Between the upper and lower bounds, the severity may decay linearly, discretely, polynomially, or through some other method. Decay factors may be configured independently, and vary between threat types.

Threat score=Likelihood×Severity×Spatial decay×Temporal decay

In some embodiments, if any alerts overlap in space, time, category, and sub-category, then the system groups these similar alerts together. Alerts overlap in space if their maximum radii of effect intersect. Alerts overlap in time if they were created within a defined time window. Alerts overlap in category and sub-category if their values for these parameters exactly match. Alerts that are grouped together are processed as a single, combined threat, with a single threat score. If an alert does not overlap any other alerts, then it is processed as a single, unique threat.

An asset 101, for which risk scores are calculated, may be any entity that can be exposed to threats. Assets may be both static and mobile. Example assets include buildings, equipment, vehicles, animals, and people. Assets may also be non-physical, such as a company's reputation. The calculation of risk for a building may include an assessment of threats in relation to the physical building, as well as the equipment and people within that building.

A risk profile 105 is a preconfigured mapping of threats and threat categories to vulnerability scores. For each threat type, or each threat category, that is configured in the system, a vulnerability score is assigned. The vulnerability score is a measure of the impact that a particular threat type or threat category could have on an asset for that risk type. In some embodiments, the vulnerability is normalized to a scale between 0 and 1.

In some embodiments, risk profiles 105 are associated with assets 101 through the use of asset risk profiles 106. This enables a single risk profile to be defined, which is then associated with all assets. It also enables groups of similar assets to share a common risk profile, each asset to have its own unique risk profile, multiple risk profiles to be associated with a single asset, or any other mapping of assets to risk profiles.

The asset risk profile 106 associates threat types and threat categories with a cost 109. The cost is a measure of the maximum potential loss that could be incurred. The cost may represent a financial loss, a loss of life, a loss of productivity, or some other measure. If a single risk profile is associated with an asset, the cost may quantify the total loss of the asset. Where multiple risk profiles are associated with a single asset, each risk profile may represent a category of potential loss. Example focuses for risk profiles include life safety, business continuity, asset protection, business reputation, and investment value. For example, if the risk profile relates to life safety, then the cost is a measure of the total loss of life that could occur. If the risk profile is related to asset protection, then the cost may be a measure of the maximum financial cost that could be incurred if the asset were completely destroyed. In some embodiments, the cost is normalized to a scale between 0 and 1. The asset risk profile generates a vulnerability-cost (VC) value for each combination of asset and threat.

VC score=Vulnerability×Cost

In some embodiments, the risk score 103 is calculated as a product of the threat score and the VC score.

Risk score=Threat score×VC score

Risk scores are calculated for each threat. These risk scores are aggregated to produce a single risk score for each asset risk profile. The risk score for the asset risk profile may be based on the highest risk score, an average of the risk scores, or calculated through some other mathematical process. Similarly, the risk scores for all asset risk profiles that are associated with an asset may be aggregated to produce a single representative risk score for the asset.

In some embodiments, the assets may be mobile assets, such as people or vehicles. The location of the mobile asset may be tracked through the use of GPS, GSM/GPRS, WiFi, or other known method. The dynamic risk system may be continuously updated as to the asset's changing location, or the updates may be more periodic. In some embodiments, a user manually updates the location of an asset. For example, an individual that is travelling may themselves be considered as an asset, and they may manually update the system with their location by accessing the system through their mobile device. As an asset moves, the distances change between that asset and threats, and risk scores are recalculated in response to the changing distances. The asset's movements may take it outside of the effective radius of some threats, and into the effective radius of other threats.

In some embodiments, part, or the entirety, of a mobile asset's planned route may be known. The dynamic risk system may analyze both existing threat data and data about known future threats to predict risk scores for part, or the entirety, of the journey. The system may incorporate information about the speed of the asset, transport schedules, road traffic reports, or similar, in order to add predicted times to points along the route. The system can then predict threats that may coincide with the asset's location at a point in time. For example, the system may have access to an individual's flight details, and use that anticipated time and location information to identify any relevant threats, such as extreme weather or worker strikes.

In some embodiments, some or all of the features available in the dynamic risk system are accessible through a mobile device. In situations where a person is linked to a mobile asset in the system, that person can review information, such as the current and predicted threats that apply to them, as well as their overall risk score.

In some embodiments, hypothetical assets can be defined in the system. These are processed by the system as though they were standard assets, but they do not have any real-world equivalent. One use for hypothetical assets is in the creation of simulations. For example, when determining whether to construct a new building on a specific site, a hypothetical asset can be defined at that location first. The system can identify threats and calculate a risk score for the asset. A user can adjust risk profile parameters and view their effect on the calculated risk. The adjusted risk profile parameters can then be used to inform the design of the building. For example, it may be determined that to achieve an acceptable level of risk for the building, it must be designed with a reduced vulnerability to floods and loss of power. When risk is being assessed in relation to a new construction, or a similar project that has an extended lifetime, additional data sources may be harvested to identify longer-term threats. For example, planning applications, political manifestos, and low-frequency natural disasters.

In some embodiments, the dynamic risk system is integrated into other systems. Methods of integration include, but are not limited to, the dynamic risk system reading or writing to a database that is shared with another system, the dynamic risk system providing an API that is accessed by another system, and the dynamic risk system accessing an API that is provided by another system. Integrations may allow the dynamic risk system to accept data input at any stage in its processes, and to output data at any stage in its processes.

In some embodiments, the dynamic risk system receives data from an external system that then modifies cost calculations. For example, an access control system could provide a building occupancy count, which would affect loss of life calculations. In some embodiments, the dynamic risk system receives data from an external system that then modifies vulnerability parameters. For example, a fire alarm system could notify the dynamic risk system that the fire alarms are currently disabled, which could increase the building's vulnerability to fire. In some embodiments, the dynamic risk system accepts structured threat data that bypasses part or all of the risk calculation process. A security system within a building could detect a broken window, and then access the dynamic risk system's API to provide data about the threat; bypassing the alert categorization and overlap tests. A similar security system could fully assess the risk of a threat, and then provide the dynamic risk system with a risk score and accompanying threat data.

In some embodiments, the dynamic risk system identifies a situation that must be acted upon, and communicates the information to an external system. Example external systems include incident management systems, systems that coordinate the execution of standard operating procedures (SOPs), mass notification systems, and security systems. The determination to act upon a situation includes calculating a threat score that exceeds a specified threshold value and calculating a risk score that exceeds a specified threshold value. Thresholds may vary depending on the type of threat or risk profile. For example, the dynamic risk system could determine that a threat score for a burglary has exceeded a threshold, communicate the information to an SOP system, which then initiates an investigation from a security guard. In some embodiments, the decision to initiate communication with an external system is made by a user. The user interface provides functionality to communicate relevant information to an external system when viewing risk information, threat information, or some other part of the system. For example, upon seeing that a building's risk score relating to loss of life is unacceptably high, a user may command the dynamic risk system to communicate with an alarm system, which would then initiate an evacuation of the building. Where affected assets are individual people, the dynamic risk system can instead communicate with a mass notification system, which would then send SMS messages to the affected users.

In some embodiments, the dynamic risk system is used to run simulations. This may include commanding the full system to enter a simulation mode. Alert data may also be tagged to indicate that it is simulated. Simulated alert data may be created in an external system, and ingested into the dynamic risk system in the same manner as other alert data, or it may be created within the dynamic risk system. When operating in a simulation mode, or when processing simulated data, some functionality may be disabled. For example, during simulation, alerts may be displayed on screens and alarms may be triggered within a building, but the system may block automatic notifications that would be sent to emergency services. Running a simulation may cause additional log data to be generated, which can be used to review information such as what actions were taken and at what times.

In some embodiments, an output of the dynamic risk system may be a “what if” analysis feature. For example, a user may select an arbitrary geo-location for a fictitious asset, and data and calculations from the risk analysis platform may be used to provide historical and current risk perspectives. This type of analysis may be used for making real estate or other asset investment decisions, for assessing the risk in planning a corporate event at a new venue, or for travel advisories.

Referring generally to the FIGURES, systems and methods are shown for a risk analytics system for a building or multiple buildings, according to various exemplary embodiments. The risk analytics system can be configured for threat and risk analytics for security operations of the building. The analytics system provides a set of algorithms for scalable risk analytics pipeline including the threat data ingestion, enrichments, analytics, and machine learning models, risk modeling, reports, and presentation.

Many organizations need scalable and reliable security solutions to mitigate risk, monitor security operations and lower the chance of potential loss or damage on their assets. Asset can be anything that is valuable for that organization including campuses, buildings, personnel, equipment, and resources. Depending on the type of the asset, each asset might be vulnerable towards a set of threats. Understanding the relationship between an asset and the set of threats is a complex task that require an infrastructure that can gather all the relevant data from different sources, analyze the data in multiple processing steps and generate rich yet easy to understand information to security operators and site monitors so that these personal can take appropriate actions. The analytics systems and methods as described herein can generate risk information for use in prioritization of alarms, presenting users with contextual threat and/or asset information, reducing the response time to threats by raising the situational awareness, and automating response actions. In case of mobile assets, another block to the analytics system can be included to identify the location of the mobile asset since the location of the mobile asset will be dynamically changing while the rest of the pipeline of the analytics system may remain the same.

The analytics system as described herein can be configured to uses various components to provide scalability and reliable security solutions. The analytics system can be configured to ingest threat data from multiple disparate data sources. The threat data can be information indicating a particular threat incident, i.e., an event that may put the building or other asset at risk (e.g., a chance of personal injury, theft, asset damage, etc.). Based on the ingested threat data, the analytics system can identify which of a collection of stored assets are affected by the threat, e.g., by performing geofencing with geofences of the assets and reported locations of the threat data. Based on the indication of assets affecting threats, the analytics system can perform risk analytics via an analytics pipeline to perform operations such as risk calculation for the threat and asset, risk decay, and various other analytical operations.

Furthermore, based on the analyzed threat and asset data, the analytics system can present information to a user, e.g., a security officer, via user interface systems. The user interface system can facilitate alarm handling by providing contextual information together with risk scores for particular threats. Using the risk asset score for an alarm event, security personnel can filter and/or sort alarm events to show or highlight the highest risk alarms.

Referring now to FIG. 1, a system 100 is shown including a risk analytics system 106 configured to perform data ingestion with a data ingestion service 116, geofencing with a geofence service 118, risk analytics with a risk analytics pipeline (RAP) 120, and user interface operations with risk applications 126, according to an exemplary embodiment. The system 100 further includes third party data sources 102, network 104, and user devices 108. The risk analytics system 106 is shown to be communicably coupled to the data sources 102 and the user devices 108 via the network 104.

The network 104 can communicatively couple the devices and systems of system 100. In some embodiments, network 104 is at least one of and/or a combination of a Wi-Fi network, a wired Ethernet network, a ZigBee network, a Bluetooth network, and/or any other wireless network. Network 104 may be a local area network or a wide area network (e.g., the Internet, a building WAN, etc.) and may use a variety of communications protocols (e.g., BACnet, IP, LON, etc.). Network 104 may include routers, modems, servers, cell towers, satellites, and/or network switches. Network 104 may be a combination of wired and wireless networks.

Via the network 104, the risk analytics system 106 can be configured to ingest (receive, process, and/or standardize) data from data sources 102. The data sources 102 can be located locally within a building or outside a building and can report threats for multiple buildings, cities, states, countries, and/or continents. The data sources 102 can be local building systems, e.g., access control systems, camera security systems, occupancy sensing systems, and/or any other system located within a building. Furthermore, the data sources 102 can be government agency systems that report threats, e.g., a police report server providing the risk analytics system 106 with police reports. Data sources 102 may also include, for example, government agency, non-governmental agency, multi-departmental, municipal, and unit of government communications and data sources relevant to dispatch functions associated with the risk analytics system 106. By collecting and correlating data from disparate data sources—including police, fire, social services, building inspection, social media, data subscriptions, voluntary submission, etc., the risk analytics system 106 may be used to support government and non-governmental agencies (e.g. municipalities) dispatch the most appropriate responders to incidents. Use of the risk analytics system 106 to support dispatch functions based on collection and analysis of “all source” data, including agency communications, may improve response & outcomes as well as save money by optimizing resources.

For example, the risk analytics system 106 may be provided to a municipal consolidated dispatch center (dispatching for police, fire, emergency medical, public health, utilities). When the dispatch center receives a call for services (e.g. a call reports a gas smell), the risk analytics system 106 correlates information from all available sources (e.g. social media, utility company communications, news media, private alarm company reporting, etc.) and tailors the response dispatched to the incident based on analysis of the correlated information. In a case where the dispatch center receives the report of a gas smell, the risk analytics system 106 may determine that the call is from a single house residential location and search monitored sources for additional information. With no additional data from the monitored sources correlated to the call, the system recommended response may consist of a single fire unit and a utility company unit. The incident is resolved quickly and cost effectively with a dispatch optimized to fit the particular situation based on multiple data sources.

In a case where the risk analytics system 106 identifies data from multiple sources indicating a more significant level of risk or threat, the system may scale the recommended response based on the cross-correlated data. For example, with the same initial call reporting a gas smell, the risk analytics system 106 may capture social media reports of a fire, private alarm company fire alarm activations at a hotel, security camera imagery of an explosion in a multi-story building, etc. and correlate these in space and time with the initial call reporting the smell of gas. The risk analytics system 106 may recommend dispatching a major incident response including multiple fire units, medical transport, police for traffic control, public and private utility units, etc. In this case, the dispatched services are matched in number and type to the size of the emergency saving time and providing sufficient resources at the first indication of a major incident. In a further example, when a dispatch center receives a call for an ambulance and the risk analytics system 106 receives additional data from social media, a private security company radio alert concerning a traffic accident at a store, and store security camera imagery showing a vehicle striking a pedestrian in a crosswalk, the system may correlate information from all data sources to assess that the incident is a combined criminal and medical emergency and dispatch police and medical units while providing vehicle information from the security camera to the responding police units to support the response.

The data sources can be analytics companies (e.g., Dataminr, NC4, Lenel on Guard) and/or any other analytics system configured to collect and/or report threats. Dataminr is a service that monitors social media data and generates alarms on different topics. Dataminr can be configured to send alarms generated from twitter data to the risk analytics system 106. NC4 can be configured to generate incidents and/or advisory alerts and provide the incidents and/or alerts to the risk analytics system 106. NC4 can include local resources on different parts of the globe to collect data for generating the incidents and/or advisory alerts. Lenel is a system that manages the entrance, badge monitoring, etc. in a building.

The risk analytics system 106 can be configured to support any type of data source and is not limited to the data sources enumerated above. Any live feed of potential threats according to the vulnerabilities of the asset under protection can be used as a data source for the risk analytics system 106.

The threat data reported by the data sources 102 can include time information, location information, summary text, an indication of a threat category, and a severity indication.

Threat Data={Time Information, Location Information, Summary Text, Category, Severity}

In some embodiments, the data sources 102 are configured to provide time information, e.g., date and time information for reported threats to the risk analytics system 106. In some embodiments, the current time stamp can be attached to the incoming threats. However, this timing information may be different for different data sources, for example, some data sources may indicate that a current time of the data provided by the data source is the time of that threat occurring. In this regard, for data from data sources that indicate that the time of a threat is the time that the threat data is received, the risk analytics system 106 can add the time of threat occurrence as the time that the threat was received.

The data source can provide the location information on the incident. The location information could be the latitude and longitude of the incident. Both point and area information can be included. For example, some incidents like weather related threats affect a large area and they are not a specific point on the map but rather a particular geographic area. However, some other incidents like traffic incidents, bombing, or urban fires may be associated with a specific point on a map. The threat data can further include summary text or otherwise a text explanation of the incident should also be included in the threat reported.

Furthermore, the threat data can include an indication of a category of the incident. For example, each of the data sources 102 can define a category for the threat data, e.g., crime, fire, hurricane, tornado, etc. Each of the data sources 102 may have a unique category scheme. For example, one data source could define a shooting as a “Crime” category while another data source would define the same event as a “Violent Activity” category. If no category is reported by a data source, the risk analytics system 106 can be configured to determine a category from the text summary of the threat using Natural Language Processing (NLP).

The threat data can include severity information. Threats might be different in terms of severity. In order to understand the potential risk for that specific threat, the severity information can be included in the threat data. Different scales can be used for different data sources (e.g., 1-10, 1-5, A-F, etc.). The risk analytics system 106 can be configured to convert the severity levels to a standard format as part of ingesting data from the data sources 102.

The data sources 102 can provide real-time updates on potential and/or actual threats. Depending on the application, the data sources 102 may differ significantly in the formatting and/or reporting scheme of the data source. There should be some analysis done on the asset vulnerability before deciding on what data sources are suitable to report the potential threats. For example if the main vulnerability of the asset is towards natural disasters and extreme weather conditions then a proper channel that provides real-time updates on the weather conditions and forecast would be an appropriate data source for the risk analytics system 106.

Another example is social media information. If a reputation of a company is part of the asset, the risk analytics system 106 is to protect or the way consumers share their feedback and thoughts on social media are a good indication of possible threats to hurt the company reputation. Then a data source that reports updates on social media topics and trends can be valuable for the risk analytics system 106. This can be extended to sensors and camera feeds that monitor a building or campus and generate alarms (threats) that need to be ingested and analyzed to deduce the best action possible. The data sources 102 can either be first party and/or third party, i.e., platforms and/or from equipment owned by an entity and/or generated by data sources subscribed to by an entity.

The risk analytics system 106 can be a computing system configured to perform threat ingesting, threat analysis, and user interfaces management. The risk analytics system 106 can be a server, multiple servers, a controller, a desktop computer, and/or any other computing system. In some embodiments, the risk analytics system 106 can be a cloud computing system e.g., Amazon Web Services (AWS) and/or Microsoft Azure. The risk analytics system 106 can be an off-premises system located in the cloud or an on-premises system located within a building of the entity and/or on a campus.

Although the risk analytics system 106 can be implemented on a single system and/or distributed across multiple systems, the components of the risk analytics system 106 (the data ingestion service 116, the geofence service 118, the RAP 120, and the risk applications 126) are shown to include processor(s) 112 and memories 114. In some embodiments, the risk analytics system 106 is distributed, in whole or in part, across multiple different processing circuits. The components of the risk analytics system 106 can be implement on one, or across multiple of the memories 114 and/or the processors 112 such that, for example, each of the data ingestion service 116, the geofence service 118, the RAP 120, and/or the risk applications 126 could each be implemented on their own respective memories 114 and/or processors 112 or alternatively multiple of the components could be implemented on particular memories and/or processors (e.g., two of or more of the components could be stored on the same memory device and executed on the same processor).

The processor(s) 112 can be a general purpose or specific purpose processor, an application specific integrated circuit (ASIC), one or more field programmable gate arrays (FPGAs), a group of processing components, or other suitable processing components. The processor(s) 112 may be configured to execute computer code and/or instructions stored in the memories 114 or received from other computer readable media (e.g., CDROM, network storage, a remote server, etc.).

The memories 114 can include one or more devices (e.g., memory units, memory devices, storage devices, etc.) for storing data and/or computer code for completing and/or facilitating the various processes described in the present disclosure. The memories 114 can include random access memory (RAM), read-only memory (ROM), hard drive storage, temporary storage, non-volatile memory, flash memory, optical memory, or any other suitable memory for storing software objects and/or computer instructions. The memories 114 can include database components, object code components, script components, or any other type of information structure for supporting the various activities and information structures described in the present disclosure. The memories 114 can be communicably connected to the processor(s) 112 and can include computer code for executing (e.g., by the processor(s) 112) one or more processes described herein. The memories 114 can include multiple components (e.g., software modules, computer code, etc.) that can be performed by the processor(s) 112 (e.g., executed by the processor(s) 112). The risk analytics system 106 is shown to include a data ingestion service 116. The data ingestion service 116 can be configured to receive, collect, and/or pull threat data from the data sources 102 via the network 104.

The data ingestion service 116 can be configured to bring all relevant information on potential threats and/or actual threats into the risk analytics system 106 (e.g., based on insights gained from historical threat data analysis or data received from data sources 102). The data ingestion service 116 can perform various transformations and/or enrichments to the incoming threats and forward the transformed and/or enriched threats to the next stages of the pipeline of the risk analytics system 106, e.g., geofence service 118, RAP 120, and/or risk applications 126. The data ingestion service 116 can be configured receive threats in a variety of different formats and standardize the threats into a standard threat schema.

The risk analytics system 106 is shown to include the geofence service 118. The geofence service 118 can be configured to receive the standard threats from the data ingestion service 116 and determine which of multiple assets are affected by the threats. For example, assets, e.g., buildings, cities, people, building equipment, etc. can each be associated with a particular geofence. If a location of the standard threat violates the geofence, i.e., is within the geofence, the geofence service 118 can generate a specific threat object for that asset. In this regard, a single threat can be duplicated multiple times based on the number of assets that the threat affects. The geofence service 118 can communicate with threat service 122. Threat service 122 can be configured to buffer the threats received from data ingestion service 116 in queue or database, e.g., the threat database 124.

The standard threats can be provided by the geofence service 118 to the RAP 120. The RAP 120 can be configured to determine various risk scores for different assets and threats based on the standard threats. For example, for an asset, the RAP 120 can be configured to determine a dynamic risk score which is based on one or multiple threats affecting the asset. Furthermore, the RAP 120 can be configured to determine a baseline risk score for the asset which indicates what a normal dynamic risk score for the asset would be. In some embodiments, the baseline risk score is determined for particular threat categories. For example, the baseline risk score for a building may be different for snow than for active shooters.

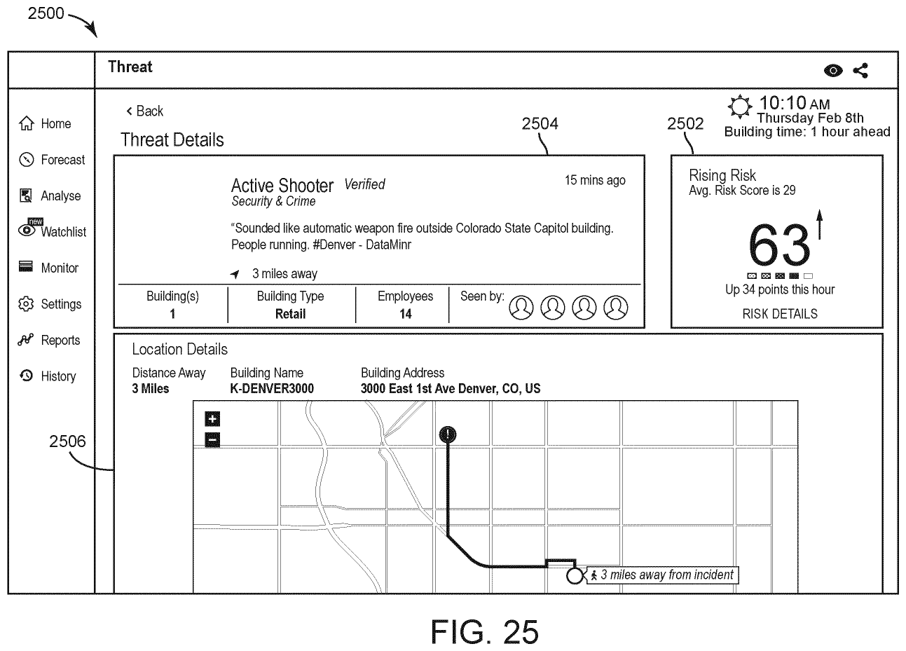

Risk analytics system 106 is shown to include the risk applications 126. The risk applications 126 can be configured to present risk information to a user. For example, the risk applications 126 can be configured to generate various risk interfaces and present the interfaces to a user via the user devices 108 via network 104. The risk applications 126 can be configured to receive the risk scores and/or other contextual information for assets and/or threats and populate the user interfaces based on the information from the RAP 120. The user interfaces as described with reference to FIGS. 25-31 can be generated and/or managed by the risk applications 126.

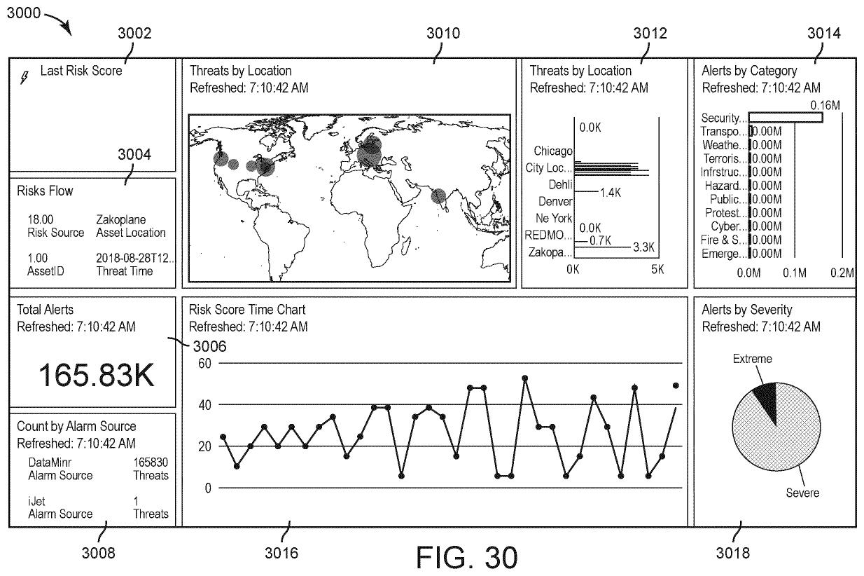

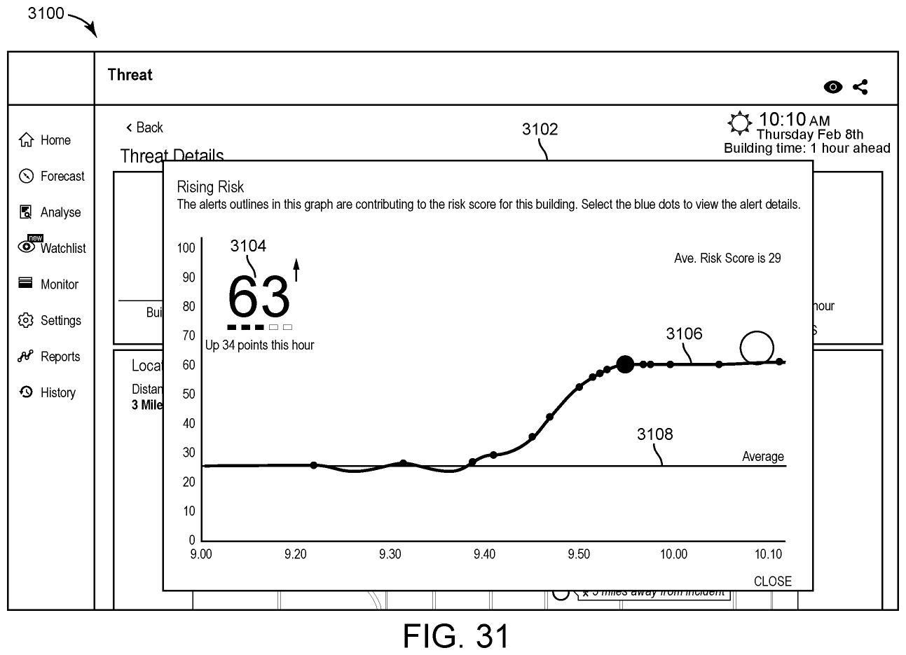

The risk applications 126 are shown to include a monitoring client 128 and a risk dashboard 130. The risk dashboard 130 can provide a user with a high level view of risk across multiple geographic locations, e.g., a geographic risk dashboard. An example of a risk dashboard that the risk dashboard 130 can be configured to generate and mange is shown in FIG. 30 and further risk dashboard interfaces are shown in FIGS. 31-33. Monitoring client 128 can be configured to present risk scores and contextual information to a user for monitoring and/or responding to threats of a building or campus. Examples of the interfaces that the monitoring client 128 can generate and/or mange are shown in FIGS. 25-29.

The user devices 108 can include user interfaces configured to present a user with the interfaces generated by the risk applications 126 and provide input to the risk applications 126 via the user interfaces. User devices 108 can include smartphones, tablets, desktop computers, laptops, and/or any other computing device that includes a user interface, whether visual (screen), input (mouse, keyboard, touchscreen, microphone based voice command) or audio (speaker).

Referring now to FIG. 2, the data ingestion service 116 is shown in greater detail, according to an exemplary embodiment. Data ingestion service 116 is shown to include a data collector 230, ingestion operators 212, and a scalable queue 222. The data collector 230 can be configured to receive, collect, and/or pull data (e.g., continuously or periodically pull data) from the data sources 102. As shown, data sources 102 include a first data source 200, a second data source 202, and a third data source 204. The data collector 230 is shown to collect a threat in a first format 206, a threat in a second format 208, and a threat in a third format 210 from the sources 200-204 respectively.

Each of the threats 206-210 is in different schema and the scale of metric (e.g., severity and threat category schema) of the threats 206-210 may be different. For example, the severity levels of the threats 206-210 can be on a 1-5 scale or on a 1-3 scale. Furthermore, the threats 206-210 can have different naming for the fields in their data schema even though they represent the same piece of information like different names for the same threat categories.

The ingestion operators 212 can be configured to perform processing operations on the threats 206-210 to generate standard threats and put the standard threats in scalable queue 222 before forwarding the threats 224-228 to other services (e.g., the geofence service 118). The ingestion operators 212 are shown to include a standardize operator 214, an expiry time predictor 216, an NLP engine 218, and a cross-correlator 220. The standardize operator 214 can be configured to convert the schema (e.g., severity scales, data storage formats, etc.) of the threats 206 to a standard schema and generate corresponding standard threats 224-228 (e.g., defined data objects with particular attributes).

Expiry time predictor 216 can be configured to generate, via various timing models, how long the threats 206-210 will last, i.e., when the threats 206-210 will expire. The expiry time may be added to the standard threats 224-228 as a data element. NLP engine 218 can be configured to categorize the threats 206-210. Since the category included in each of threats 206-210 may be for a different schema, the NLP engine 218 can perform natural language processing on a category and/or summary text of the threats 206-210 to assign the threats to a particular category. The assigned categories can be included in the threats 224-228. The cross-correlator 220 can be configured to group the threats 224-228. Since multiple sources 200-204 are generating the threats 206-210, it is possible that two sources are reporting the same incident. In this regard, the cross-correlator 220 can be configured to perform cross-correlation to group threats 224-228 that describe the same incident so as not to generate duplicate threats.

Where available, a threat expiration time can be extracted by the expiry time predictor 216 from a threat. If the expiration time cannot be extracted from the threat, the expiry time predictor 216 can be configured to use analytics performed on the historical threat data to determine the threat expiration time. For example, a traffic incident may be expected to take a particular amount of time to be responded and handled by the local authorities given the severity, type and location of the threat calculated periodically from similar historical incidents can be used to determine the threat expiration time. If the threat expiration time cannot be identified from the threat parameter database, a static or default threat expiration time can be used. The threat expiration time for the threat and/or asset can be stored in the active threats database 328.

Referring now to FIG. 3, a process 250 for ingesting data with the data ingestion service 116 is shown, according to an exemplary embodiment. The data ingestion service 116 can be configured to perform the process 250. Furthermore, any computing device (e.g., the risk analytics system 106) can be configured to perform the process 250.

In step 252, the data collector 230 can pull data from the data sources 102. Data collector 230 can implement multiple processes in parallel to pull data from the multiple data sources. In this regard, step 252 is shown to include steps 254, 256, and 258, each of the steps 254, 256, and 258 can include pulling data from a particular data source, e.g., a first data source, a second data source, and a third data source, the data sources 200-204.

In step 260, the standardize operator 214 can convert threats pulled from multiple data sources to standardized threats. More specifically, the standardize operator 214 can convert a first threat to the standard threat 224, a second threat to the standard threat 226, and a third threat to the standard threat 228. Each of the standard threats converted can be received from different data sources and/or the same data source.

Different formats and data schemas might be used by the different data sources and thus each threat may have a different schema. In step 260, the standardize operator 214 can perform multiple operations to convert all the incoming threats to a standard threat objects, the standard threats 224-228. The standardize operator 214 can perform one or multiple (e.g., a series) of static mappings. For example, the standardize operator 214 can adjusting the scales for severity levels of the threats using the same naming for the data fields that present in all the ingested threats like the summary, location info and category. The step 260 is shown to include multiple sub-steps, convert first threat 262, convert second threat 264, and convert third threat 266. The steps 262-266 indicate the steps that the standardize operator 214 can perform (e.g., either in parallel or in sequence) to convert the threats received in the steps 254-258 into the standard threats 224-228.

Part of the conversion of the step 260 into the standard threats 224-228 may include identifying a category for each of the incoming threats, the category being added and/or filled in the standard threats 224-228. The categories can be identified via the NLP engine 218. In this regard, the standardize operator 214 can perform a call to the NLP engine 218 to cause the NLP engine 218 to identify a category for each of the threats received in the step 252. In response to receiving the call to the step 268 (and/or the original threats themselves), the NLP engine 218 can identify a category for each of the incoming threats.

In step 270, expiry time predictor 216 can predict an expiry time for each of the standard threats 224-228. The expiry time may indicate how long it will take a particular threat to expire, e.g., how long it takes for the effects of an incident to be resolved and/or be eliminated. The step 270 can be made up of multiple processes (performed in parallel or performed in series), i.e., the steps 274, 276, and 278, each step including predicting an expiry time for each of the standard threats 224-228. The expiry time predictor 216 may call an expiry time model 280 (step 272) to determine the expiry time for each of the standard threats 224-228. The expiry time model 280 can generate an expiry time for each of the standard threats 224-228 based on the information of the standard threats 224-228 (e.g., the category of the threat, a description of the threat, a severity of the threat, etc.). The expiry time model 280 can be a component of the expiry time predictor 216 or otherwise a component of the data ingestion service 116.

The data ingestion service 116 can add the standard threats 224, 226, and 228 into the scalable queue 222. The scalable queue 222 could have different implementations like Apache Kafka or Azure Eventhubs in various embodiments. The queue 222 is designed in a way that it can ingest large volume of incoming messages and is able to scale horizontally. In step 282, the cross-correlator 220 can group related threats together so that threats that describe the same event are de-duplicated. The result of the cross-correlation by cross-correlator 220 can be grouped threats 284 which can include groups of multiple threats reported by different data sources each relating to the same event. The grouped threats 284 can be added back into the scalable queue 222 and/or forwarded on to the geofence service 118. The scalable queue 222 can be implemented via Apache Kafka and/or Azure Event-hubs and can buffer the incoming traffic until the running processes e.g., the steps 260, 270, 282) finish processing them.

Referring now to FIG. 4, the RAP 120 of FIG. 1 is shown in greater detail, according to an exemplary embodiment. The RAP 120 can be configured to receive threats, standard threat 300, from the geofence service 118. The standard threat can be enriched with asset information by asset information enricher 302 (e.g., asset information can be added into the standard threat 300 data object). The RAP 120 is shown to include the asset information enricher 302 and an asset service 304. The asset service 304 is shown to include an asset database 306. The asset database can include information indicating various different types of assets (e.g., buildings, people, cars, building equipment, etc.). Asset information enricher 302 can send a request for asset information for a particular asset affected by the standard threat 300 to asset service 304. Asset service 304 can retrieve the asset information and provide the asset information to asset information enricher 302 for enriching the standard threat 300. The asset database 306 can be an entity-relationship database e.g., the database described with reference to U.S. patent application Ser. No. 16/048,052, filed Jul. 27, 2018, the entirety of which is incorporated by reference herein.

The result of the enrichment by the asset information enricher 302 is the enriched threat 308. The enriched threat 308 can include an indication of a threat, an indication of an asset affected by the threat, and contextual information of the asset and/or threat. The RAP 120 includes risk engine 310 and risk score enricher 312. Risk engine 310 can be configured to generate a risk score (or scores) for the enriched threat 308. Risk engine 310 can be configured to generate a dynamic risk score for the enriched threat 308. The risk score enricher 312 can cause the dynamic risk can be included in the enriched threat 316 generated based on the enriched threat 308.

Batch process manager 318 can implement particular processes that are configured to generate dynamic risk 332 and baseline risk 334 for presentation in a user interface of risk applications 126. Batch process manager 318 is shown to include risk decay manager 320, threat expiration manager 322, and base risk updater 324. Each of the components of batch process manager 318 can be implemented as a batch process and executed by the batch process manager 318. Risk decay manager 320 can be configured to determine and/or decay a dynamic risk score of the enriched threat 316 based on a particular decay model (e.g., a linear decay model, an exponential decay model, a polynomial decay model, etc.). In this regard, the risk decay manager 320 can cause a value of the dynamic risk score to lower over time.

The batch process manager 318 is shown to communicate with databases, risk decay database 326, active threats database 328, and base risk database 330. The risk decay database 326 can store risk decay models and/or associations between particular threats and/or assets and particular decay models. The risk decay manager 320 can call the risk decay database 326 to retrieve particular decay models and/or decay parameters based on an asset and/or threat. The active threats database 328 can store an indication of an expiration time for the threat expiration manager 322. In some embodiments, the active threats database 328 stores models for determining a threat expiration time for a threat and/or asset. The base risk database 330 can store an indication of a base risk value for each of multiple different threat categories for particular assets that the base risk updater 324 can be configured to determine.

The threat expiration manager 322 can be configured to expire, e.g., delete, a threat based on an expiration time. The expiration time can be included within the enriched threat 316 and can be generated by the expiry time predictor 216 as described with reference to FIG. 2. The base risk updater 324 can be configured to generate the baseline risk 334. The baseline risk 334 may be a baseline risk value indicative of a normal baseline risk value for a particular asset and/or a particular threat category for that asset considering the historical data. Baseline risk score provides a good metric to compare different neighborhoods and assets in terms of the “norms” and trends for different threat categories. For example, one neighborhood could have a higher baseline risk score in crime compared to another but has much less score for extreme weather calculated over years of historical data. Providing both the dynamic risk 332 and the baseline risk 334 to the risk applications 126 can enable the risk applications 126 to generate user interfaces that present both a real-time risk value, the dynamic risk 332, for a particular asset but also a baseline risk value, the baseline risk 334, so that a user can understand contextually what the dynamic risk 332 means for a particular asset since the user is able to compare the dynamic risk 332 to the baseline risk 334.

The risk decay manager 320 can be a mechanism for dynamically changing a risk score of an asset over time to more accurately represent the actual significance of an alarm event associated with an asset. The risk decay manager 320 can be configured to apply a decay model that reduces risk score over time. The parameters of the models can be learned by the risk decay manager 320 from historical data making the model adaptive towards ever-changing nature of threats. The decaying asset risk score can be used by the risk applications 116 to sort and filter threats occurring in relation to that asset. The order of the threats displayed (e.g., in a list) can change based on the risk decay performed by the risk decay manager 320.

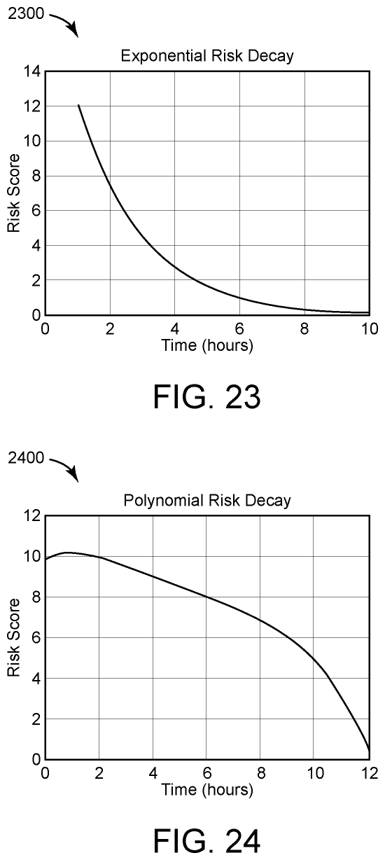

The risk decay manager 320 can determine a decay model based the type of threat. The risk decay manager 320 can be implemented in the RAP 120 and/or in the risk applications 126. Decay models define how the risk changes over time and can be tuned for specific applications. Examples of decay models can be exponential decay models, polynomial decay models, and linear decay models. Examples are shown in FIGS. 23-24. The threat may include a risk score determined for the asset by the risk engine 310. The risk score and/or the threat can be stored in the risk database 314. Using the identified decay model and threat expiration time, the risk decay manager 320 can be configured to update the risk score by decaying the risk score. In this way, the risk score is periodically reduced according to the decay model until the contributing threats are closed.

Using the polynomial decay model facilitates a dynamic decay that can be adapted for particular situations. For example, the polynomial could incorporate a factor to account for the time of day that could change the decay curve for night time events. The polynomial model also captures the natural progress of the risk in most scenarios by a slow decay at the beginning of the curve then a fast decay when approaching the estimated threat expiration time for that threat. This behavior is observed in many threats that reflect how the situation is handled after first responders are at the scene. The slope of the curve is configurable for each type of threats to best match the natural dynamic of that threat in specific. The decay models can be automatically selected for different assets, asset types, and threat categories.

Using the decayed risk score and/or other risk scores for other assets, the risk applications 126 can sort and/or filter the threats for display on a user interface. In this regard, one threat may immediately rise to the top of a threat list but over time fall down the threat list due to the decay determined by the risk decay manager 320. An interface could include selectable monitoring zones and threat events. Each threat event may have a type, a date, a time, an identifier (ID) number, an alarm location, and a risk score. The risk score of the event is the risk score associated with the asset under threat. The threats can be sorted by multiple properties including risk scores.

The decay process performed by the risk decay manager 320 can continue until the risk score returns to the baseline asset risk score or the estimated duration is reached. Additionally, the risk of a specific threat can be eliminated if such a notification is received from the original event source. For example, a weather update notifying that the tornado has stopped. The risk score can also be updated by accessing data feeds from external sources. For example, the tornado severity classification is upgraded by another weather service (or multiple sources). The risk score will change and evolve to reflect the actual risk of the event. The result of a risk decay is a more realistic and reflective of how risk scores should evolve.

Referring now to FIG. 5, a mapping 500 is shown for two exemplary threat categories, category of a data source 504 and categories of a data source 506 into categories of master list 502. Mapping between threat categories to the master threat list can be supported by the threat ingestion service 116. In some embodiments, there is a set of defined threats that the system 106 is configured to protect assets against. This set of known threat list is the master list 502 that the system 106 can be configured to recognize and ingest into the pipeline. The master threat list 502 supported by the system 106 can be updated and/or generated based on vulnerabilities of the assets of a particular building and/or site.

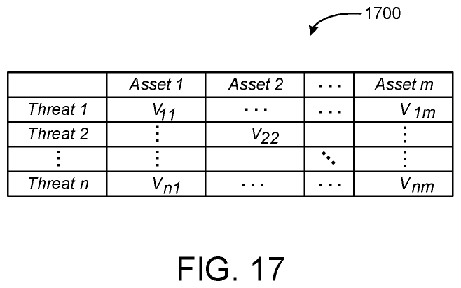

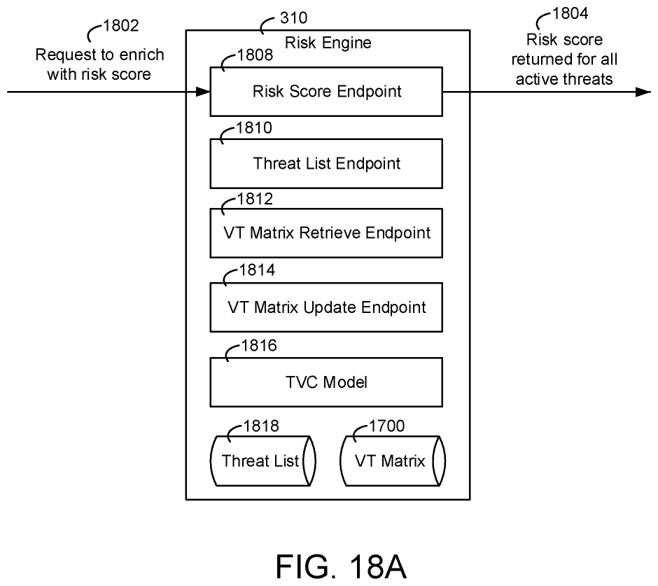

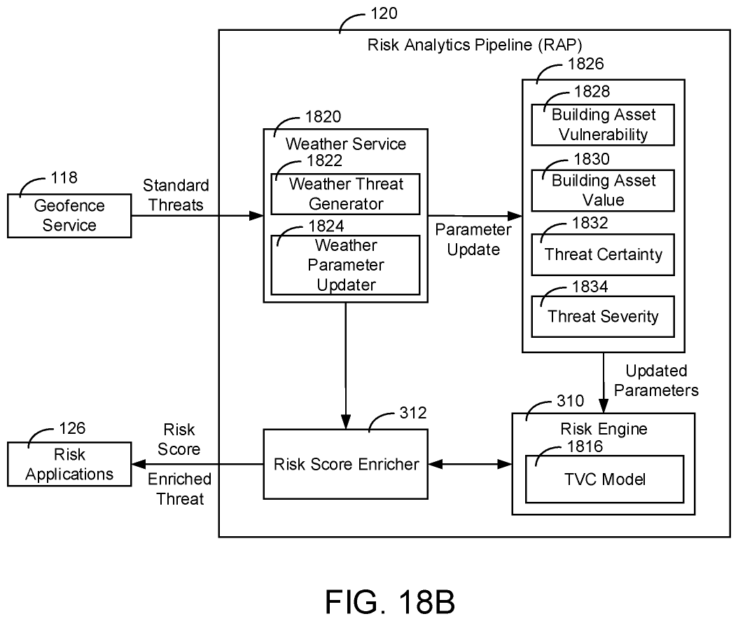

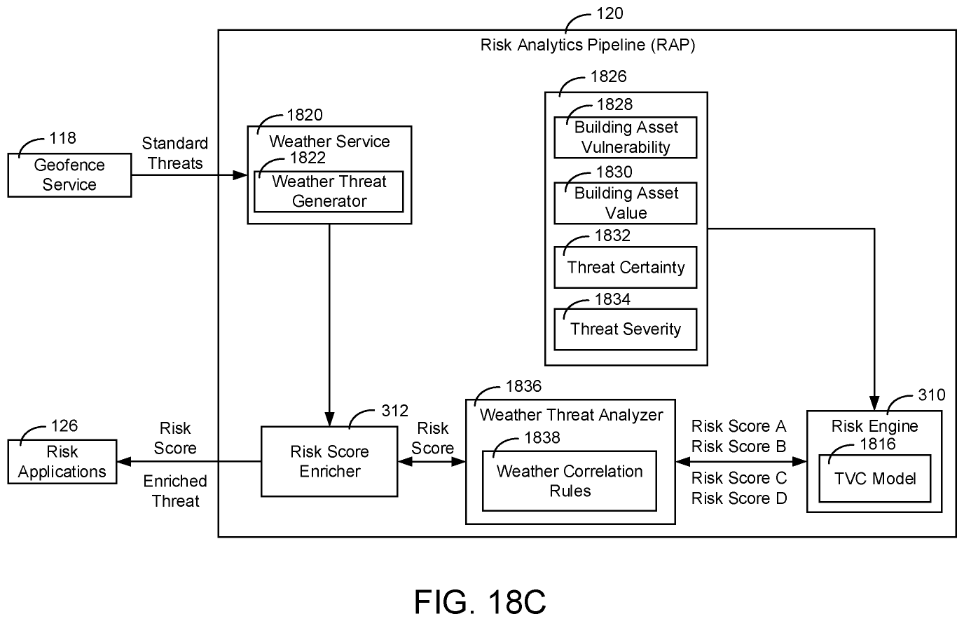

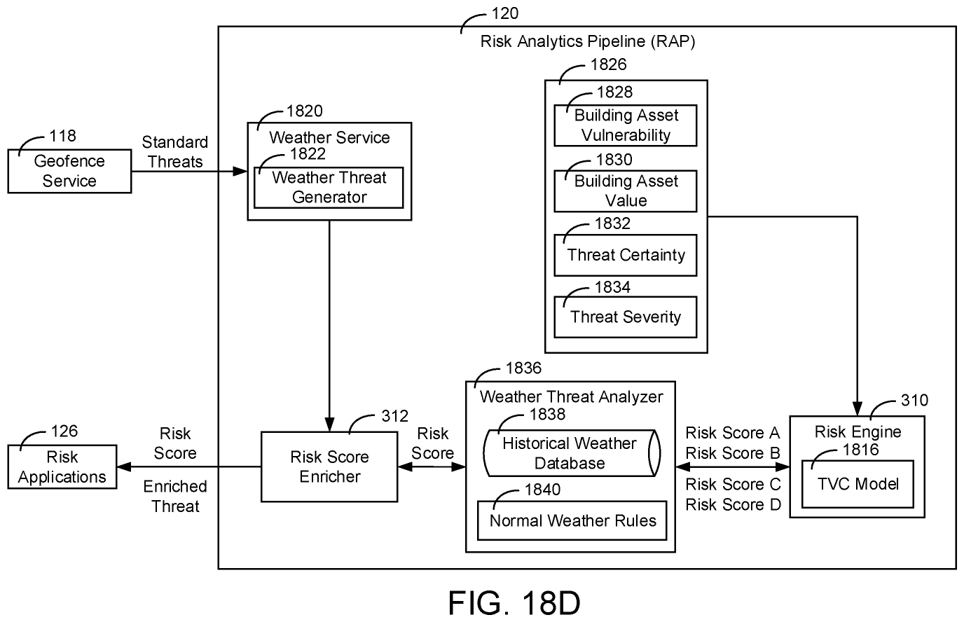

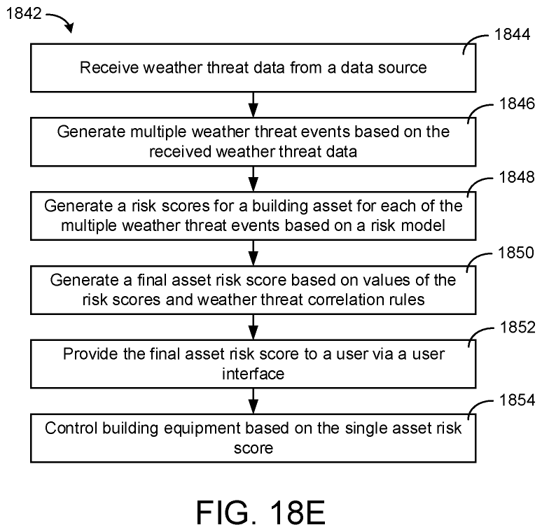

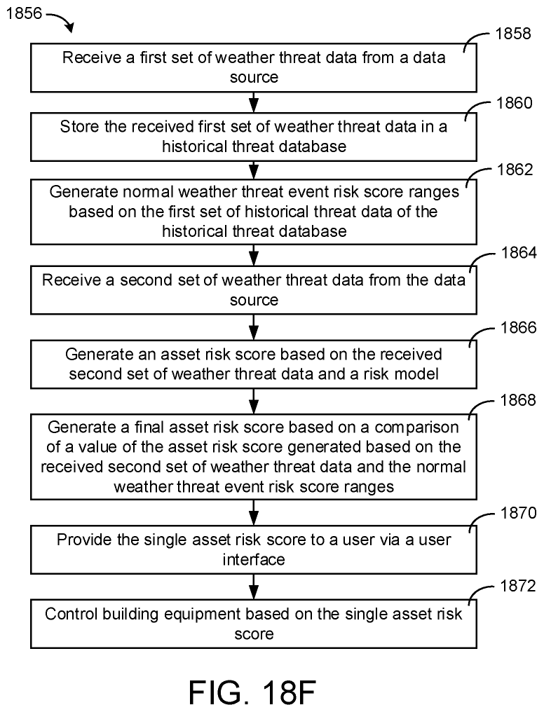

The type of threats might be very different from one asset to another. The master list 502 can act as a union of all the threats that might impact any of the assets of the building and/or the site. With reference to FIGS. 17-18, risk calculation, the TVC model, and the VT matrix are described. In this regard, the mapping shown in FIG. 5 can be implemented in the risk calculation as described elsewhere herein. So knowing the type of the threat coming into the pipeline may be important for the risk calculation that will happen later in the pipeline since asset vulnerabilities depend on threat category.

Many data sources provide the category and sub-category information about the reported threats. In some cases there might be a static mapping between those threats and the master threat list 502. However, a direct static mapping might not exist for all the categories. In FIG. 5, there are two data sources, the data source 504 and the data source 506 for reporting crime and security related threats. The data source 504 two categories of security criminal activity and drugs and the data source 506 has a category for crime that includes police activity and shootings. However the master list 502 supported in the system that has been identified in this scenario includes much more detailed sub-categories for crime.

It can be seen that there is a static mapping for some categories and sub-categories but for example for criminal activity there is no direct mapping to any of the sub-categories on the master list. To be able to accurately identify the sub-category of the crime discussed in the threat summary, the NLP engine 218 can be configured to process the textual summary of the threat to find the closest sub-category on the master list that will be a good representation of the topic for that threat.

Referring now to FIG. 6, the NLP engine 218 as described with reference to FIG. 2 is shown in greater detail, according to an exemplary embodiment. The NLP engine 218 can include a RESTful interface (the web server 602, the WSGI server 604, and the WSGI application 606) and a classification model 608. The NLP engine 218 can be configured to categorize a threat into the standard categories supported by the system (e.g., the master list 502 as described with reference to FIG. 5). The service can be made up of an Application Programming Interface (API) layer on top of a machine learning model that represent the classifier trained to understand the standard categories.

The process 600 can be the operation performed by the standardize operator 214 and/or a message (an HTTP request) sent from the standardize operator 214 to the NLP engine 218 to get the threat category for the new incoming threats. The standardize operator 214 can talk to a high-performance web server, the web server 602, that can be configured to work as a reverse proxy relaying all the incoming requests to the underlying WSGI server 604.

It is the reverse proxy implemented via the web server 602 that exposes the NLP engine 218 to the outside world (e.g., the standardize operator 214). This provides solid security and scalability built-into the NLP engine 218. The web server 602 can be different in different embodiments but can be Nginx web servers and/or Apache web servers. The WSGI server 604 can be a scalable server that can process requests in parallel. There are many different options for WSGI servers. For example, the WSGI server 604 can be a Gunicorn server. The WSGI server 604 can be configured to communicate with the underlying WSGI application 606 in order to do the calculations and return the results of the classification. The classification model 608 can be a Machine Learning model that is used by the WSGI application 606 to do the categorization of the threats.

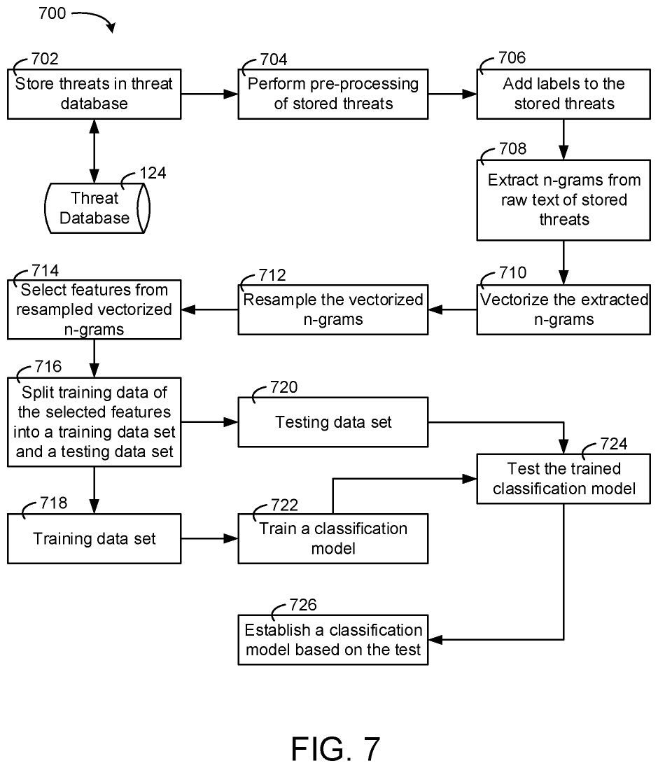

Referring now to FIG. 7, a process 700 for generating the classification model 608 via the NLP engine 218 is shown, according to an exemplary embodiment. The process 700 illustrates supervised methods for generating the classification model 608. However, in some embodiments, unsupervised methods can be performed to generate the classification model 608. The risk analytics system 106, more specifically, the data ingestion service 116 and/or the threats service 122 can be configured to perform the process 700. Furthermore, any computing device as described herein can be configured to perform the process 700.

In step 702, the threats service 122 can store historical threats coming into the system 106 in the threat database 124. All the threats can be ingested and stored for analytics by the threats service 122. The ingested historical threat data stored in the threat database 124 can be utilized to develop a language model.

In step 704, the NLP engine 218 can perform pre-processing on the stored threats. Pre-processing can include the initial steps in the NLP pipeline. The text summary of the threats coming in might include a lot of noise, links, and characters that do not have any significant meaning for the purpose of risk modeling. In this step, the NLP engine 218 can remove the links, text words or phrases which are too short or too long, and/or the stop words along with the special characters (e.g., “&,” “!,” etc.)

In step 706, after filtering out some of the threats in the pre-processing step 704, the NLP engine 218 can label a small portion of the threats with the corresponding standard categories that the system supports, e.g., the categories as shown in the master list 502 of FIG. 5. The labeling step 706 can include requirements in order to make sure high quality data is generated for training the classification model 608. The requirements can include that threats be reviewed by a human to correctly identify the right category for that threat. The requirements can include that only the threats that clearly fall in that category need to be labeled otherwise they are skipped. Furthermore, labeling can be done by multiple users to avoid bias and personal opinions and minimize human errors. The requirements can include that multiple categories can be applied to a single threat. For example if there is “police activity” and “drugs” on the master threat list 502 then they both might apply to the incidents that report police presence at a drug related bust. In this regard, the NLP engine 218 can handle multiple labels for each threat.

The requirements can further include having good coverage on all the categories on the list of the threats that are picked from the historical threat store should be distributed among all the categories. For example, there may need to be example labelled threats in every category. A minimum 20 examples in each category may be required to cover all the categories in the model. Furthermore, considering the preceding requirement, the distribution of the threats that are picked up for labeling should not disturb the natural frequency of threats in categories drastically. This means that the ingested data by nature has more threats on crime category than weather incidents for example. The sampling strategy can respect this bias and have more samples in crime category picked for labeling.

In step 708, after the labeling is performed in the step 706, n-grams can be extracted from the raw text of the labeled threats by the NLP engine 218. Going beyond bigrams may have has little to no value added for the increased complexity of the model. In this regard, the n-grams may be limited to unigrams and bigrams. Examples of unigrams and bigrams may be specific highly occurring words for word groups. For example, bigrams (2-grams) could be “Police Shooting,” “Gas Fire,” and “Armed Robbery” while examples of unigrams (1-grams) can be “Police,” “Fire,” and “Robbery.”

In step 710, the NLP engine 218 can vectorize the extracted n-grams (e.g., the unigrams and bigrams). The extracted n-grams can be vectorized in a high-dimensional vector space. Vectorizing the n-grams enables the NLP engine 218 to work with numbers instead of words. The NLP engine 218 can be configured to utilize bag of words and/or count-vectorizer to vectorize the n-grams. Vectorizing may indicate the frequency at which particular words occur, in the example of bag-of words vectorization, a bag-of-words data structure could be,

BoW={“Fire”: 40, “Shooting”: 20, “Rain”: 3, “Heavy Rain”: 2}; which indicates that the unigrams “Fire,” “Shooting,” and “Rain” occurred 40, 20, and 3 times respectively and the bigram “Heavy Rain” occurred twice.

In some embodiments, the class imbalance in the data might be too big to ignore. In response to detecting a class imbalance, the NLP engine 218 can perform, in step 712, over-sampling of the minority classes and/or under-sampling of majority classes. The NLP engine 218 can perform resampling (over-sampling and/or under-sampling) based on the Imbalanced-learn Python library.

In some cases, the number of features for the classifier is very large. Not all the features have the same level of importance in training a model. The features that are not strongly relevant to the classification can be removed by the NLP engine 218 with minimal impact on the accuracy of the classification model 608. For this reason, in step 714, the NLP engine 218 can select the most importance features for classification. The NLP engine 218 can be configured to perform a statistical relevance tests like x² (Chi-Squared) test can be used as a measure of importance of a feature. Scikit-learn library for Python can be implemented by the NLP engine 218 to perform the selection. In some embodiments, the NLP engine 218 can select a predefined number (e.g., the top 10 percent) of the most importance features. Selected features can be particular n-grams that are important.

In step 716, the NLP engine 218 can split the data set of the selected features of the step 714 into a test data set 720 and a training data set 718. The ratio between test and training data might be different in different applications. In some embodiments, the training data set 718 is larger than the testing data set 720. In some embodiments, the training data set includes 80% of the data set while the testing data set includes 20% of the data set.

The NLP engine 218 can train the classification model 608 using the training data set 718 in step 722. The classification model 608 can be one or multiple different classifiers. The classification model 608 can be a Naïve Bayes and/or Random Forrest model. Naïve Bayes may be not as accurate as Random Forest but it has the speed advantage compared to Random Forest. Depending on the size of the data and number of features, Naïve Bayes can be much faster to train compared to Random Forest. However, if pure accuracy is the ultimate goal Random Forest may be the best choice.

In step 724, the testing data set 720 can be used by the NLP engine 218 to test the trained classification model 608 and make sure the classification model 608 provides satisfactory performance. Precision and Recall per class needs to be calculated to evaluate the model. If the trained classification model 608 is successfully tested (e.g., has an accuracy above a predefined accuracy level), the NLP engine 218 establishes the classification model 608 by deploying the classification model 608 on the WSGI application 606 within in the NLP engine 218 (step 726). If the classification model 608 is not good enough (has an accuracy below the predefined accuracy level), the training process needs to repeat with more data, different features and different model parameters until the satisfactory results are achieved (e.g., repeat the process 700 again any number of times).

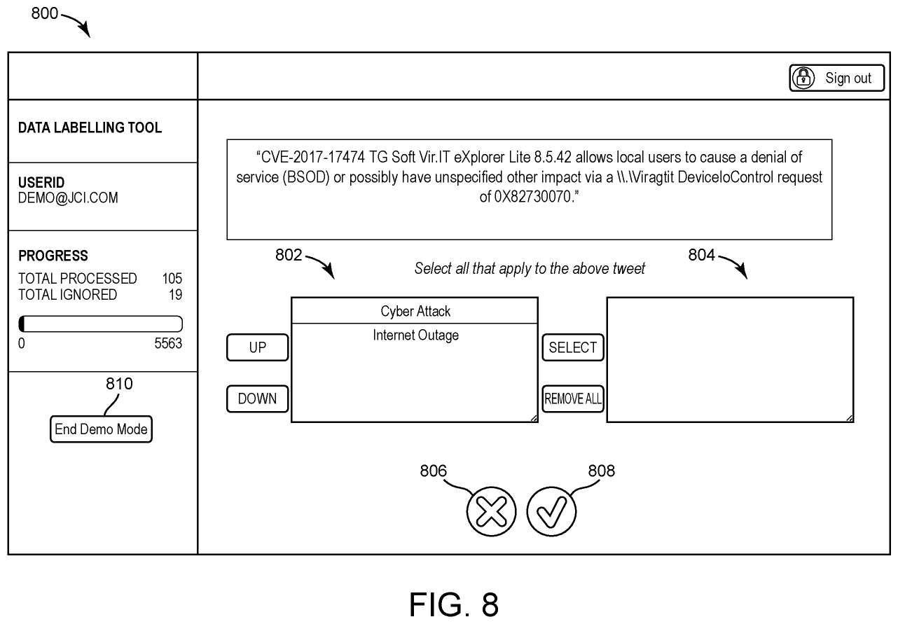

Referring now to FIG. 8, an interface 800 for a data labeling tool is shown, according to an exemplary embodiment. The data labeling tool can be used to perform the step 706 of the process 700. Furthermore, the data labeling tool can meet all of the requirements for the step 706. The data labeling tool is user friendly tool that can be used to label data for developing supervised machine learning models, e.g., the classification model 608.

The labeling tool can be a component connected to the threats service 122 and can be configured to load the threats stored in the threat database 124, apply the pre-processing to filter out the noisy threats and then provides the threats one by one to the user via the interface 800 to generate labels for each threat based on user input indicating the labels. In interface 800, a potential threat that has been reported from social media (e.g., TWITTER, FACEBOOK, etc.) has been loaded and the possible labels for that tweet are suggested as options to be picked for the user in element 802. The user selects all the labels of the element 802 that apply to that threat and then accepts the labels by pressing the checkmark button 808. This causes the selected labels to be moved from element 802 to a list in element 804. In case the threat loaded is not suitable for labeling (e.g., it does not have clear relevance to the threat categories) the user can skip that threat and go to the next threat by pressing the “x” button 806. The buttons 806 and 808 can be included in the interface 800 to satisfy the requirement that only threats that clearly fall into a category are labeled otherwise they are skipped.

The interface 800 is shown to include demo mode element 810 which can include text “Demo Mode” and “End Demo Mode.” The demo mode enables new users to get familiar with the labeling tool without generating inaccurate labels on the system. This feature helps the users to quickly interact with the tool and feel confident about what they will be doing with the tool before the actual labeling begins.

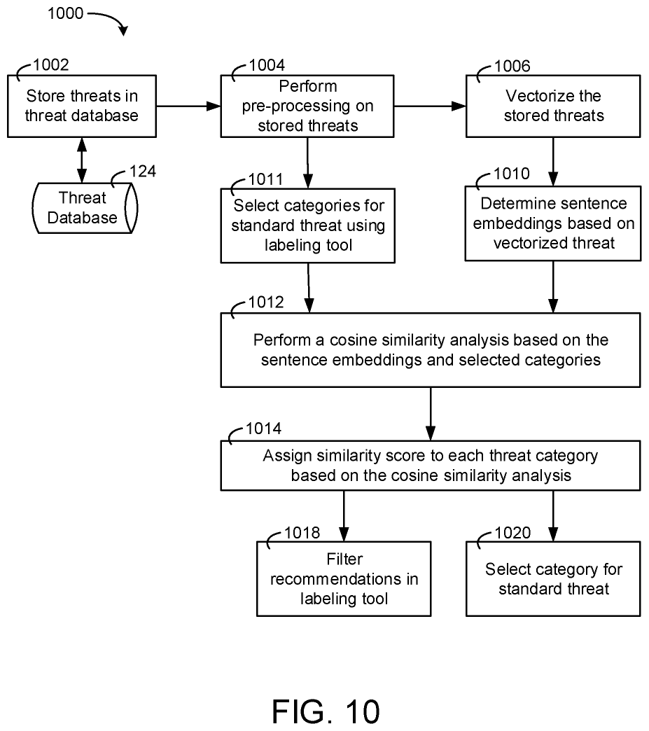

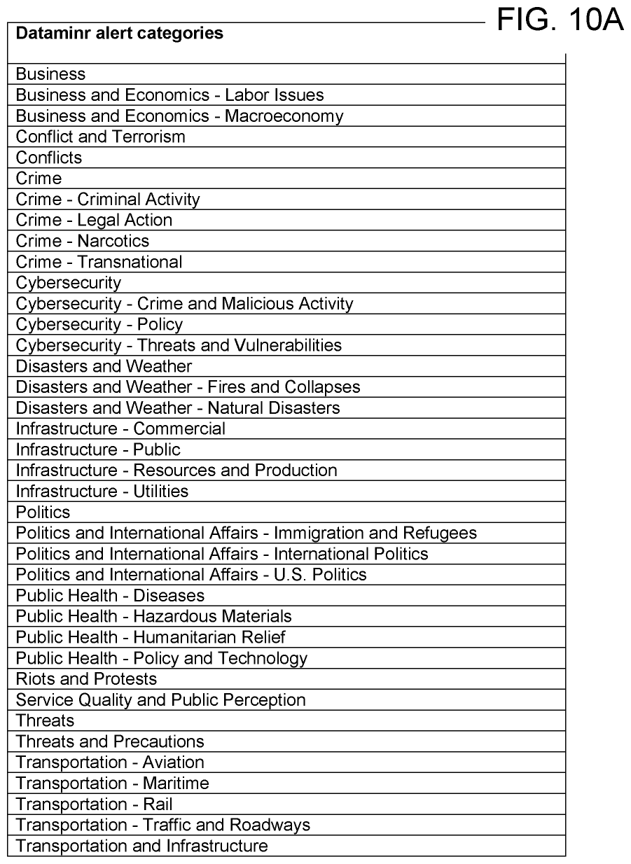

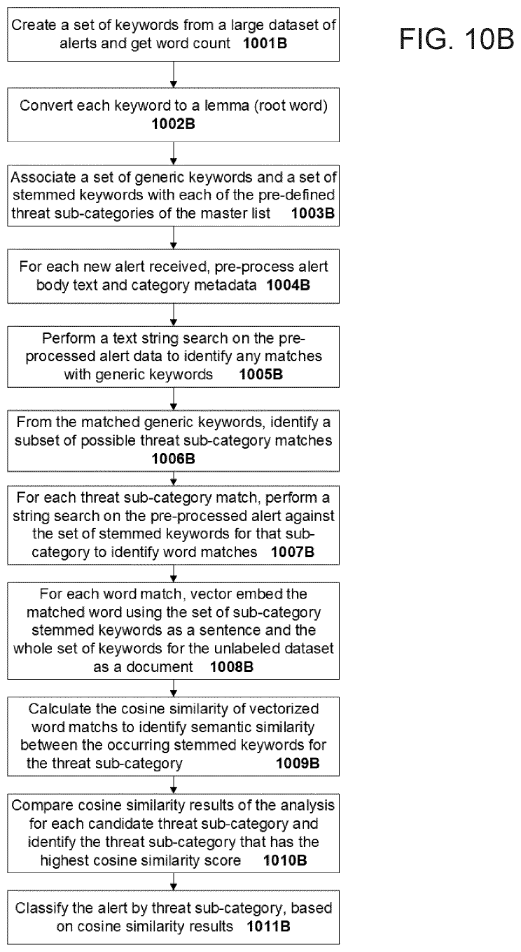

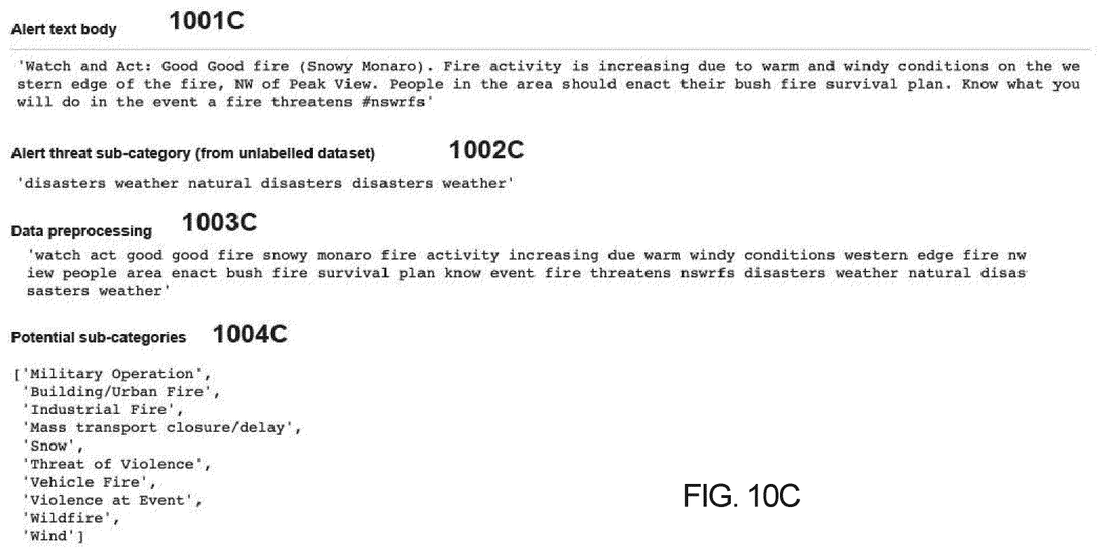

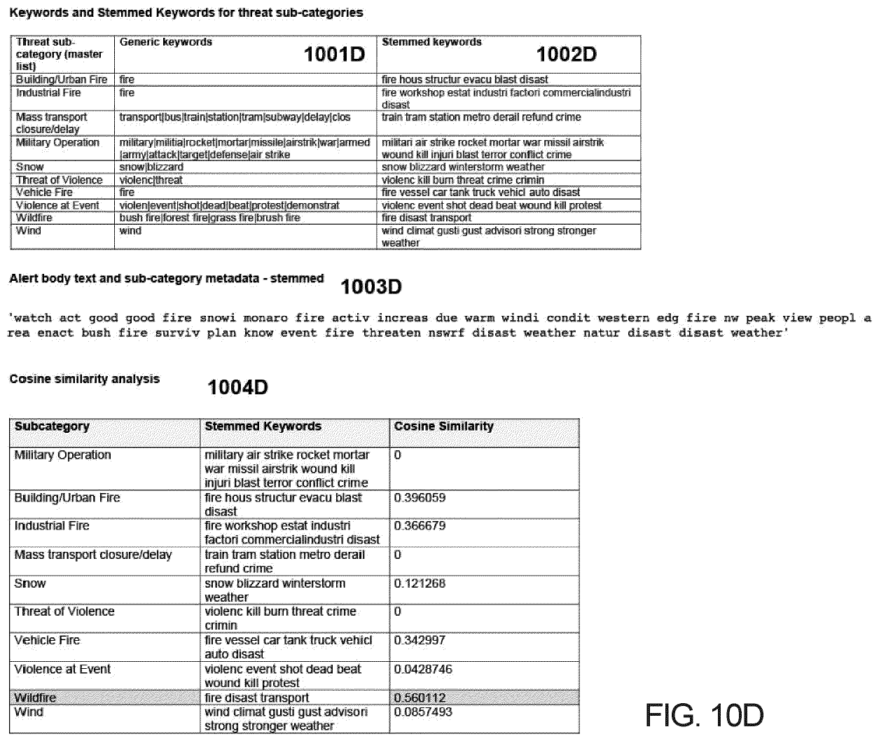

The master list of all the threats that are supported by the system, e.g., the master list 502 as described with reference to FIG. 5, can be long depending on the assets and their vulnerabilities that the system 106 is monitoring against. It can be very tedious and unpractical to populate the page with all the threats to choose from for the user of the tool. In this regard, the tool can be configured to automatically recommend potential categories for each threat, e.g., a subset of the total master list 502 and therefore the list presented to the user is much shorter than the master list 502. The recommendations are presented to the user based on a cosine similarity analysis of sentence embeddings as described with reference to FIG. 10.

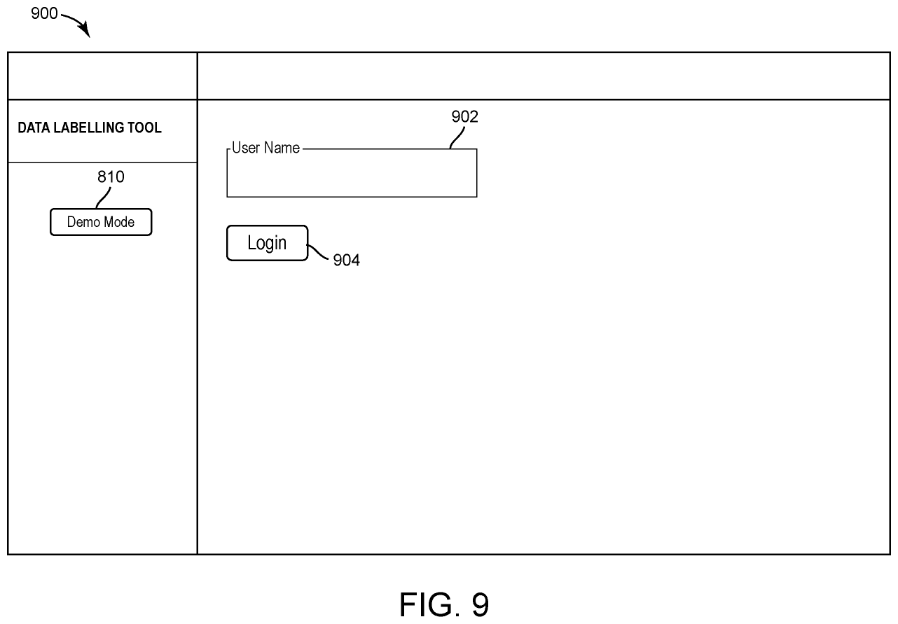

Referring now to FIG. 9, an interface 900 for a login page of the labeling tool is shown, according to an exemplary embodiment. The interface 900 can satisfy the requirement for data labeling that labeling must be done by multiple users to avoid bias and personal opinions, minimizing error. This login interface 900 ensures an extra security layer for the labeling tool and also making sure that multiple users and sessions work with the labeling tool. The user can enter their user name via the input box 902 and press the login button 904 to login with the user name. In some embodiments, the labeling tool determines, based on the users that have logged in and/or based on how many labels the particular user has performed, whether an appropriate diversity of user inputs has been received. In some embodiments, all the labeling activities are tied to the user that has performed the labeling. In this regard, if a particular user is identified as not properly labeling the threats, those labeling activities tied to the identified user can be removed from the dataset used to train the classification model 608.

Referring now to FIG. 10, a process 1000 is shown for performing a similarity analysis of threats for threat categories for use in the labeling tool as described with reference to FIGS. 8-9 is shown, according to an exemplary embodiment. The NLP engine 218 and/or alternatively the labeling tool can be configured to perform the process 1000. The similarity analysis of the process 1000 can be used to determine how similar two words or sentences are. With the recent developments in Word Embeddings there have been efficient algorithms developed to build language models out of any large corpus. Word2Vec and GloVe are the two algorithms to obtain high-dimensional vector representations of words in a corpus. The developed vector models are different for different texts because of the differences in the context and the type of expressions used specifically in that context. For example, the type of the words and expressions frequently used in on twitter are very different than the language used in a newspaper or a book. For the purpose of risk and threat modeling the language is very specific to the security operations and the specific models described herein can be used to collect and analyze the threats.

In step 1002, the threat service 122 stores received and ingested threats in the threat database 124, e.g., historical threats. The step 1002 may be the same as and/or similar to the step 702 as described with reference to FIG. 7. In step 1004, the stored threats can be pre-processed by the NLP engine 218. In some embodiments, the pre-processing includes removing stop words, periods, etc. The step 1004 can be the same as and/or similar to the step 704 as described with reference to FIG. 7.

The stored threats, in step 1006, can be vectorized by the NLP engine 218. For example, the stored threats can be fed by the NLP engine 218 into the Word2Vec. The step 1006 can be the same and/or similar to the step 710 as described with reference to FIG. 7. Word2Vec can generate a high-dimensional vector representations for the words used in the context of threats. One implementation of Word2Vec may be performed with the Python module Gensim.

The word vectors that result from perform the step 1006 can be used to obtain sentence embeddings by the NLP engine 218 in step 1010. There are multiple ways (e.g., calculating averages) to determine a sentence embedding. In some embodiments, the sentence embedding is determined according to the process described in Y. L. T. M. Sanjeev Arora, “A Simple But Tough-To-Beat Baseline For Sentence Embeddings,” in International Conference on Learning Representations (ICLR), Toulon, France, 2017.

In step 1011, a user can select one or multiple categories for a threat using the labeling tool. Based on the sentence embeddings of the step 1010 and the selected categories of the step 1018, the NLP engine 218 can, in step 1012 perform a similarity analysis (e.g., a cosine similarity analysis) to determine and assign (in step 1014) a score for each of the categories for each of the threats. For example, each threat can include a score for each of the categories.

In step 1018, the labeling tool can use the similarity score to filter which labels are recommended to a user for confirming which labels are appropriate for particular threats (e.g., suggest categories with a score above a predefined amount and/or select a predefined number of the highest scored categories). After the initial labels are put on some data that labeled data (the step 1011) that is used to calculate the similarity of those labels to the new coming threats. The most relevant labels are shown to the user and the rest of the categories are dropped from the list. This helps the user to be able to quickly identify the potential labels without getting inundated with all the possible labels. In step 1020, the NLP engine 218 can select the category and/or categories for a particular threat based on the scores (e.g., select the highest score). Using the similarity score to select the label for a threat can be used as an alternative and/or together with the classification model 608.

Referring now generally to FIG. 10A, FIG. 10B, FIG. 10C, and FIG. 10D, an unsupervised method of generating the classification model 608 of NLP engine 218 is described, according to an exemplary embodiment. Some external threat data sources provide labelled data with threat category classifications that can be used to train a learning model, such as the supervised methods described above. However, other external data sources are less organized and may be unlabeled or inconsistently labelled. For example, the threat categories and threat sub-categories of Dataminr alerts are not reliable to map to the master list of threat sub-categories referred to in 502 of FIG. 5. A list of all the threat categories used in Dataminr alerts is shown in FIG. 10A. Alerts in Dataminr may be assigned with one or more of these categories. These categories are not reliable to map to the master list of threat sub-categories 502 of FIG. 5. In addition, some Dataminr alerts may consist of random text that is not related to any particular category. In order to address the problems created by an unlabeled dataset of alerts, a data exploration of the unlabeled dataset is performed and is described herein using an alert dataset from Dataminr as an illustration of the method.

Referring now to FIG. 10B, an overall process for generating a classification model is described, according to an exemplary embodiment.

From a large dataset of unlabeled alerts (e.g., a set of Dataminr alerts), a list of keywords is created, based on all the words occurring in the unlabeled dataset 1001B. Keywords are extracted both from the alert text body and the alert's category metadata. The count of each keyword in the whole alert dataset is also calculated.

For each keyword, convert the word to lowercase, remove all punctuation marks, special characters, numbers, and stop words (it, has, he, etc.), and stem each word to (e.g., to remove suffixes and prefixes) to generate a root word (lemma) 1002B. For example, a lemma for the words ‘evacuation’ and ‘evacuated’ would be ‘evacu’.

Associate each generic keyword with one or more pre-defined threat sub-categories on the master list of FIG. 5 and create, for each threat sub-category, a second set of stemmed keywords from the main set of keywords 1003B. A threat sub-category may have more than one generic keyword. The set of generic keywords is used in this step for the purposes of performing an initial text string search on a new received alert, as described in more detail below. For example, for the master list sub-categories ‘Building/Urban fire’, ‘Industrial Fire’, and ‘Vehicle Fire’, the generic keyword ‘fire’ is used for those sub-categories. This means that any alert containing the word ‘fire’ in its text or metadata is a possible match to each of those three master list threat sub-categories.

For each incoming alert, preprocess and stem each word in the alert text body and category metadata. In other words, convert all words to lowercase, remove punctuation marks, special characters, numbers, and stop words (it, has, he, etc.) and stem each word to convert it to a lemma 1004B.

Using the preprocessed alert data, perform a string search against the full set of generic keywords to identify matches 1005B.

Identify, from any generic keyword matches, a sub-set of potential threat sub-categories from the master list 1006B.

Perform a second string search of the preprocessed alert against the set of stemmed keywords for each potential threat sub-category identified in the previous step, by identifying all lemmas in the alert that match the stemmed keywords for that threat sub-category 1007B.

For each word match, vector embed the stemmed keyword using the set of sub-category stemmed keywords as a sentence and the main set of keywords for the unlabeled dataset as a document 1008B.

Perform a cosine similarity analysis on the embedded vectors to calculate semantic similarity between the occurring stemmed keywords for the threat sub-category 1009B.

Compare cosine similarity results of the analysis for each candidate threat sub-category and identify the threat sub-category that has the highest cosine similarity score 1010B.

Classify the alert by threat sub-category, based on the results of the cosine similarity analysis 1011B.

An example of an analysis of an alert is shown in FIG. 10C. The raw alert text 1001C and category metadata 1002C are used to preprocess the alert into a string of lemmas 1003C. From an initial string search on the preprocessed alert, a subset of potential threat sub-categories defined in the system is identified 1004C. FIG. 10D shows a manually created set of generic keywords 1001D and a set of stemmed keywords 1002D that have each been associated with a threat sub-category of the master list. The generic keywords are used for a first string search of the preprocessed alert data 1003D to identify possible threat sub-category matches 1004C of FIG. 10C. Based on the string search shown in this example, the preprocessed alert has ten possible threat sub-category matches 1004C. The preprocessed alert data 1003D is then compared with the stemmed keyword set for each candidate sub-category, the matches are vector embedded and a cosine similarity analysis performed to determine the sub-category with the highest cosine similarity score for the alert. The results of an analysis 1004D show that the predicted threat sub-category for this alert is ‘Wildfire’, because it has the highest cosine similarity value of 0.560112.

The performance of the classifier may be measured on a manually labelled subset of the whole alert dataset. Each of these alerts are labelled with an exact sub-category match and a possible sub-category match. An exact match represents the most suited sub-category for the alert and a possible match is a second best option from all the master list threat sub-categories.

Based on the percentage accuracy of matches using the manually labelled dataset, the set of generic keywords and stemmed keywords may be adjusted for a sub-category. It may not be possible to classify some alerts (considering both exact match and possible match). This may occur where the string search on the alert determines that it contains no words matching any of the generic keywords. This may also occur when the results of a cosine similarity analysis on the alert results in a zero score for all potential threat sub-categories. In such cases, the classifier may simply label these alerts as ‘unclassified’ and they may be ignored or further processed in some other manner.

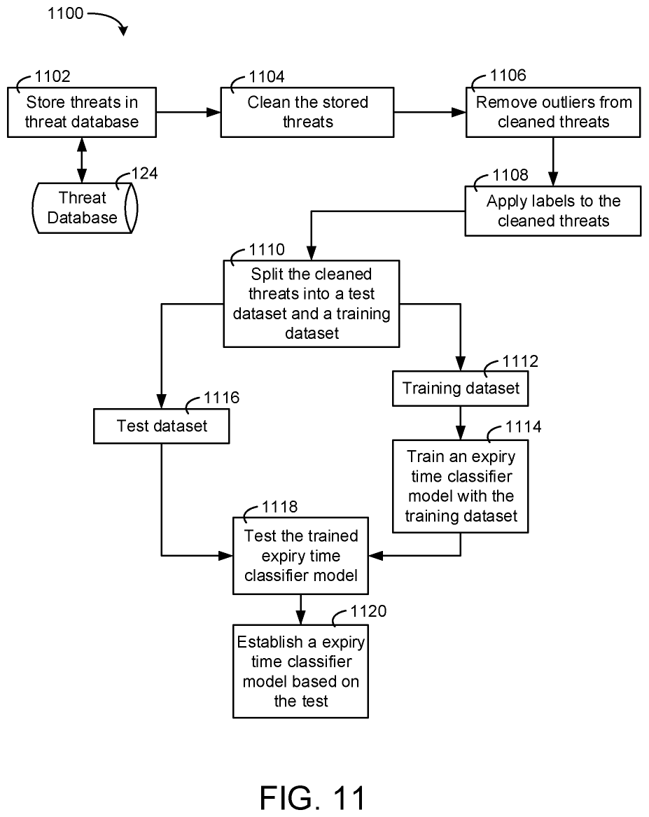

Referring now to FIG. 11, a process 1100 is shown for training the expiry time model 280 according to an exemplary embodiment. The expiry time predictor 216 and/or any other computing system as described herein can be configured to perform the process 1100. Threats can be expired after their immediate impact has been eliminated. For example, a traffic accident might have been reported by one of the data sources and then police arrive at the location of the traffic accident and deal with the situation and after few hours everything is back to normal. In the system 106, an increase in the risk score associated with that incident may be seen since the risk score may cause some delays in the transportation to one or more facilities. However, after it is completed, the system 106 can update the risk score and then remove that threat from the list of active threats.

Many data sources send out updates about the threats as they develop. After the incident has been closed, the data sources set the status of that threat to closed. This information is sometimes sent out as updates (push model) and some other times, an explicit call is required to get the status updates is needed. Depending on the data source API, the implementation of the process that pulls data can be different. However, in the threat database 124 of the system 106 the records of the times when an incident was first reported and the time that it was closed or updated. Using that historical data on the incidents that are monitored, the expiry time predictor 216 can build a machine learning model that can be used for predicting the expiry time of the incidents the moment they come into the pipeline. This predicted expiry time can be used by the risk decay manager 320 and can enable users to have forecasting capability on the incidents that come in by knowing approximately how long it will take to be closed or dealt with.

In step 1102, threats are stored as historical data in the threat database 124 by the threat service 122. In step 1104, the expiry time predictor 216 can prepare the stored threats. Cleaning the stored threats can include removing the data that has missing fields, removing the data that has zero or negative expiry time. The expiry time is calculated by subtracting the time the threat was reported and the time that the threat was closed/updated. In practical applications, there are always cases in which the data provided includes some inaccuracies and mistakes. The expiry time predictor 216 can verify that those are removed before using that data for training.

Other than the data that include fields that are inaccurate, there are some extreme cases that are considered outliers and those usually do not represent the trends and insights about the data. So by removing those outliers in the step 1106 by the expiry time predictor 216 it can be ensured that high quality data is used in training. A simple example for this type of data can be a false incident report. If there was a bomb threat reported by mistake but after few seconds it was removed or closed by the analyst who posted it to avoid the confusion. Those types of threats will appear with a very short expiry time which is very unusual to the other valid incidents. Thus those threats are removed by the expiry time predictor 216 is removed from further processing. The techniques used can be Modified Z-Score and Inter Quartile Range (IQR).

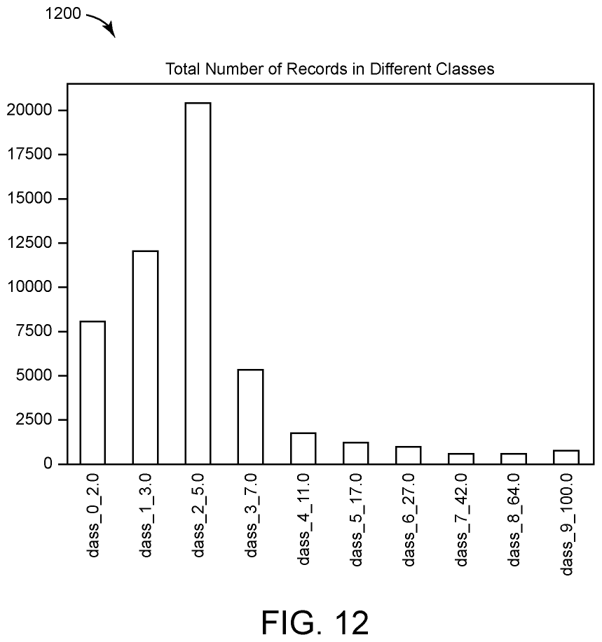

Regarding expiry time, the output can range from very small positive values (minutes) to very large values e.g., days. This can correspond to a variety of factors for example the type of the threat. Minor traffic incidents might take only a few minutes to be cleared but a major wild fire might take days to be dealt with. In order to build a model that predicts the exact time of the expiration, there may need to be a limit on the possible classes that a threat can belong to. By defining a set of labels based on the percentile of the expiry time, the expiry time predictor 216 can label the data in step 1108. This can create many (e.g., hundreds) different type of classes that each threat can belong to. In some applications, there might be less and in some, there might be more classes defined. For example, a 10 class labeling distribution (e.g., a histogram analysis of expiry time) is shown in FIG. 12.

After applying the labels, the data can be split in step 1110 by the expiry time predictor 216 between the training data set 1112 and the test dataset 1116. The training data set 1112 can be used to train the expiry time classifier model using supervised machine learning algorithms like Support Vector Machine, Random Forest and so on in step 1114. The test dataset 1116 can be used to test and validate the performance of the expiry time classifier model in step 1118. This process repeated until an expiry time model with satisfactory performance is determined (step 1120).

Referring now to FIG. 12, a chart 1200 of a distribution of threats in different classes is shown, according to an exemplary embodiment. In chart 1200, 10 classes are defined based on expiry time range. For example, the first class represents all the threats that have been closed less than two hours. The second class are the threats expired between 2 and 3 hours and the last classes shows the threats that expired between64 and 100 hours.

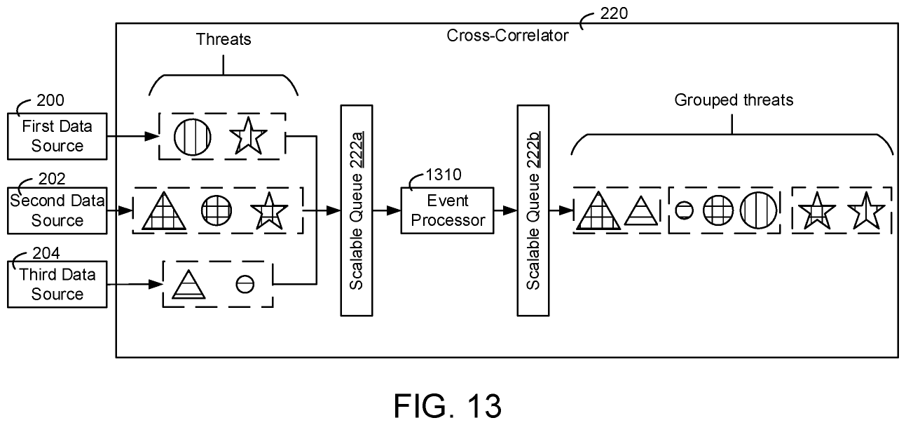

Referring now to FIG. 13, the cross-correlator 220 is shown in greater detail, according to an exemplary embodiment. Having multiple data sources, the data sources 200-204, reporting on the incidents adds a lot of benefits on the coverage and response time. However, it also has the potential of having so many duplicate or related threats coming from multiple different channels. If the threats are not properly grouped together, each incident will be treated as a new threat and will cause noise and a poor user experience for the users of the system 106. The cross-correlator 220 can be configured to identifying the related threats reported from different data sources and then grouping the threats together. This creates a unique opportunity to the applications and presentation layers to show one incident in a timeline and all the reported threats associated with that incident even if they were reported from different data sources. The cross-correlator 220 as described with reference to FIG. 13 can be scalable and can be implemented for various numbers of data sources.

Threats are reported from multiple different data sources 200-204. Although the threats are reported from three different data sources, any number of data sources can be used. The threats reported by the data sources 200-204 can be buffered in the scalable queue 222a. The threats of the data sources 200-204 are shown as different shapes to represent different threats. The circle threats reported by the data sources 200-204 each represent the same incident. Similarly the start shaped threats reported by the data sources 200 and 202 represent the same threat and likewise the triangle threats reported by the data sources 202 and 204 represents the same threat.

The cross-correlator 220 is shown to include an event processor 1310. The event processor 1310 can be configured to read the threats from the scalable queue 222a and processes the incoming threats in real-time and store them in scalable queue 222b. The event processor 1310 can be configured to implement an instance of in-memory cache to store the most recent threats. The cache provides high speed lookups and read/write capability which is required to be able to processes thousands of incoming threats reported from all the data sources. The windows of time to keep the threats in the cache can be configurable. In some embodiments, the window can be six hours of time.

The event processor 1310 can be configured to group threats together based on information of each of the threats. For example, the event processor 1310 can be configured to analyze a time that each threat was reported, a location of each threat, and a category of each threat to determine whether to group threats together or not. If all the time, location, and/or category match any of the cached threats, those threats can be grouped with the cached threats.

For the time and location, a certain amount of tolerance is defined (e.g., threats with a timestamp falling within a predefined length of time from each other can be considered occurring at the same time). The tolerances can be different for different data sources 200-204, different for different types of threats, and/or based on the particular implementation of the cross-correlator 220. The event processor 1310 can implement a threat-specific tolerance for time and location. For example, weather related threats may have a higher tolerance than traffic incidents. An earthquake might be reported by multiple sources more than a mile difference in the location. However, an urban traffic incident should have much less than quarter of a mile in difference.

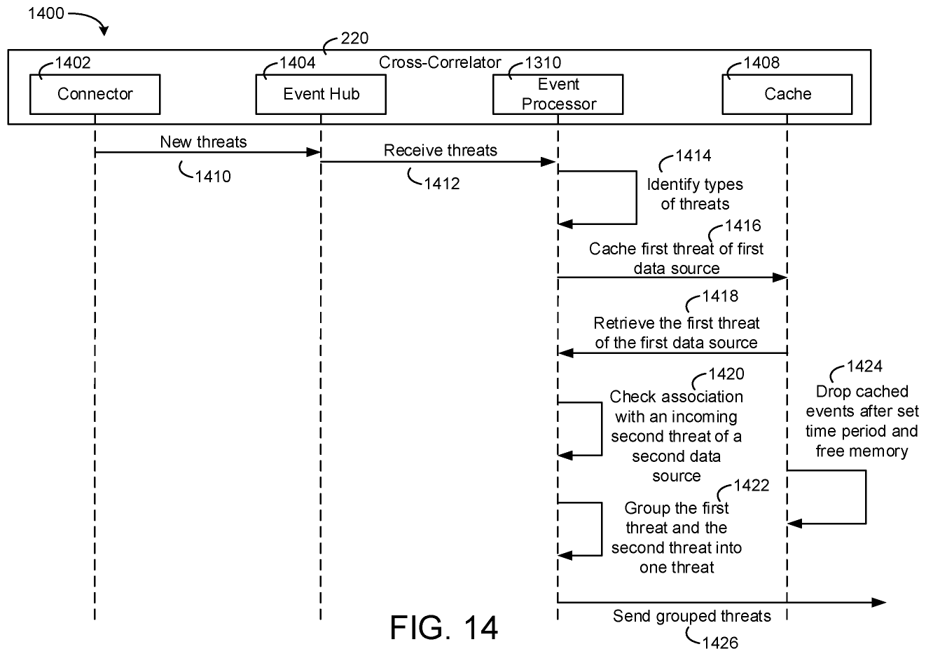

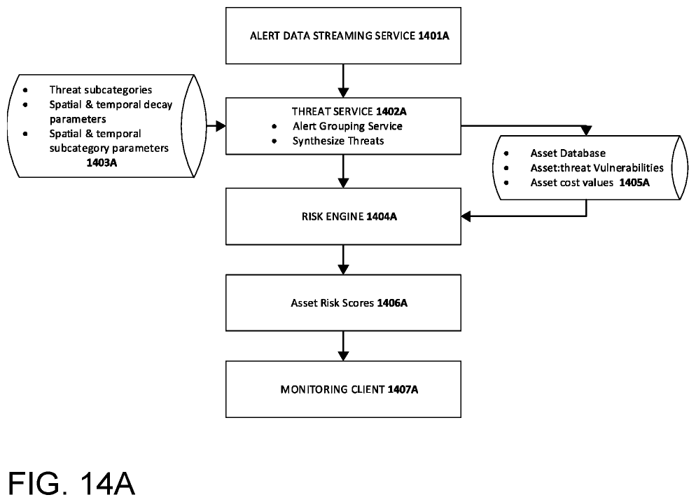

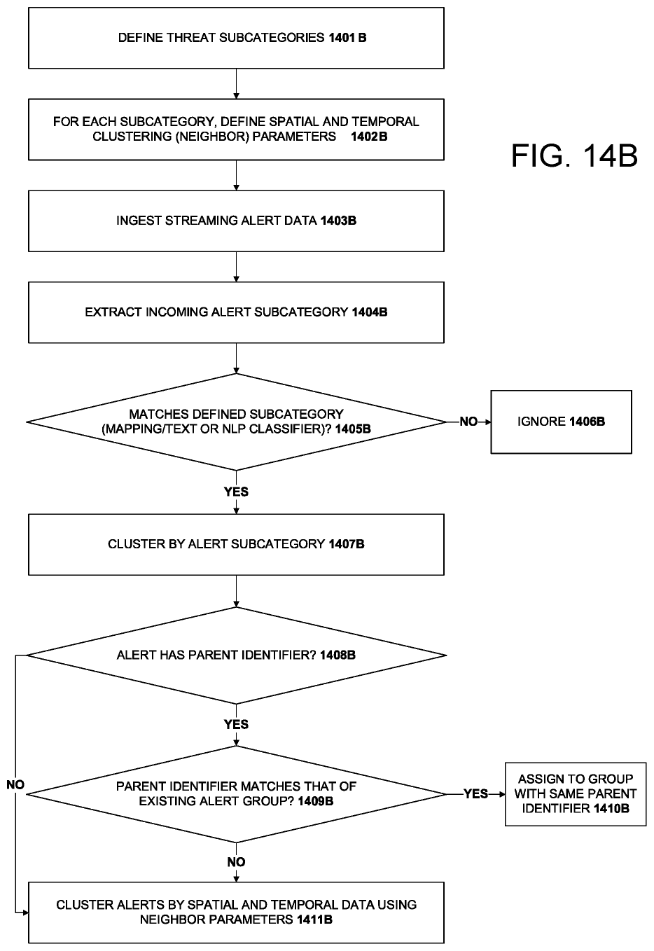

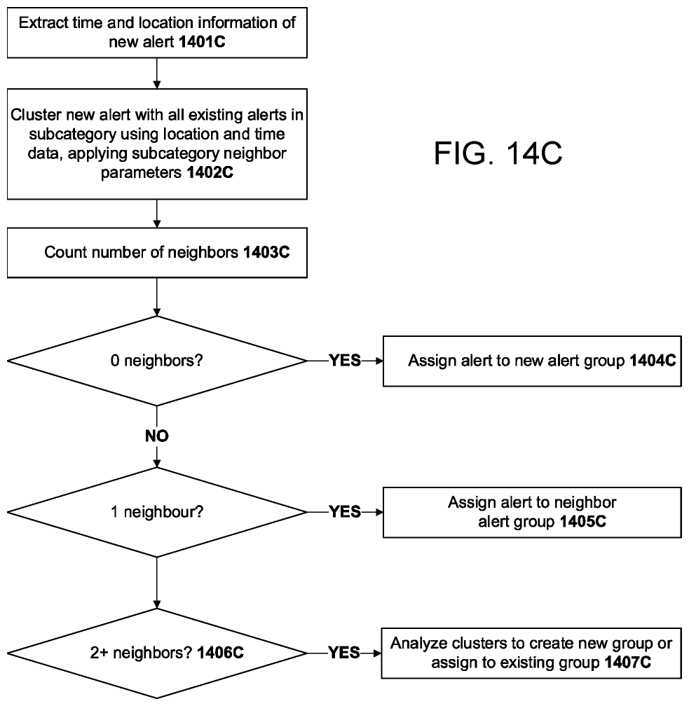

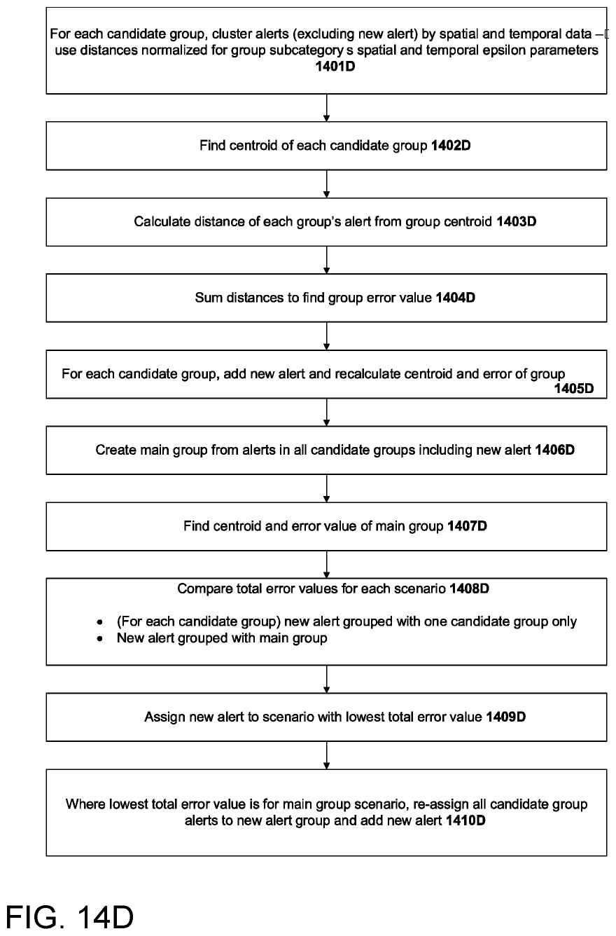

Referring now to FIG. 14, a process 1400 is shown for grouping the same threats together, according to an exemplary embodiment. The cross-correlator 220 can be configured to perform the process 1400. The sequence of events that happen after data is received from two separate data sources; a first data source and a second data source are shown in FIG. 14. Various components of the cross-correlator 220 are shown in FIG. 14, a connector 1402, an event hub 1404, a stream processor 1406, and a cache 1408 (e.g., a redis cache or any other type of cache) can be configured to perform the steps of the process 1400.

In step 1410, the connector 1402 can receive new threats from the data sources 200-204 and forward the new threats to an event hub 1404. The event hub 1404 can provide the new threats to the event processor 1310 in step 1412. The event processor 1310 can identify, in step 1414, a type of each of the threats. The threats received by the event processor 1310 may be standard threats that have been processed by the data ingestion service 116 and can include an indication of the identity of each of the threats.

In step 1416, the event processor 1310 can store the threats in the cache 1408. Particularly, the event processor 1310 can store a first threat of the first data source 200 in the cache 1408. In step 1418, the event processor 1310 can retrieve the first threat from the cache 1408. The step 1418 can be performed periodically and/or in response to receiving a second threat from the second data source 202. In step 1420, the event processor 1310 can compare the second threat with the first threat to determine if there is an association, i.e., both threats describe the same incident. The event processor 1310 can determine whether both threats describe the same threat type. The association can be determined by analyzing a time of occurrence of each threat. The event processor 1310 can determine whether the threats occur within a predefined length of time from each other. The length of the predefined time can be dependent on the type of threats of each of the threats.

Furthermore, the event processor 1310 can analyze the location of the threats. If the threats have a reported location that is within a predefined distance from each other, the threats can be considered to have occurred at the same location. For example, the predefined distance can be a half mile, a mile, ten miles, etc. The distance can be different for different types of threats. In response to determining that the type, time, and/or location of the first threat and the second threat are the same, the event processor 1310 can determine that the threats are the same threat and should be associated and grouped.

In step 1422, the event processor 1310 can group the threats together into a single threat. The grouped threats can be added back into the cache 1408 and/or forwarded on to other components of the system 106, e.g., the geofence service 118 in step 1426. The grouped threats can be again compared to new threats so that two or more threats can be grouped together. In step 1424, cached threats can be dropped after a set period of time occurs and the cache memory can be set to free memory. In some embodiments, each of the threats has an expiry time or otherwise there is a set expiry time for the cache 1408. In response to the time occurring, the threat can be dropped from the queue.

Referring generally to FIG. 14A, FIG. 14B, FIG. 14C, and FIG. 14D, further methods of grouping reported threats (in the form of alerts) by event processor 1310 are described, according to some embodiments. Generally, the following methods described refer to defining spatial and temporal parameters for threat sub-categories (also referred to elsewhere in this disclosure as threat types) and to applying those parameters in clustering alert data of the same sub-category using their time and location information and thereby assigning alerts to existing alert groups representing existing threats or forming new alert groups representing new threats.

The event processor 1310 of risk analysis system may receive multiple alerts of the same type. In the description of FIG. 14, alerts are described as threats, however it should be understood hereinafter in relation to FIG. 14A to FIG. 14D, that such threats are to be understood as alerts, and that the term, threats, should be understood as relating to groups of alerts corresponding to the same threat event. Some alerts may be multiple instances generated from the same source of threat, e.g., a group of rioters breaking multiple windows. Other alerts may be variations on the same incident, e.g., several misreported locations for a shooting. Alerts affecting an asset that share a spatial and temporal overlap and that share the same threat sub-category may be assumed to relate to the same underlying event. In some cases, this assumption is false. For example, there may be multiple separate underlying sources of threat, such as multiple terrorist attacks occurring throughout the same city. This potential inaccuracy in estimating the true number of individual threats may prejudicially affect threat and risk scores and create difficulties in locating individual threats. One consequence of this may be an erroneous assumption that a monitored individual (e.g., travelling employee) is not at risk in locations where threat events may have been missed.

Referring now to FIG. 14A, various elements of an implementing system for grouping alerts and calculating risks are described, according to some embodiments. Alert data are streamed by an alert streaming service 1401A and received by a threat service 1402A that processes the data, extracting its threat sub-category, and temporal and spatial data. Threat service 1402A receives threat sub-category data, spatial and temporal decay parameters of threat sub-categories, and spatial and temporal sub-category clustering parameters (neighbor parameters) from a data storage 1403A. Threat service 1402A groups alerts and synthesizes asset threats, using information from various databases 1405A, including an asset database, a database matching each asset's vulnerabilities to different threat sub-categories, and an asset cost database. Synthesized threats to assets are passed to a risk engine 1404A that computes asset risk scores 1406A and sends these scores to a monitoring client 1407A. The system just described may define a set of threat sub-categories that may be used to classify alerts into groups representing threats. Alert metadata typically contains threat category and sub-category information. Alert sub-categories are more detailed descriptions of a threat underlying an alert. The system may map alert sub-categories from different alert providers to the alert grouping service's pre-defined threat sub-categories. Where there is no mapping available, the system may perform a text or NLP analysis on the alert content to extract a sub-category matching one defined in the system. For the purposes of the methods described herein, alert data must also contain valid spatial and temporal data, i.e., alert location and time data.

An example of a set of alert (threat) categories and sub-categories is shown in Table 14A below.

TABLE 14A
example of threat categories and sub-categories

| Threat Category | Threat Sub-category |
|---|---|
| Security & Crime | Violent Crime/Shootings/Stabbings |
| Security & Crime | Property Crime |
| Security & Crime | Personal Crime |
| Security & Crime | Hate Crime |
| Security & Crime | Robbery |
| Protest & Riot | Demonstration/Protest |
| Protest & Riot | Planned Event |
| Protest & Riot | Civil Unrest/Riot |
| Protest & Riot | Violence at Event |
| Protest & Riot | Labor Strike |
| Terrorism & Conflict | Extremist/Rebel Messaging |

The alert grouping service matches incoming alerts with other alerts and existing alert groups within the same threat sub-category. These alerts may be grouped using a clustering analysis on the spatial and temporal information contained in alerts. A clustering algorithm may be selected based on its ability to effectively cluster large numbers of live streaming alert data. The clustering algorithm may be similar to DBSCAN or another algorithm with equivalent characteristics.

Each system-defined threat sub-category is given a set of spatial and temporal parameters that define a neighborhood radius around an alert within that sub-category. A new alert's time and location data is clustered with the time and location data of other alerts within the same sub-category, applying the sub-category's spatial and temporal parameters to the subject alert in order to locate neighbor alerts with temporal and spatial data falling within those parameters.

The spatial and temporal sub-category clustering parameters (neighbor parameters) for a sub-category are defined on the basis of the nature of the threat event underlying an alert. For example, a shooting event will have a smaller spatial and temporal radius of effect than an event, such as a hurricane, that is more sustained and dispersed. The closer in time and space two alerts are, the more likely it is that they relate to the same event. Two alerts may share the same sub-category, but may not relate to the same underlying event. For example, two or more alerts may be received under the sub-category ‘Shooting’, but may represent otherwise unrelated incidents that should not be grouped together as a single threat. The neighbor parameters are designed to reflect the expected temporal and spatial overlap between alerts corresponding to the same event, allowing individual alerts within the same sub-category to be grouped more accurately.

The parameters may be initially configured with default values, based on different attributes of a threat, and may, in some embodiments, be configurable by an end user of the risk analysis system. An example of a set of temporal and spatial parameters is shown in Table 14B below.

TABLE 14B
example of temporal and spatial parameters
for threat sub-categories

| | | | Spatial Parameter |
|---|---|---|---|
| Threat | Threat | Temporal Parameter | (distance from alert |
| Category | Sub-category | (time elapsed in hours) | location in km) |
| Security & | Shootings | 2 | 1 |
| Crime | | | |
| Protest & | Demonstration/ | 2 | 2 |
| Riot | Protest | | |
| Weather | Hurricane | 24 | 50 |

The temporal parameter in the above example represents a period of elapsed time from the time of the alert. The spatial parameter represents a distance measurement from the location information for the alert. The individual parameters may be configured based on experimentation with historical alert data.

Referring now to FIG. 14B, an overall process for assigning alerts to alert groups, based on alert sub-category is described, according to some embodiments.

The alert grouping system defines threat sub-categories 1401B. For each such sub-category, a set of temporal and spatial neighbor parameters is defined 1402B. The parameter values are used to define a time and space window around an alert, based on the nature of the threat event represented by the alert's sub-category. For example, a hurricane, due to its wider geographical range and longer duration, will have wider spatial and temporal parameters than a more localized and short-term threat event, such as a single shooting incident. The alert grouping service ingests streaming alert data 1403B. As alert data are streamed, their sub-category data are extracted 1404B and the system searches for a match with one of the defined alert sub-categories 1405B. In some cases, no immediate match is found, and the alert grouping system may perform a text or natural language processing (NLP) analysis to extract a known sub-category. If no known sub-category is found, the alert is ignored 1406B. If a match is found, each new alert undergoes a clustering process with other alerts in that sub-category 1407B. The alert grouping system analyses the alert for a parent identifier 1408B. A parent identifier is a unique code contained in the alert's metadata that may be used consistently by alert providers to relate multiple alerts to the same individual event. Individual alerts may share the same parent identifier where they are updates on the same event. Where the alert has a parent identifier, the system looks for a match to a parent identifier for an existing alert group 1409B. Where a match is found, the alert is assigned to the alert group having the same parent identifier 1410B. Where the new alert has no parent identifier or its identifier does not match that of an existing group, the alert is clustered with all other alerts within that sub-category, using the temporal and spatial information of clustered alerts and applying the temporal and spatial neighbor parameters of the sub-category 1411B.

Referring now to FIG. 14C, a further process for assigning a new alert to an alert group is described, according to some embodiments. The new alert has been processed as described in relation to FIG. 14B. The alert grouping system extracts the alert's time and location information 1401C. The new alert is initially clustered with all existing alerts in the sub-category using location and time data (e.g., the latitude and longitude and the time data of each alert) and the sub-category neighbor parameters are applied 1402C. The spatial and temporal data of clustered alerts is normalized for the neighbor parameters. These parameters define a radius around an alert within which other alerts are treated as neighbors. The number of neighbor alerts is counted 1403C. Where the new alert has no neighbors, it is assigned to a newly-created group of alerts 1404C. This new alert represents a new unique threat event. Where the new alert has only one neighbor, it is assigned to that neighbor group 1405C. In some cases, the new alert may have more than one neighbor 1406C that belong to different alert groups, therefore potentially more than one alert group to which it could be assigned. The candidate alert groups are analyzed with respect to the new alert by determining group cluster centroids and error values 1407C, as described further in relation to FIG. 14D.

Referring now to FIG. 14D, a further process for analyzing clusters of alerts is described, according to some embodiments. Where, as described in relation to FIG. 14C, a new alert has more than one candidate neighbor group, the alert is analyzed with each candidate group using alert spatial and temporal data. For each candidate alert group, its alert data are clustered by spatial and temporal factors using distances normalized for the group sub-category's spatial and temporal parameters 1401D. This clustering excludes the new alert. For each candidate group, the centroid of its cluster is found 1402D and distances calculated for each alert in the group from the group centroid 1403D. These distances are summed to find the group's error value 1404D.

For each candidate group, the new alert is then added and the group's centroid and error are recalculated 1405D. A new main group is then created from all candidate groups and the new alert is added to this cluster 1406D. The centroid and error of this main group is calculated 1407D.

The method assigns the new alert to a group representing a scenario where the error is lowest. The system compares each scenario in which the new alert is grouped with one of the candidate groups, but no other group, and in which the new alert and all candidate group alerts form one single group. This comparison is made using the total error values for each scenario 1408D. The new alert is assigned to the group representing the scenario with the lowest total error value 1409D. Where the lowest total error value occurs if the new alert is grouped with all candidate group alerts to form a single group, then all candidate group alerts are re-assigned to a new group including the new alert 1410D.

The methods described above discuss alert grouping based on alerts being within a group's temporal and spatial parameters or not. In other embodiments, the system may apply different weighting factors to spatial or temporal data of an alert so that, for example, an alert with a sub-category matching an existing group, with identical location data, but a time data outside the temporal parameters of the alert group, may be assigned to that group, notwithstanding that its time data falls outside the temporal parameters.

Referring again to FIG. 1, the geofence service 118 can be configured to route potential threats that are geographically in the close range of assets. The geofence service 118 can process the incoming threats in real-time. For every reported threat ingested by the data ingestion service 116 and provided by the data ingestion service 116 to the geofence service 118, the geofence service 118 can, for that threat for all assets are retrieved to be checked, to find if there is any asset that has a geofence that has been violated by that threat. If no geofence has been violated, the geofence service 118 can be configured to drop the threat and not forward the threat to the risk analytics pipeline 120. Instead, the geofence service 118 can store the threat as a historical threat within the threat database 124. However, if there was any asset that was close enough to the threat, i.e., the geofence of the asset was violated by the threat, the geofence service 118 can be configured to route the threat to the RAP 120 and/or store the threat within the threat database 124. In case of multiple assets impacted by a threat, the geofence service 118 can be configured to duplicate the threat for each of the multiple assets and send the multiple threats to the RAP 120 so that the RAP 120 can processes one threat per asset at a time.

The geofence settings can be different for each asset for different threats. Some threats are considered “far” if the distance between the threat and the asset is more than 10 miles and some other threats to be considered “far” that setting might be 40 miles for example. Natural disasters usually have much larger range of impact than minor urban incidents. That is why the geo-fences defined for assets can be per threat type.

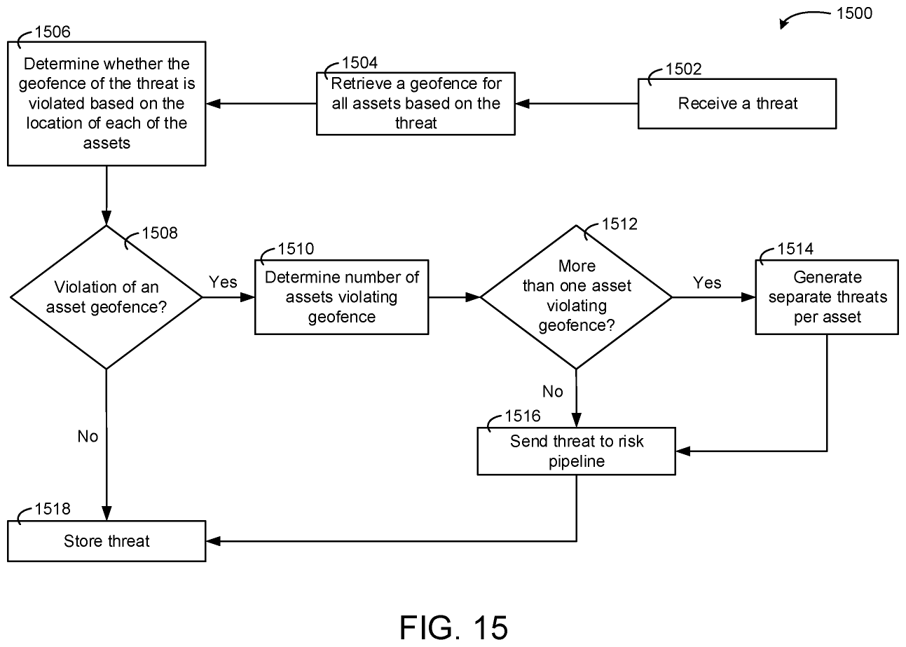

Referring now to FIG. 15, a process 1500 is shown for determining whether a threat affects a particular asset, according to an exemplary embodiment. The geofence service 118 can be configured to perform the process 1500. Furthermore, any computing device as described herein can be configured to perform the process 1500. In step 1502, the geofence service 118 can receive a threat. The threat can be received by the geofence service 118 from the data ingestion service 116.

In step 1504, the geofence service 118 can retrieve a geofence for each of a collection of assets based on the threat. The geofence service 118 may store, or otherwise retrieve from a different data store, a particular geofence for each of multiple assets. The geofence may be particular to both the threat and the asset itself. For example, the geofence may be a particular size and/or geometric based on a severity of the threat, a type of the threat, a type of the asset, and/or a vulnerability of the asset to the particular threat. The geofence may be a particular geographic boundary surrounding each of the assets.

In step 1506, the geofence service 118 can determine whether a geofence of each of the assets is violated by a location of the threat. Since the threat can include an indication of location, the geofence service 118 can determine whether each of the geofences of the assets is violated by the location of the asset, i.e., whether the location of the threat is within the geofence of each of the assets. The result of step 1506, the determination whether each of the asset geofences are violated by the threat, can cause the geofence service 118 to perform steps 1508-1516 for each of the assets.

Considering a particular asset, if, in step 1508, there is a determination by the geofence service 118 (step 1506) that the threat violates the geofence of the particular asset, the process moves to step 1510. If the geofence of the particular asset is not violated by the threat, the process moves to step 1518. In step 1518, the geofence service 118 stores the threat. Storing the threat can include, causing, by the geofence service 118, the threats service 122 to store the threat in the threat database 124. The geofence service 118 may only perform the step 1518 if none of the assets has a geofence violated by the threat.

In step 1510, the geofence service 118 can determine the number of geofences of assets that are violated by the threat. If, more than one asset has a geofence violated by the threat, step 1512, the geofence service 118 can perform step 1415. If only one asset is associated with a geofence that has been violated, the process can proceed to the step 1516.

In step 1514, the geofence service 118 can generate separate threats for each of the assets that have a geofence violated by the threat. For example, each of the threats can be paired with a particular asset to form an asset-threat pairing. In step 1516, the geofence service 118 can send all the threats, either original or generated in the step 1514, to the RAP 120.

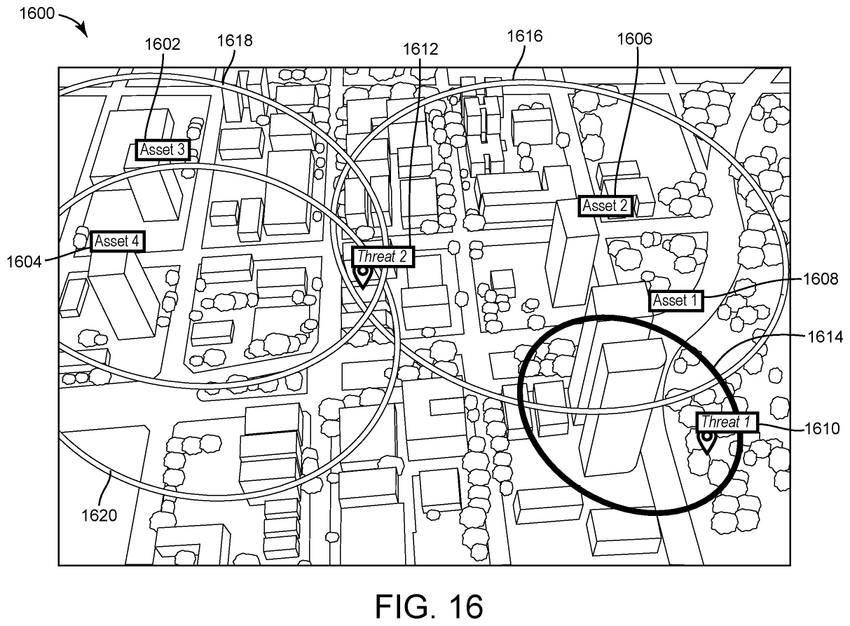

Referring now to FIG. 16, a drawing 1600 of a city including multiple building assets and two different threats is shown, according to an exemplary embodiment. As shown in FIG. 16, asset 1602, asset 1604, asset 1606, and asset 1608 are each associated with a respective geofence, the geofences 1618, 1620, 1616, and 1614 respectively. The geofences 1614-1620 are shown to be various sizes. The sizes of each of the geofences can be associated with the type of the particular asset, the type of a particular threat (e.g., the threat 1612 and/or the threat 1610), a severity of the threat, a type of the threat, and/or a vulnerability of the asset to the threat. In some embodiments, where there are multiple threats, the geofence can depend in size based on a combination of the multiple threats.

Threat 1612 is shown to violate the geofences 1618, 1620, and 1616. In this regard, the geofence service 118 can replicate the threat 1612 so that there is a corresponding threat for each of the assets 1602, 1604, and 1606. Furthermore, the threat 1610 is shown to violate a single geofence, the geofence 1614 but no other geofences. In this regard, the geofence service 118 does not need to replicate the threat 1610 but can pair the threat 1610 with the asset 1608.

In some embodiments, the threats 1612 and/or 1610 can be associated with their own geofences. The geofences can be included within the threats 1612 and/or 1610 and can be extracted by the geofence service 118. In some embodiments, the geofence service 118 can generate the geofences for the threats 1612 and/or 1610 based on a severity of the threat and/or a type of the threat. The geofence service 118 can determine what asset geofences intersect with the threat geofences. The area of intersection can be determine by the geofence service 118 and used to determine whether the asset is affected by the threat and/or whether the severity of the threat should be adjusted for the threat. In some embodiments, if the intersection area is greater than a predefined amount (e.g., zero), the threat can be considered to violate the geofence. However, based on the area of the intersection, the severity of the geofence can be adjusted. For example, particular areas can be associated with particular severity levels and/or particular adjustments to an existing severity level so that the severity level of a threat can be tailored specifically to each of the assets associated with geofences that the threat violates.

Referring again to FIG. 4, the RAP 120 is shown for performing risk analytics on threats and/or assets. Processing and enrichments that are performed after the enrichment performed by the geofence service 118 can be performed by the RAP 120. The RAP 120 can be configured to generate risk scores for the threats based on features of the threats and/or assets and/or relationships between the threats and/or the assets.

The risk engine 310 of the RAP 120 can be configured to generate risk scores for the threats via a model. The model used by the risk engine 310 can be based on Expected Utility Theory and formulated as an extended version of a Threat, Vulnerability and Cost (TVC) model. The risk engine 310 can be configured to determine the risk scores on a per asset basis. The threats can all be decoupled per asset in the processing pipeline as well as the calculation of the risk. For example, if a protest or weather condition is created alerts towards multiple buildings, separate alerts per building will be generated based on the geo-fences of the building and the detected alert. This will insure that the RAP 120 can horizontally scale as the threats are introduced to the system. The model used by the risk engine 310 can be,

$${Risk}_{Asset} ( t ) = {( {\sum }_{i = 1}^{n} {\vert {S}_{i} ( t ) \times {T}_{i} ( t ) \times {D}_{i} \times {V}_{i} ( {threat}_{i} , Asset ) \vert}^{p} )}^{\frac{1}{p}} \times {C}_{Asset} \times ρ ( t )$$

where, Tᵢ(t) is the probability of threat or attack threat at time t, Sᵢ is the severity of the threatᵢ at time t, Vᵢ(threatᵢ, Asset) is the vulnerability index of that Asset against threat_i, C_{Asset} is the cost or consequence of losing that asset, p≥1 is a positive value associated with the p-norm, and Dᵢ is the weight corresponding on the geographical proximity (distance) of the threat i to the asset. ρ(t) is the decay factor for the risk score.

There can be two sets of parameters in the formula for risk calculation. The first set of parameters can be from the threat and the second is about the asset impacted by that threat. The list of the threat categories can be different in different applications. But some of the most popular categories are Weather, Terrorism, Life/Safety, Access/Intrusion, Theft/Loss, Cybersecurity, and Facility. The model is not limited to specific type of threats and can be updated as new sources of threats are introduced. There are certain threat parameters that play an important role on the level of risk they potentially impose on the assets.

Severity of the threat refers to the intensity of reported incidents independent of the impact on assets. Notice that other measures like geographical distance will play a role on the risk besides the severity. However, severity is focused on the intensity of the threat itself. For example in case of a hurricane, its severity can be measured by the category level of the hurricane. It might not even be a major risk if it is too far from assets or if the assets are tightened with protective measures.

One of the parameters in the threat is the probability of actually threat occurring (Tᵢ(t)). This topic brings us to the concept of predictive and reactive risk. If the time in the risk formulation refers to a future time, that risk is considered to be predictive. To be able to estimate or predict the risks in a future time, the system 106 should be configured to predict the parameters involved in the calculation specially the potential threats and their severity in a future time. Some data sources that report the threats include threats that are expected to happen in future. Threats like planned protests, threats of violence or attacks and so on fall under the category of predictive risk. Those predictive threats will be used to train ML models to estimate the validity of the threats. On the other hand, the threats that have already happened and reported fall under reactive risk.

Referring now to FIG. 17, a VT matrix 1700 is shown, according to an exemplary embodiment. Each asset might be vulnerable towards one or multiple different threats. Studying the assets to understand the vulnerabilities and the threats impacting the asset is one of the first major tasks in the real implementation of a risk analytics project. For example, if it is assumed that different buildings are the assets, one might find some buildings are by the water and they are vulnerable towards flooding. However, another building might not have this vulnerability because of the measures taken into account in the construction or basically the location of that building. The risk model as described above takes into account the specific characteristics of the assets in terms of vulnerabilities against each of the threats that are supported in the system. For practical implementations, the VT matrix 1700 can be developed and/or stored all assets.

The matrix will include all the threats that are supported in the system. VT matrix will be a n×m matrix for, m assets exposed to n different threats. The values can be between 0-1 showing no vulnerability to full vulnerability. In some embodiments this can be further simplified to a binary matrix considering only values of 0 and 1. However, in some other embodiments any range between [0, 1] can be applied.

Regardless of the imminent threat and its nature, the value of the asset is important in evaluating the risk to the owner. The asset value becomes more important when a company has multiple types of assets with different functionality and responsibilities. Some of them might be strategic and very valuable. However, others might be smaller and less valuable compared to the others. Asset assessment includes the asset cost estimation besides vulnerability assessment. The result of the asset value assessment is translated to a number between 1 to 10 in the risk model to represent the least to most valuable assets.

In any given point in time an asset might be exposed to multiple threats. There might be heavy rain and major traffic accidents at the same time. To be able to combine the effect of the threats the formulation includes a p-norm to combine the threats. p could be any positive integer in the formula. Here, 2 and infinity are considered as possible values. 2-norm might not be a good metric for analyzing the multiple sources of threats since it will decrease the impact of the highest threats. co-norm can be a good or the best option, since it focuses on the highest degree of the risk.

The calculated risk can corresponding to dynamic risk score. The risk score can gradually decay until the threats are expired. ρ(t) can be the decay factor that is multiplied to the risk score based on a decay model.

Referring now to FIG. 18A, the risk engine 310 is shown in greater detail, according to an exemplary embodiment. The risk engine 310 is shown to receive a request to enrich an asset with a risk score, message 1802, and can generate and/or return a risk score in response to the request, i.e., response 1804.

The risk engine 310 is shown to include a TVC model 1816. The TVC model 1816 can be the TVC model as shown and described above. The risk engine 310 can expose the TVC model 1816 to the outside world via an API. The API can be a REST API. The API can provide four endpoints; a risk score endpoint 1808, a threat list endpoint 1810, a VT matrix retrieve endpoint 1812, and a VT matrix update endpoint 1814.

The risk score endpoint 1808 can be an endpoint used to return the risk score for the incoming threats. At this stage of the pipeline the threats are identified to be at the vicinity of at least one of the assets and also they are enriched with the asset details. The threat list endpoint 1810 can retrieve the list of all the threats that are recognized by the risk engine. The list is the master list of all the threats from all the data sources that report threats to the system. The VT matrix endpoints can be two endpoints here to retrieve and modify the VT matrix settings. The risk engine 310 is shown to include a threat list 1818 and a VT matrix 1700. The threat list 1818 can be a list of all the threats that the risk engine 310 needs to processes. The VT matrix 1700 can be a matrix of the vulnerability parameters for specific threats, e.g., as shown in FIG. 17. The risk engine 310 can query the VT matrix 1700 with an indication of a threat and an asset to retrieve the vulnerability parameter for the particular asset and threat.

Referring again to FIG. 4, RAP 120 is shown generating the dynamic risk 332 and the baseline risk 334. The dynamic risk 332 can represent the real-time activities and the possible risk on the assets. The baseline risk 334 can provide an indication of the long-term risk scores for an asset or a geographical area. The baseline risk 334 reveals the trends in the historical data. For example, the baseline risk 334 can be used to analyze which assets or neighborhoods are exposed to natural disasters like Hurricanes or areas that are more crime prone. A good combination of the two scores provides a good understanding for analyzing risk. The dynamic risk 332 can provide situational awareness while the baseline risk 334 score can be used for analyzing long term trends on an asset or neighborhood. Baseline risk is calculated by the running batch processes and the dynamic risk is calculated by the risk engine.

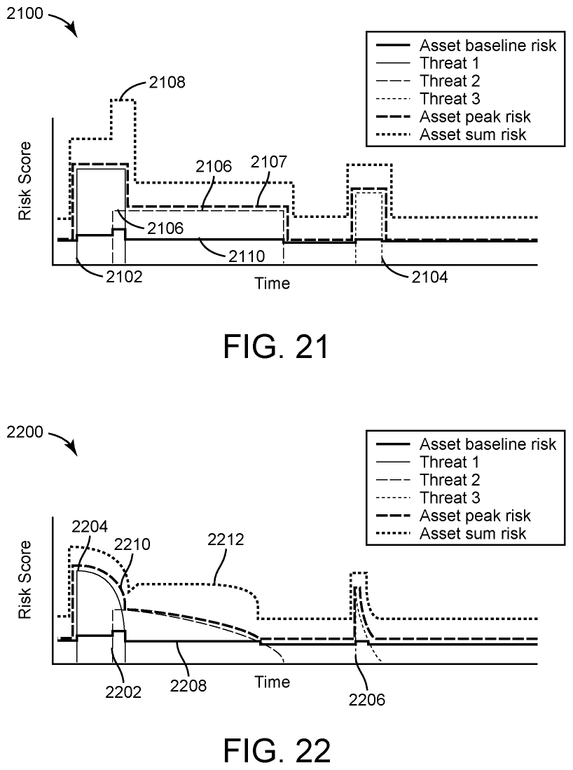

Still referring to FIG. 4, RAP 120 is shown to include the risk decay manager 320 and the threat expiration manager 322, which can be configured to decay risk scores over time and expire risk scores. The dynamic risk 332 can keep track of all the active threats that have an impact on the assets in any given point in time. Many data sources only provide information on the binary state of a threat that is reported. The threat can be “open” or “closed.” There is no information on the predicted duration of the threat to remain active before it is closed. The RAP 120 can be configured to develop machine learning models to enable predicting the expiry time for any threat (e.g., via the threat expiration manager 322). The expected duration for any threat can be used by the RAP 120 to reflect this information to a security analyst by showing the transition period to a closed state. This gradual decay can be performed by the risk decay manager 320 by applying a decay model that suits the nature of that threat. FIGS. 21 and 22 provide an illustration of risk decay for three threats impacting an asset along with the dynamic risk score resulted from each threat with and without risk decay.

Referring generally to FIGS. 18B-18F, systems and methods are shown for dynamically analyzing weather data to generate asset risk scores, according to various exemplary embodiments. Weather data can be used to generate a risk score by analyzing and contextualizing weather data (e.g., temperature, humidity, wind speed, snow fall, rain fall, etc.) and to dynamically model correlations between multiple weather threats, and/or between one or more weather threats, non-weather threats, and/or one or more other types of threats, and estimate weather and/or non-weather related risks. In some implementations, the systems and methods may determine anomalous weather conditions based on historic weather data.

The systems and methods discussed with reference to FIGS. 18B-18F can analyze weather data and generate (or receive) weather threat events for extreme environmental conditions. Extreme environmental conditions may be conditions where an environmental value exceeds a predefined amount or are outside a predefined range (e.g., a high humidity, a high or low temperature, etc.). As an example, a temperature below 40 degree Fahrenheit (or 10 degrees Fahrenheit, 0 degrees Fahrenheit, −10 degrees Fahrenheit, etc.) or above 130 degree Fahrenheit (or 100 degrees Fahrenheit, 110 degrees Fahrenheit, 120 degrees Fahrenheit, etc.) can be considered an extreme temperature which may be dangerous for humans. Such a threat event can contribute to a high risk score. Similarly, wind speed higher than 30 miles per hour (mph) or 40 mph could also be treated by the systems and methods discussed herein as extreme and weather condition. Furthermore, snowfall or rainfall in an amount greater than a predefined amount can be treated as an extreme weather condition.

The systems discussed with reference to FIGS. 18B-18F can be configured to analyze combinations of extreme weather events, i.e., weather events that occur simultaneously. For example, the systems described with reference to FIGS. 18B-18F can be configured to determine, for a very low temperature and a simultaneously occurring very high snowfall, a risk score greater than a risk score determined for the temperature or snowfall individually. The systems and methods can determine, for two, three, or more simultaneous weather related threat events a compounded threat event score based on the correlations between the simultaneously occurring threat events.

Furthermore, the systems and methods discussed herein can be configured to analyze historical data to determine if there is a weather related condition occurring that would not normally occur. A facility or city may not be prepared to respond to an extreme weather related condition if the extreme weather related condition rarely occurs at the facility. The systems and methods could determine whether a weather condition is abnormal based on analyzing historical data (e.g., historic temperature ranges, snowfall amounts, etc.) for a predefined amount of time in the past (e.g., the past five years). If the weather condition is abnormal, a risk score can be generated based on the abnormal weather condition such that the value of the risk score is increased due to the abnormality of the weather condition. For example, if it has not snowed in Atlanta in the month of October in past 5 years, and suddenly for a particular year it does snow in Atlanta in October, the systems and methods described herein could generate an increased risk score for the snow fall since the city of Atlanta may not have the infrastructure (e.g., snow plows, response personnel, etc.) to handle the snowfall.

Furthermore, weather data can be enriched or cross-correlated with non-weather related events. For example, if there is a major event at a building (e.g., a party, a large meeting, etc.) and there is a high snow fall, a risk score for the building or and occupants of the event can be compounded to account for additional dangers which may occur due to the high population being subjected to the weather event.

Referring more particularly to FIG. 18B, the RAP 120 is shown in greater detail for dynamically generating risk scores by adjusting risk score parameters 1826 based on weather data, according to an exemplary embodiment. The RAP 120 is shown to receive standard threats from the geofence service 118 (e.g., threats received from third party data sources, building data sources, etc. Based on the received data, the RAP 120 can be configured to generate risk scores for an asset based on weather related threat events and further based on correlations between multiple simultaneously occurring weather based threat events and/or other non-weather related threat events.

The standard threats received from the geofence service 118 can be threats originally generated by the data sources data sources 102 and can be weather threats such as high or low temperature, a hurricane, a tornado, a snow storm, etc. and/or any other threat e.g., a riot, a protest, etc. The data sources 102 can be a weather service data source (e.g., Accuweather).

In some embodiments, the data received by the RAP 120 is not directly a threat event. In some embodiments, the weather threat generator 1822 can analyze weather data to generate weather threat event. For example, the weather threat generator 2208 can determine if a temperature of received weather data is above or below predefined amounts (e.g., above 130 degrees Fahrenheit or below 40 degrees Fahrenheit or 0 degrees Fahrenheit). This may be indicative of an extreme temperature condition and the weather threat generator 2208 can generate a weather threat event. Similarly, if wind speed is above or below predefined amounts, an extreme wind speed threat event can be generated by the weather threat generator 1822. For example, if wind speed is above 30 or 40 miles per hour, an extreme high wind speed threat event can be generated. Similarly, if an air quality metric (e.g., an AQI) for a city or area is worse than (e.g., above) a predefined amount, an extreme high air quality index threat event can be generated.

The weather threat generator 1822 can be configured to analyze the weather threat event data and update parameters of the parameters 1826 based on the received data via a weather parameter updater 1824. The weather parameter updater 1824 can be configured to analyze one or multiple weather related threats together to determine whether one threat event increases the severity of another threat event. For example, if one threat event indicates that there is heavy snow precipitation and another threat event indicates that there are extremely low temperatures, a particular building asset (e.g., a person, a building, etc.) may be at a high risk. Therefore, the weather service 1820 can increase a risk score of an asset by increasing the threat severity parameter 1834 so that the threat severity of the heavy precipitation increases to account for both heavy snow and extremely low temperatures.

The weather parameter updater 1824 can be configured to correlate various extreme weather related conditions together to determine whether the risk score should be compounded based on the presence of multiple extreme weather conditions. For example, if there is high temperature and/or high humidity in addition to poor air quality, a high temperature threat event may have an increased risk score since the high humidity and/or poor air quality can increase the danger of the high temperature. Based on combinations of extreme weather conditions, the parameters 1826, specifically the threat severity 1834 can be adjusted so that the risk score generated by the risk engine 310 is increased (e.g., compounded) based on the presence of multiple threat events indicating extreme weather conditions.

The risk engine 310 can, for each of multiple assets, be configured to generate a risk score with the TVC model 1816. The risk engine 310 can be configured to generate a risk score for the asset based on multiple simultaneously occurring threat events. For each threat event for the asset, the risk engine 310 can be configured to generate a set of risk scores. The risk score enricher 312 can be configured to select the risk score with the highest value from the set of risk scores and use the highest valued risk score as the asset risk score. The asset risk score can be provided to the risk applications 126 for presentation to an end user. Based on the TVC model 1816 and parameters 1826, a risk score for each threat event of a particular asset can be determined.

In some embodiments, the RAP 120 can be configured to analyze risk scores or other received data over a period of time (e.g., a year) to identify trends in the asset risk scores, identify anomalies in the trends, generate a new alarm (e.g., a synthetic event), determine risk scores averaging, and/or perform risk score forecasting (e.g., predictions). Examples of analyzed risk scores are shown in FIGS. 18D-18E.

Referring now to FIG. 18C, the RAP 120 is shown in greater detail to include a weather threat analyzer 1836 for analyzing risk scores for various weather threats determined by the risk engine 310, according to an exemplary embodiment. In FIG. 18C, the risk engine 310 is shown to generate multiple risk scores for a particular asset. The weather threat analyzer 1836 is shown to receive the risk scores and use weather correlation rules 1838 to generate a final risk score, the final risk score being based on the multiple risk scores and correlations between weather threat events (or other types of threat events). The weather correlation rules 1838 may indicate that particular threat events are related and thus a final risk score should be generated based on the risk scores for the threat events.

One rule for the weather correlation rules 1838 may be that for a high temperature threat event associated with a score above a predefined amount and a poor air quality threat event with a risk score above a predefined amount, a final risk score should be generated as a function of both risk scores since high temperature and poor air quality may result in a dangerous situation. An example of a determination for a final risk score based on two threat events for poor air quality and high temperature may be,

Final Risk Score

=θ₁AssetRiskScore_{High Temperature}+θ₂AssetRiskScore_{poor Air Quality} where θ₁ and θ₂ may be multipliers for determining that risk score based on two separate risk scores. For example, if the high temperature risk score is 70 and the poor air quality risk score is 52 and the weighting parameters θ₁ and θ₂ are 0.8 and 0.6 respectively, a final risk score could be determined based on,

Final Risk Score=(0.8)(70)+(0.6)(52)=87.2

Each weighting parameter may be predefined such that combinations of weather threat events result in particular final risk score values. A generalized equation for weighting risk scores together may be,

$$Final Risk Score = {\sum }_{i}^{n} {θ}_{i} {AssetRiskScore}_{i} + {θ}_{i + 1} {AssetRiskScore}_{i + 1} … {θ}_{n} {AssetRiskScore}_{n}$$

In other embodiments, the risk score may be determined by applying a multiplier to a greatest of the component risk scores. For example, in the example above, where the high temperature risk score is 70 and the poor air quality risk score is 52, the overall risk score for the asset may be determined by applying a multiplier (e.g., 1.2) to the highest component score of 70, which may, for example, result in an overall risk score of 84.

Referring now to FIG. 18D, the weather threat analyzer 1836 is shown in greater detail to include a historical weather database 1838 and normal weather condition rules 1840 for determining how severely particular weather related threat events affect a building or area which may not be properly prepared for responding to a particular weather related threat event, according to an exemplary embodiment. As an example, a building or city may be located in an area where snow fall is not frequent. If there is an abnormally high snowfall one winter for the city, the city may not be properly prepared to handle the high snowfall. For example, there may not be a sufficient number of snowplow trucks or snow removal personal for handling such a snowfall. Therefore, a risk score for a building or city can be adapted to indicate that anomalous weather related threat events result in higher risk.

The weather threat analyzer 1836 can be configured to store risk scores generated by the risk engine 310 in a historical weather database 1838. The historical weather database 1838 may store days, months, years, and/or decades of risk score data. The historical weather database 1838 can be configured to store historical data for generated risk scores for high temperature threat events, risk scores for low temperature threat events, risk scores for tornados, hurricanes, etc. The historical weather database 1838 may indicate the frequency at which particular weather related threat events occur and their severity (e.g., their risk score for particular assets). Furthermore, the historical weather database 1838 can be configured to store raw environmental data. For example, the historical weather database 1838 could store an indication of every snowfall in the past ten years and the amount of snow for each snowfall. Furthermore, the historical weather database 1838 can be configured to store temperature trends over the past two decades.

The weather threat analyzer 1836 can be configured to generate the normal weather rules 1840 based on the historical threat events and/or the raw environmental data stored by the historical weather database 1838. The weather threat analyzer 1836 can be configured to implement various forms of machine learning, e.g., neural networks, decision trees, regressions, Bayesian models, etc. to determine what a normal threat event risk score would be for a particular threat event (e.g., a risk score range), a normal environmental condition (e.g., an environmental condition range), or other rules for identify abnormal environmental conditions.

Based on the normal weather rules 1840, the weather threat analyzer 1836 can compare new risk scores for threat events to the normal weather rules 1840. For example, if a high temperature risk score is normally between 30-40 but a new risk score is at 70, this may indicate that a substantially higher temperature than usually encountered by an asset is present. In this regard, the weather threat analyzer 1836 can increase the final risk score to account for the fact that the asset may be experiencing a weather related threat event that it is not prepared to endure. For example, for an area where tornados are not usually present, a threat event for a tornado may be 170. However, if based on the frequency of tornado threat events and risk scores associated tornados the weather threat analyzer 1836 identifies a threat event risk score range of 100-150, the weather threat analyzer 1836 may multiply the tornado threat event risk score by a multiplier to increase the value for the tornado threat event.

As another example, a weather threat event may be for a temperature at a particular high value for a day, e.g., for 100 degrees Fahrenheit. The normal weather rules 2404 may indicate that normal temperatures for a city are between 30 degrees Fahrenheit and 70 degrees Fahrenheit. The threat event of 100 degrees Fahrenheit may be outside the range and, thus, may be an anomalous weather threat event.

In some embodiments, the multiplier may be selected based on a frequency or value of the threat event. For example, a threat event may occur at a rate of 0.1%. The lower that threat event rate, the higher the multiplier may be. Furthermore, if the threat event corresponds to a value range, for example, temperature between 80 and 100 degrees Fahrenheit is normal during summer months, a multiplier may be selected based on how high above the temperature range a current threat event is associated with.

Referring now to FIG. 18E, a process 1842 is shown for determining a risk score based on a correlation between multiple simultaneously occurring weather or non-weather related threat events, according to an exemplary embodiment. The analytics service RAP 120 can be configured to perform the process 1842. Furthermore, a processing circuit, e.g., a processor and/or memory, can be configured to perform the process 1842. Any computing device described herein can be configured to perform the process 1842.

In step 1844, the RAP 120 and/or the data ingestion service 116 can receive weather threat data from a data source. The RAP 120 can receive weather threat data from the local or third party data sources (e.g., 102) or can receive processed threats from the geofence service 118 originally received and processed by the data ingestion service 116 and/or the geofence service 118.

In step 1846, the RAP 120, the data ingestion service 116, and/or the geofence service 118 can generate multiple weather threat events based on the received data of the step 1846. In some embodiments, the received data is raw data, e.g., temperatures, wind speeds, etc. In some embodiments, the received data is a threat event. In some embodiments, the RAP 120, the data ingestion service 116, and/or the geofence service 118 can generate one or more weather threat events and one or more non-weather threat events based on the received data of the step 1844. For example, in some embodiments, the RAP 120, the data ingestion service 116, and/or the geofence service 118 can generate one threat event based on high temperatures and another threat event based on an unusually large population in or near a building or site, such as due to a conference or other gathering.

In the step 1848, the RAP 120 can generate risk scores for a particular building asset (e.g., a building, a geographic area, an occupant of the building, equipment within the building, etc.). The risk scores may be a risk score for a particular asset determined based on each of the threat events received in the step 1844 or determined in the step 1846. In this regard, if there is a high snowfall threat event and a low temperature threat event, two separate risk scores can be determined each for the two threat events. Similarly, if there is a high temperature threat event and large population threat event, two separate risk scores can be determined for those events.

In the step 1850, the RAP 120 can determine a final risk score for the building asset based on the risk scores determined in the step 1848 and based on weather threat correlation rules. The correlation rules may be the weather correlation rules 1838. The correlation rules 1838 may indicate that particular weather related threat events should have combined risk scores since both of the weather threat events together may indicate a situation more dangerous that the weather threat events on their own. The correlation rules may indicate a particular weighting factors such that a final risk score can be generated based on the values of the correlated weather related threats.

For example, in the step 2508, for multiple threat events, the analytics service 628 can use the Equation 6 to generate a final risk score. In some embodiments, the analytics service 628 can use the weather correlation rules 2304 to determine a final risk score based on one or more weather threat events and one or more non-weather threat events. For example, in some implementations, the analytics service 628 can determine a final risk score based on a first risk score for a high temperature threat event and a second risk score for a large population threat event, where the weather correlation rules 2304 may indicate that the final risk score should be higher than the individual risk scores due to the combination of the high temperature and the larger than normal population leading to a higher level of risk.

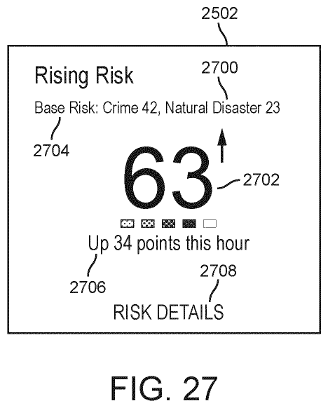

In step 1852, the RAP 120 can provide the final risk score to a user interface e.g., the risk applications 126. In some embodiments, the risk score can be provided and displayed in the user interface described with reference to FIGS. 27-33. Furthermore, the RAP 120 can, in step 1854, control various pieces of building equipment based on the risk score. In some embodiments, building equipment could control an environmental condition (e.g., temperature) to be unusually high if a risk score for a low temperature threat event is determined. In some embodiments, the building control equipment could issue warning or alerts (e.g., evacuate a building, take cover, move to a basement area, etc.).

Referring now to FIG. 18F, a process 1856 for using historical weather data to determine risk scores is shown, according to an exemplary embodiment. The RAP 120 can be configured to perform the process 1856. Furthermore, a processing circuit, e.g., a processor and/or memory, can be configured to perform the process 1856. Any computing device described herein can be configured to perform the process 1856.

In step 1858, the RAP 120 can receive a first set of weather data. The received first set of weather data can be weather threat events, ambient temperatures, humidity values, air quality values, etc. In some embodiments, the stored data includes risk scores for various weather threat events that have occurred over a past decade. This first set of data can be stored in the historical weather database 1338 in step 2604. Over time, the analytics service 628 can collect and store the data in the historical weather database, i.e., perform the steps 2402 and 2604 iteratively for days, months, years, decades, etc.

In step 1862, based on the received historical data, the RAP 120 can generate normal weather rules (e.g., the normal weather rules 1840). The normal weather rules may indicate the normal weather conditions of a particular area. The rules may be a temperature range, a snowfall amount range, etc. Furthermore, the ranges can be risk score ranges of the normal value of a risk score for a particular weather threat event. If a winter temperature is between 50 degrees Fahrenheit and 65 degrees Fahrenheit, a temperature of a threat event for 5 degrees Fahrenheit may indicate an abnormally cold threat event. Furthermore, the rules may indicate risk score ranges for various weather threat events. For example, air quality risk scores for air quality threat events may be risk scores between 30 and 40. An air quality risk score outside of the risk score range may indicate that an abnormal air quality condition is present.

In step 1864, the RAP 120 can receive a second set of weather threat data from the data source. The second set of weather threat data may be current threat data for the data source. In step 2610, the analytics service 628 can generate an asset risk score based on the received second set of data. The analytics service 628 can generate the risk score based on the building asset risk model 1812.

In step 1868, the RAP 120 can generate a final asset risk score based on comparing the value of the asset risk score determined in the step 1864 to the normal weather rules generated in the step 1862. If the rules indicate that the weather threat event is abnormal, e.g., outside a usual temperature range is a threat event that rarely occurs, etc., the RAP 120 can increase the asset risk score. In some embodiments, a multiplier is chosen or retrieved for increasing the risk score. The multiplier can be multiplied with the risk score to generate the final risk score.

In some embodiments, the multiplier is dynamic, i.e., based on the threat event, a multiplier can be generated and utilized to increase the risk score. For example, the frequency at which a threat event occurs (e.g., of the threat event rules), can determine the multiplier. A threat event that occurs less than a predefined amount may be associated with a first multiplier. The process 1856 can proceed to 1870 and/or 1872, both of which are described with further reference to FIG. 18E.

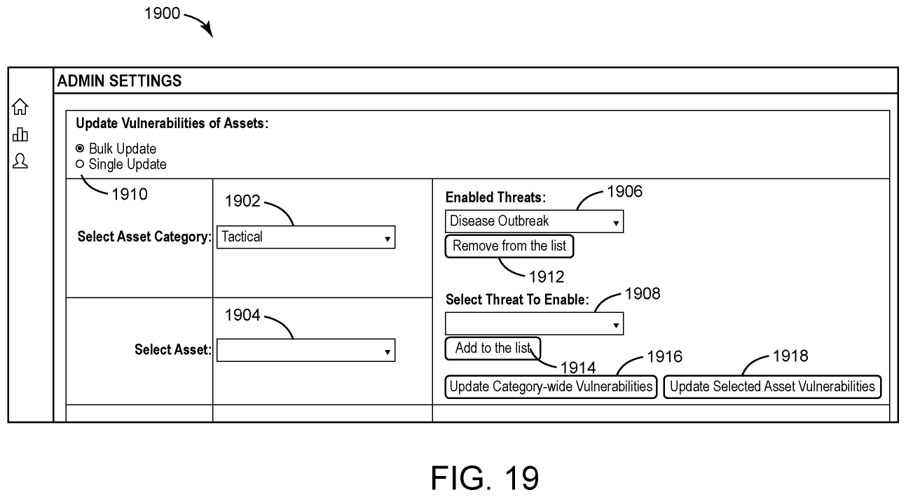

Referring now to FIG. 19, an interface 1900 is shown for managing the VT matrix 1700, according to an exemplary embodiment. The interface 1900 may be an administrator dashboard that can be configured to update the settings of the VT matrix 1700. The ability to modify the settings of the VT matrix 1700 provides a unique capability to the site managers to control the risk ratings for their assets. The administrator for a building which is the asset in this case can change the settings both individually for each asset or make a bulk update based on the type of the assets. The VT matrix 1700 is assumed to be binary in this example for simplification. However, the values of the VT matrix 1700 can be anything between [0, 1] to show zero to full vulnerability of the asset towards a particular threat.

The interface 1900 includes selections to update the VT matrix 1700 in bulk and/or for a single asset via selecting option 1910. The interface 1900 includes a select asset category dropdown 1902. The dropdown 1902 allows a user to select all assets of a particular category. “Tactical” is shown as the selected category but any other category “Human,” “HVAC Equipment,” and/or any other category can be included in the dropdown 1902.

If the user is operating in a “Single Update” mode, particular assets can be selected via dropdown 1904. The assets in the dropdown 1904 can be numbered with an identifier, e.g., “1,” “2,” etc. and/or with a name “Building Lobby,” “Grand Hotel,” and/or any other asset. Particular threat categories can be enabled for an asset and/or group of assets. For example, dropdown 1906 can provide a user with a list of threat categories that are enabled for asset and/or asset group. A “Disease Outbreak” threat category is shown but any other type of threat “Shooting,” “Rain,” “Flooding,” etc. can be included in the list. If the user interacts with the button 1912, the selected threat from the list can be disabled and removed from the list.

The dropdown 1908 can allow a user to view threat categories (threat categories not already in the dropdown 1906) to the dropdown 1908. If a user selects a particular threat category via the dropdown 1908 and interacts with the button 1914, the threat category can be added to the list of threats that the asset and/or assets are vulnerable to, e.g., the selected threat is added to the dropdown 1906.

The user can enter a particular value for a threat and/or asset vulnerability. In response to interacting with the button 1916, the group of assets selected via the interface 1900 can be updated with the entered value. If the user interacts with the button 1918, the particular singular asset selected by the user via the interface 1900 can be updated. Based on the selection via option 1910, the button 1916 and/or 1918 can be enabled and/or disabled to be interacted with (in bulk update mode the button 1916 can be enabled while in single update mode the button 1918 can be updated).

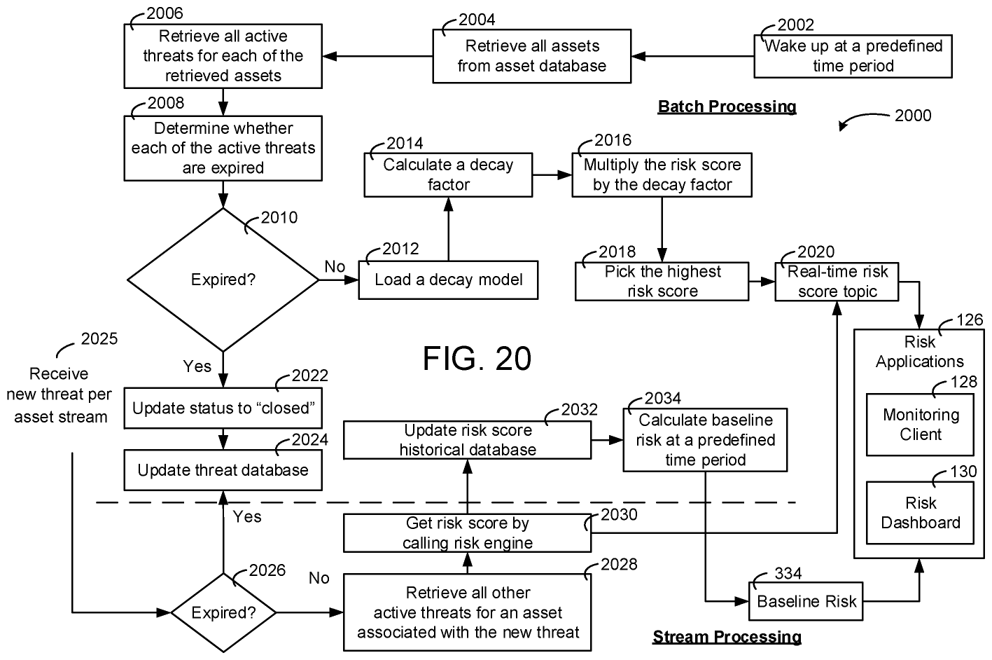

Referring now to FIG. 20, a process 2000 is shown for performing risk decay and threat expiry batch processing and risk updating for streaming new threats, according to an exemplary embodiment. The RAP 120 can be configured to perform the process 2000; furthermore, the risk decay manager 320, the threat expiration manager 322, and/or the base risk updater 324 can be configured to perform the process 2000. The process 2000 is shown to be divided into two sets of steps, the batch processing steps, steps 2002-2024, 2032, and 2034, and the stream processing steps, steps 2025-2030.

The stream processing steps can update risk score in real-time. After the threats are identified to be at the vicinity of an asset by the geofence service 118, they are enriched with the asset information. The RAP 120 can check to make sure the threat is not expired by checking the current time and the expected expiry time. If the event is expired, it will be persisted to the database. If it is not expired, then it will be sent to the risk engine along with all the other active threats for that specific asset to generate a risk score. The generated risk score will be pushed to the real-time risk score topic 2020 to be consumed by the monitoring client 128 and the risk dashboard 130. It will also be persisted to the database of historical risk scores.

The batch processing steps for risk decay and threat expiry can be handled by a set of batch processes. The batch processes may be a continuously running process that wakes up at a predefined interval (e.g., every 10 minutes) and retrieve all the assets from the database. Then for each asset all the active threats are queried. Active threats are the threats with status set to “open”. The database used within the risk analytics pipeline stores the threats after the threats have been enriched after the geofence service 118 and asset service 304 call. Therefore the threats are stored with asset information and also one threat per asset at a time. The current time will be compared with the expiry time predicted value. If the current time exceeds the predicted expiration time then the threat will be considered to be expired. The expired threat then can be pushed to the database for storage. If the threat is not expired, the risk score from that threat can be decayed. This can be done by loading the right decay model (polynomial function for example) and calculating the decay factor from the equations as described with reference to FIGS. 23-24 by replacing the parameters t, a in the formula representing the time has passed from the beginning of the threat creation and the expected duration of the threat.

The risk score then can be multiplied by the decay factor. This will repeat for all the active threats for that specific asset and then the highest risk score will be selected as the risk score for that specific asset. This process can repeat for all the assets until all the risk scores are updated. The updated risk scores can be pushed to a real-time risk score topic (e.g., a Kafka topic) from which the monitoring client 128 and the risk dashboard 130 fetch the risk score updates.

Baseline risk score is another batch processes that updates the baseline risk every particular interval (e.g., every ten minutes). The baseline risk score can be calculated by aggregating all the risk scores generated for that asset over the historical period (the longer the better). The aggregate scores will be grouped per category and those scores will be pushed to the historical/baseline topic to be consumed by the applications.

Referring more particularly to FIG. 20, in step 2002, the RAP 120 wakes up at a predefined interval to perform the batch processing steps 2004-2024, 2032, and/or 2034. In some embodiments, the batch process manager 318 wakes up at the predefined interval to perform the batch processing steps. In some embodiments, the interval is a ten-minute interval but can be any period of time.

In step 2004, the RAP 120 can retrieve all assets from the asset database 306. The assets can be all assets currently stored in the asset database 306. In step 2006, based on the retrieved assets, threats for each of the retrieved assets can be retrieved by the RAP 120. For example, the threats may be stored in the risk database 314 and thus the RAP 120 can retrieve the threats for each asset from the risk database 314. In some embodiments, only threats marked as “active” are retrieved by the RAP 120.

In step 2008, the RAP 120 can determine whether each of the active threats retrieved in the step 2006 are expired. Each of the threats retrieved in the step 2006 may be marked as active or closed. If the threat is marked as active, the RAP 120 can determine if an expiry time associated with the threat has passed. In step 2010, if the expiry time has passed as determined in the step 2008, the process can continue to step 2022 but if the expiry time has not passed, the process can continue to step 2012.

In step 2012, the RAP 120 can load a decay model for the threats retrieved and determined to not be expired in the steps 2006-2010. The decay model can be specific to each of the threats and/or for each of the assets. In this regard, for a particular combination of a threat and an asset, a specific decay model can be selected. In this regard, the appropriate decay, modeling the response to an incident, for a particular threat affecting a particular asset can be modeled.

In step 2014, based on the loaded decay models, decay factors can be determined for the threats by the RAP 120. In step 2016, the decay factors can be multiplied by the RAP 120 against the risk score of the threats to generate a decayed risk score. In some embodiments, where a particular asset is associated with multiple different threats, a risk score can be determined and/or decayed for that asset. The RAP 120 can compare the multiple risk scores against each other for the asset and select the highest risk score in the step 2018. The highest risk score selected in the step 2018 can be set to the real-time risk score topic and the risk applications 126 (the monitoring client 128 and/or the risk dashboard 130) can read the real-time risk score topic 2020 to retrieve the highest risk score for a particular asset and cause the highest risk score to be displayed in a user interface.

If one or multiple threats have expired, determined in the steps 2008-2010, the RAP 120 can update the status of the threat to “closed” to indicate that the threat is no longer active in step 2022. In step 2024, the threat database 124 can be updated by a threat database (e.g., the threat database 124) to include the new “closed” statuses for the threats that have been determined to have been expired.

In step 2025, the RAP 120 can receive a new threat from one of the data sources 102. Since the threat may be new, the step 2026, 2028, and/or 2030 can be performed as stream processing, i.e., in response to receiving the new threat. Since the new threat may be associated with an expiration time, the RAP 120 can determine, based on the expiration time, whether the new threat has already expired. In response to determining that the new threat has already expired, the process can proceed to the step 2024. In response to determining that the new threat has not yet expired, the process can move to the step 2028.

In step 2028, the RAP 120 can retrieve all other active threats for the asset affected by the new threat. In step 2030, based on the new threat and/or all the other active threats retrieved in the step 2028, the RAP 120 can determine a risk score for the asset by calling the risk engine 310 to determine the risk score for the new threat (or the other active threats retrieve din the step 2028). The RAP 120 can compare the score of the new threat and the other threat scores and select the highest score to be the score for the asset.

In step 2032, the RAP 120 can update a historical database of risk scores for the asset. The historical database of risk scores can indicate risk scores for the asset for a particular time and/or for particular times over an interval (e.g., a window of time). In step 2034, the historical risk scores of the historical database can be used to calculate a baseline risk score. The baseline risk score can be generated by averaging risk scores over a particular time period, the risk scores retrieved from the historical database. The result of the calculation of the step 2034 may be the baseline risk 334. The baseline risk 334 can be saved as an endpoint that the risk applications 126 can query to retrieve the baseline risk 334 and present the baseline risk 334 to a user via the monitoring client 128 and/or the risk dashboard 130.

Referring now to FIG. 21-22, two charts illustrating risk scores for a particular asset over time are shown, chart 2100 not including risk decay and chart 2200 including risk decay, according to an exemplary embodiment. Three threats 2102, 2104, and 2106 and the dynamic risk scores for each threat are shown in the chart 2100 with no risk decay model being applied to the risk scores. Asset sum risk 2108 is shown to be a trend of all asset risk scores summed together. The asset peak risk 2107 can track the highest risk score based on each of the threat asset risk scores 2102-2106. Furthermore, the asset baseline risk 2110 is shown tracking the baseline (e.g., average over a predefined previous time period) for the asset. In some embodiments, the risk presented to end users and/or used to cause an automated workflow to occur is the peak risk score and/or sum risk score.

As shown in the chart 2100, the threat risk scores 2102-2106 have a beginning time and an expiration time. However, the value for each of the threat risk scores 2102-2106 ends suddenly; there is no decay of the score. In many instances, setting the risk score to zero for one of the threat risk scores 2102-2106 does not properly model an incident since the risk score associated with the incident may decrease over time. In this regard, the risk decay as described elsewhere herein can be applied to the risk scores to more accurately model how risk behaviors and incidents are responded to and resolved. Chart 2200 provides an example of risk decaying over time.

There is not information about the decay if focus is put on the two states of a threat “open” and “closed”. An analyst will have no expectation on how long a threat is going to last until suddenly the score goes down. But with risk decay, the score goes down gradually according to the expiry time predicted by a machine learning model developed on the historical data and thus the analyst has an idea of how long the risk is expected to last.

In chart 2200, three threat risk scores 2202-2206 are shown where a risk score is decayed over time. The threats are the same as the threat risk scores 2102-2106 of chart 2100 but the risk is decayed with a decay model. The threats 2202 and 2204 are decayed with a polynomial decay model while the threat 2206 is decayed with an exponential risk model. The different threats can be decayed with different models based on a combination of the particular asset and/or the particular threat. Since the threat risk scores 2202-2206 are decayed over time, the asset sum risk 2212, which is a summation of all risk scores, is shown to also be decayed while the asset peak risk score 2210, which is the highest current decayed risk, is also decayed since it is based on the decayed risk scores 2202-2206. The baseline 2208 is shown to be the same as the baseline 2110 since the baselines can be determined based on the raw risk values, not the decayed risk values. In some embodiments, the baseline risk score is based on the decayed risk values.

Referring now to FIG. 23-24, a chart 2300 of an exponential risk decay model and a chart 2400 of a polynomial risk decay model are shown, according to an exemplary embodiment. There are different types of risk decay models to apply to the dynamic risk (polynomial, exponential, linear, etc.). Two useful decay functions for the risk decay model, ρ(t), are shown in the FIGS. 23-24.

The two proposed decay functions of FIGS. 23-24 both provide the gradual decay operation with different properties. The exponential decay function, shown in FIG. 23, has a very fast decay at the beginning but then becomes slow at the end of the curve. This type of decay function is appropriate for representing the cases that has a sudden impact and expires fast but it lingers for some time because of the possible consequences on peoples and public view. For example, a bomb threat can be a high risk but it quickly decays because they find out it was a false alarm however, the police remains vigilant and ask public to be aware until the risk is completely gone away. The exponential decay is aggressive (more than 80% of the risk will be eliminated half way thru the life span of that threat in exponential decay) and should be applied only in cases that has a good justification.

The polynomial decay function, as shown in FIG. 24, has a slow decay at the beginning of the curve but close to the end of the curve it becomes a faster decay. This model which is suitable for the majority of the threats provide a better transition since it preserves the impact of the threat for the most part of the predicted active period. A minor accident for example needs to stay active and decay slow until police shows up and deals with the situation. Then the traffic goes to normal very quickly. Polynomial decay function can be very useful in those scenarios.

The polynomial decay function parameters can be determined from Theorem 1.
Theorem 1 (Polynomial Risk Decay Function)
Given a quartic function with a degree-4 polynomial for the decay model,

f (x)=a₄x⁴+a₃x³+a₂x²+a₁x+a₀

the polynomial coefficients for a quarterly interpolation points of [1, 0.95, 0.80, 0.60, 0.05] can be uniquely calculated as,

a₀=1

a₁=0.4167a⁻¹

a₂=−3.767a⁻²

a₃=6.133a⁻³

a₄=−3.73a⁻⁴

where α is a positive real number representing the expected expiry time of the threat in minutes.

### Proof

Applying the interpolation points {(0, 1), (0.25α, 0.95), (0.5α, 0.8), (0.75α, 0.6), (α, 0.05)} to the equation f (x)=a₄x⁴+a₃x³+a₂x²+a₁x+a₀ leads to the linear system of equations below,

a₁(0.25a)+a₂(0.25a)²+a₃(0.25a)³+a₄(0.25a)⁴=−0.05

a₁(0.5a)+a₂(0.5a)²+a₃(0.5a)³+a₄(0.5a)⁴=−0.2

a₁(0.75a)+a₂(0.75a)²+a₃(0.75a)³+a₄(0.75a)⁴=−0.4

a₁a+a₂a²+a₃a³+a₄a⁴=−0.95 a₀=1

Using the Cramer's Rule, as described in greater detail in I. Reiner, Introduction to matrix theory and linear algebra, Holt, Rinehart and Winston, 1971,

$${a}_{1} = \frac{\vert \begin{matrix}- 0.05 & {( 0.25 a )}^{2} & {( 0.25 a )}^{3} & {( 0.25 a )}^{4} \\ - 0.2 & {( 0.5 a )}^{2} & {( 0.5 a )}^{3} & {( 0.5 a )}^{4} \\ 0.4 & {( 0.75 a )}^{2} & {( 0.75 a )}^{3} & {( 0.75 a )}^{4} \\ - 0.95 & {a}^{2} & {a}^{3} & {a}^{4}\end{matrix} \vert}{\vert \begin{matrix}0.25 a & {( 0.25 a )}^{2} & {( 0.25 a )}^{3} & {( 0.25 a )}^{4} \\ 0.5 a & {( 0.5 a )}^{2} & {( 0.5 a )}^{3} & {( 0.5 a )}^{4} \\ 0.75 a & {( 0.75 a )}^{2} & {( 0.75 a )}^{3} & {( 0.75 a )}^{4} \\ a & {a}^{2} & {a}^{3} & {a}^{4}\end{matrix} \vert} = 0.4167 {α}^{- 1}$$

$${a}_{2} = \frac{\vert \begin{matrix}0.25 a & - 0.95 & {( 0.25 a )}^{3} & {( 0.25 a )}^{4} \\ 0.5 a & - 0.2 & {( 0.5 a )}^{3} & {( 0.5 a )}^{4} \\ 0.75 a & - 0.4 & {( 0.75 a )}^{3} & {( 0.75 a )}^{4} \\ a & - 0.95 & {a}^{3} & {a}^{4}\end{matrix} \vert}{\vert \begin{matrix}0.25 a & {( 0.25 a )}^{2} & {( 0.25 a )}^{3} & {( 0.25 a )}^{4} \\ 0.5 a & {( 0.5 a )}^{2} & {( 0.5 a )}^{3} & {( 0.5 a )}^{4} \\ 0.75 a & {( 0.75 a )}^{2} & {( 0.75 a )}^{3} & {( 0.75 a )}^{4} \\ a & {a}^{2} & {a}^{3} & {a}^{4}\end{matrix} \vert} = - 3.767 {α}^{- 2}$$

$${a}_{3} = \frac{\vert \begin{matrix}0.25 a & {( 0.25 a )}^{2} & - 0.05 & {( 0.25 a )}^{4} \\ 0.5 a & {( 0.5 a )}^{2} & - 0.2 & {( 0.5 a )}^{4} \\ 0.75 a & {( 0.75 a )}^{2} & - 0.4 & {( 0.75 a )}^{4} \\ a & {a}^{2} & - 0.95 & {a}^{4}\end{matrix} \vert}{\vert \begin{matrix}0.25 a & {( 0.25 a )}^{2} & {( 0.25 a )}^{3} & {( 0.25 a )}^{4} \\ 0.5 a & {( 0.5 a )}^{2} & {( 0.5 a )}^{3} & {( 0.5 a )}^{4} \\ 0.75 a & {( 0.75 a )}^{2} & {( 0.75 a )}^{3} & {( 0.75 a )}^{4} \\ a & {a}^{2} & {a}^{3} & {a}^{4}\end{matrix} \vert} = - 6.133 {α}^{- 3}$$

$${a}_{4} = \frac{\vert \begin{matrix}0.25 a & {( 0.25 a )}^{2} & {( 0.25 a )}^{3} & - 0.05 \\ 0.5 a & {( 0.5 a )}^{2} & {( 0.5 a )}^{3} & - 0.2 \\ 0.75 a & {( 0.75 a )}^{2} & {( 0.75 a )}^{3} & - 0.4 \\ a & {a}^{2} & {a}^{3} & - 0.95\end{matrix} \vert}{\vert \begin{matrix}0.25 a & {( 0.25 a )}^{2} & {( 0.25 a )}^{3} & {( 0.25 a )}^{4} \\ 0.5 a & {( 0.5 a )}^{2} & {( 0.5 a )}^{3} & {( 0.5 a )}^{4} \\ 0.75 a & {( 0.75 a )}^{2} & {( 0.75 a )}^{3} & {( 0.75 a )}^{4} \\ a & {a}^{2} & {a}^{3} & {a}^{4}\end{matrix} \vert} = - 3.73 {α}^{- 4}$$

where |M| denotes the determinant of matrix M.

Referring generally to FIGS. 25-29, interfaces that the monitoring client 128 can be configured to generate and cause the user devices 108 to display and/or receive interface interactions from are shown according to various exemplary embodiments. The interfaces of FIGS. 25-29 can provide alarm handling integrated with risk scores, asset information, and/or threat information. Security operations often involve dealing with a high volume of alarms generated from cameras, sensory devices, controllers, Internet of Things (IoT) devices, fire & security system, badge in/out reports and door forced open incidents and so on. Handling alarms in such a large volume requires assigning significant resources to monitor the alarms and make the appropriate decision to take actions based on the current situation. Prioritizing alarms, providing contextual information about assets and the threats involved and filtering/sorting alarms are very important to reduce the time and improve the user experience on the alarm monitors. The interfaces of FIGS. 25-29 provide integrated risk and threat analysis into a single user interface and/or user interface system.

Referring now to FIGS. 25-27, interfaces are shown with risk score and active threats as contextual information for responding to incidents, according to an exemplary embodiment. In FIG. 25, a risk card 2502 is shown, the risk card illustrates both dynamic and baseline risk for an asset. The risk card 2502 is described in greater detail in FIG. 27. Interface element 2504 is shown to provide information regarding a particular threat received from one of the data sources 102 and that the risk analytics system 106 standardizes. The element 2504 provides an indication of the threat (“Active Shooter”) a threat category (“Security & Crime”), a brief explanation of the threat (can be the raw summary text received from the data sources 102 and used to perform NLP on), an indication of the data source itself (“DataMinr”), an indication of the distance away from a particular asset (“3 miles away”) and an indication of the assets affected by the threat (i.e., number of buildings and/or employees affected by the threat). The element 2504 allows a user to view the type of building affected by the threat; in element 2504, the building affected by the threat is a retail building. Finally, the users that are logged into the monitoring client 128 that have viewed the element 2504 are recorded and provided as part of the element 2504. In this regard, a building operator can quickly gain an understanding of what building personal are aware of a particular threat and can more quickly respond to a threat since the operator may not need to notify a building person who has already seen the threat.

Element 2506 of the interface 2500 provides information pertaining to the asset affected by the threat described in the element 2504. The asset affected by the threat in this example is a retail building. The retail building is shown on a map interface along with a distance of the building from the threat, a name of the building, and an address of the building. The map illustrates both the location of the threat and the location of the building. Furthermore, a navigation route from the building of the threat is provided.

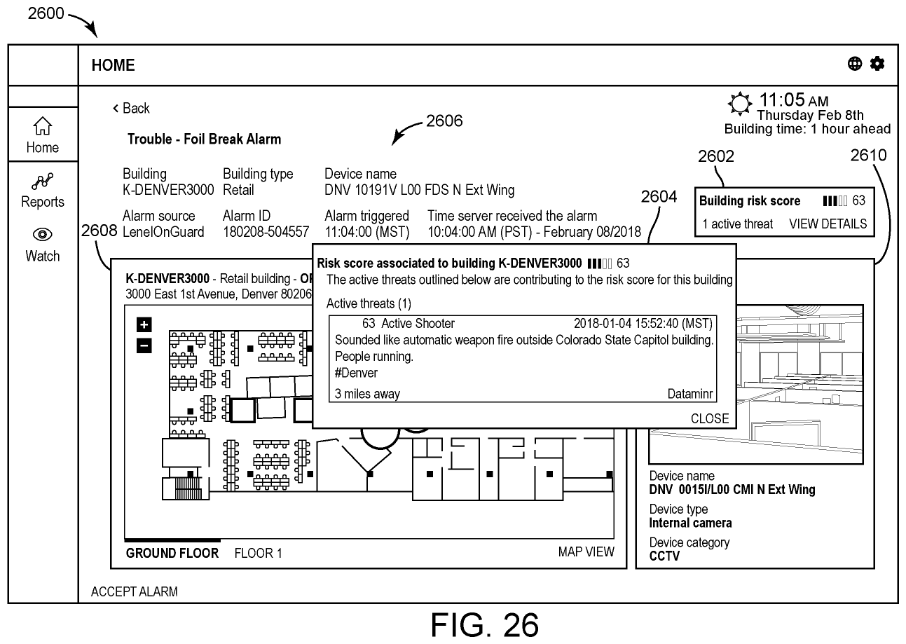

In FIG. 26, an interface 2600 provides information for another threat and information for an asset affected by the threat. Interface 2600 is shown to include threat details 2606. The details 2606 indicate a type of threat, in this case a “Foil Break Alarm,” an indication of a building name, an indication of a building type, the equipment which picked up the threat, an alarm source, an alarm identifier, a time that the alarm was triggered, and a time that the risk analytics system 106 received the alarm.

Element 2602 provides a dynamic risk score for the building affected by the threat, an indication of a number of threats currently affecting the building, and an element to view additional details regarding the building. Element 2608 provides a floor plan indication of the building affected by the threat of element 2606. The user can view each of the floors of the building and view, on the floor plan map, where the threat is occurring within the building. The element 2604 provides an indication of a dynamic risk score for the building an a tabulation of each of the threats affecting the building, for example, if another threat is affecting the building outside of the “Foil Break Alarm,” an active shooter threat, the active shooter threat and/or the foil break alarm can be shown in the element 2604 along with an indication of the risk score value for the particular threat. Element 2610 provides an indication of security camera feeds associated with the building at a particular location associated with the location of the threat occurring within the building. For example, the monitoring client 128 can be configured to identify, based on equipment reporting the foil break alarm, what camera in the building views the equipment and/or space associated with the equipment. In this regard, a user can view a live stream and/or a historical video stream (associated with the time at which the threat was triggered) to review the threat.

In FIG. 27, the risk card 2502 is shown in greater detail. The risk card 2502 includes an indication of a baseline risk values and an associated threat category, i.e., elements 2704 and 2700. For example, a particular asset can have multiple base risks, one baseline risk for crime and another baseline risk for natural disasters. A dynamic risk 2702 is further shown indicating the highest risk score reported for the asset. Element 2706 provides an indication of whether the risk score has been rising and/or falling for a predefined time period. The monitoring client 128 can be configured to determine whether the risk score has risen and/or fallen over a predefined time period and can provide the risk card 2502 with an indication of the amount that the risk score has risen or fallen. If the risk score is rising, the monitoring client 128 can cause the risk card 2502 to provide an up arrow while if the risk score is falling the monitoring client 128 can provide a down arrow. The user can interact with a risk details element 2708. In response to detecting a user interacting with the risk details element 2708, the monitoring client 128 can cause information pertaining to a risk (all threats reported for the asset, the highest risk threat, etc.) to be displayed.

The risk card 2502 includes the most critical information but in a concise and brief manner. The risk card 2502 includes the dynamic risk score which corresponds to the current risk score from real time active threats. Then it also includes baseline risk score which shows the risk score over an extended period of time. Combination of these two together makes it a meaningful insight. Neither of them alone may be enough. Considering a location such as Miami, the risk of Tornado is higher in Miami as compared to Milwaukee but if one looks into the dynamic risk score which comes from the active threats reflecting what is happening “right now” that might not even show any difference because tornados do not happen any minute. However, if one looks into base risk score, which has been calculated over 50 years of data, then one would see that there is a noticeable difference in those scores between those cities.

On the other hand, dynamic risk score is beneficial for situational awareness to understand what threats are active at the moment and which one has the highest risk. So the risk card shows both base and dynamic risk score. It also shows the slope (rise or fall) on the last hour for dynamic risk to show where it is headed.

The risk card 2502 includes two categories for base risk score: Crime and Natural disaster. Those are the two main categories that many users care about according to some studies. The baseline risk scores for crime and natural disaster when combined might convey wrong information. In this regard, baseline risk scores can be determined for particular categories so that a user can compare a dynamic risk score for crime to the baseline for crime and a dynamic risk score for natural disasters to the baseline for natural disasters.

Other than the risk card, an “alarm details” page can be viewed in response to interacting with the element 2708 which shows the more detailed info on that alarm or threat. In that page, additional information on the risk score is provided as well for example the distance of the threat and also the details of the asset that was impacted. In the detailed information page, one can also show the base risk score at the sub-category level. For example if risk score is shown to be high for natural disaster at the risk card level, the interface can specify which sub-category e.g. earthquake, tornado, snowfall, etc. on the detailed page.

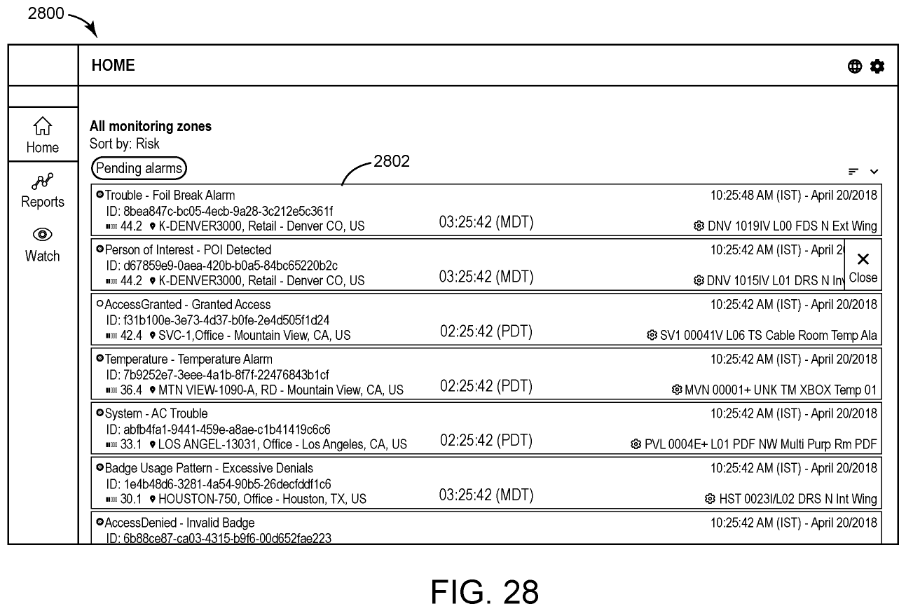

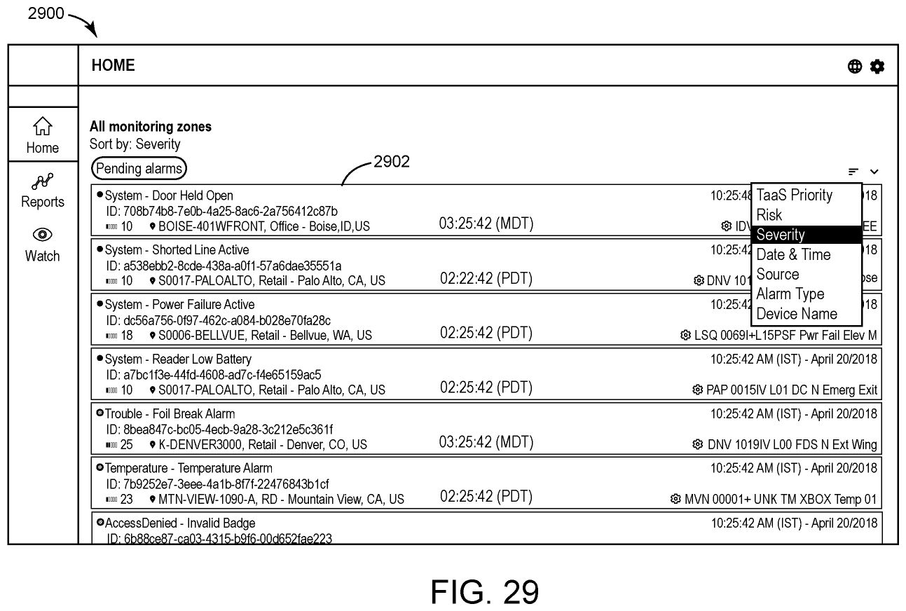

Referring now to FIGS. 28-29, interfaces 2800 and 2900 are shown including a list of active threats for an asset listed along with the risk associated for each threat. The higher the risk score the more important that threat is. In this regard, the monitoring client 128 can dynamically prioritize alarms, i.e., threats, based on a risk score associated with the asset affected by the threat. The monitoring client 128 can be configured to dynamically sort the threats of the list 2802 and 2902 so that the highest risk scores are shown on the top of the list, allowing a user to quickly identify what threats and/or assets are associated with the highest priority. As can be seen in interfaces 2800-2900, as new threats are reported, and risk scores change, threats can move up and down the list, as can be seen from list 2802 to 2902.

Existing solutions may prioritize events and alarms by adding “severity” metadata fields to the monitored data. These severity fields are usually configured by the site-monitoring devices themselves. One disadvantage of these methods is the severity data's lack of situational context. For example, two identical “glass break” events in two different buildings may have different actual priorities if one of the buildings is near a civil demonstration. Similarly, the same category of asset threat would have a different actual impact on buildings of greater value, or where a senior executive, or a known offender, is present. In current solutions, such events are likely to be given equal priority without further investigation, adding potential cost and delay to the incident management process. An automated, more richly contextualized risk analysis of threat data facilitates a more timely and accurate prioritization of asset threats.

As another example, a broken window in a building could trigger a break glass alarm event. The risk score for the building asset would be increased in response to the event occurring. The risk score for the building may not trigger any automated workflow (e.g., call the police). However, if there is an event in the vicinity of the building, e.g., an active shooter, the building asset risk score could be elevated. The break glass event risk score could be added to the already elevated risk score to reflect the larger potential significance of the break glass event occurring near the active shooter. This could cause an automated workflow to be triggered causing security personal to be contacted or access to specific areas of the building to be restricted.

For an increase in the risk reported from social media on a specific asset, the priority of the alarm related to that asset movies higher on the monitoring client interfaces 2800-2900 because of the increased risk. This provides dynamic alarm prioritization in real-time versus statically prioritizing alarms without including any signals on the incidents that happen in real time that leave a potential risk on assets.

The provided risk score can also be used to sort the alarms based on the risk score. The risk score can be dynamic risk score for the most important alarm at that particular time or it can be the baseline risk score to highlight the assets or neighborhoods that historically have shown higher exposer to threats like crime or natural disasters.

Referring now to FIG. 30, an interface 3000 is shown providing a global risk dashboard to view dynamic risk history, threat, and asset information interactively, according to an exemplary embodiment. The interface 3000 can be generated by the risk dashboard 130 to provide a user with information for assets and/or threats on a global scale. The risk dashboard 130 can provide a dedicated application to risk and threat analysis across all assets associated with a particular entity or group of entities (e.g., a store chain, a particular chain owner, etc.). The risk dashboard 130 is a comprehensive tool for risk analysis utilizing most of the backend service developed for risk. The interface 3000 can provide an overview of all assets and the major risk factors for each one, an analysis of threats by grouping them based on category, location and time frame. Furthermore, the interface 3000 can provide a view of historical values of dynamic risk. The interface can provide an indication of analysis of baseline risk scores for different neighborhoods and assets including comparisons and root cause analysis. The interface 3000 can provide risk forecasting based on the historical data and can provide the capability to do simulated scenarios for moving assets. The interface 3000 can use map view to quickly identify the threats and their risk scores against assets and explore assets, their values and vulnerabilities interactively.

The implementation of the risk dashboard 130 can be different in different applications. The risk dashboard 130 allows a user to view dynamic risk history, threats and asset information interactively. As shown in the figure, the threats can be categorized and filtered interactively to enable analyzing the risk globally across all assets. The threats can be filtered by asset category, threat severity, threat type, geographic regions, etc. Furthermore, the risk dashboard 130 (or any other risk dashboard described herein) can display forecasted risk for multiple future points in time based on multiple past threat values (e.g., for a particular asset). Risk scores can be forecasted via time series forecasting techniques such as the techniques as described in U.S. patent application Ser. No. 14/717,593, filed May 20, 2015, the entirety of which is incorporated by reference herein.

Referring more particularly to interface 3000, interface 3000 is shown to include an element 3002. The element 3002 can provide an indication of the most recent risk score for a particular asset for all assets reported in the interface 3000. Element 3004 can show the value of the risk score, an identification of an asset, a location of the asset, and time that the threat occurred that is affecting the asset. The risk information shown in the element 3004 can be the information of the last risk score shown in the element 3002.

A counter 3006 is shown in the interface 3000. The counter 3006 can count the number of threats that have been recorded for all assets on a global scale. An indication of a time at which the risk dashboard 130 most recently updated the counter 3006 can be shown. In some embodiments, the total number of threats shown by the counter 3006 is an all-time count and/or for a particular period of time into the past. The element 3008 can show a count of threats by data source. In this regard, the risk dashboard 130 can record the number of threats reported by teach of the data sources 102 and display the indication in the element 3008.

Element 3010 illustrates threats by geographic area on an interactive map. The asset locations shown may correspond to important cities and/or cities where assets belonging to the entity and/or entities are located. The risk scores for the assets can be shown by different colors to indicate the level of risk of each city. For example, some cities may have more risk scores and/or higher level risk scores, therefore, these cities can be assigned a different risk level and/or risk level color.

In element 3016, risk scores are shown over time. The risk scores can illustrate a trend for a particular asset, city, and/or a maximum reported risk score for multiple points of time. Element 3012 provides an indication of assets and the number of threats reported for particular locations (e.g., cities, states, countries, continents, etc.). Element 3014 provides an indication of a number of threats per category. The categories can be the same and/or similar to the categories described with reference to FIG. 5. Finally, element 3018 provides an indication of threats and the severity of the threats. The indications of threat severities are shown in a pie chart where a particular percentage of total reported threats have a severity level within predefined amounts associated with an “Extreme” label while a second percentage of total reported threats have a severity level within other predefined amounts associated with a “Severe” label.

Referring now to FIG. 31, an interface 3100 is shown including additional information on dynamic and baseline risk for a particular asset. The interface 3100 is shown to include an element 3102. The element 3102 can provide an indication of dynamic risk 332, element 3104, a trend of the dynamic risk trend 3106, and a baseline risk 3108. Element 3102 provides an indication of dynamic risk and highlighted threats impacting an asset. Risk dynamics can be studied by providing the risk evolution in time and highlighting major incidents causing the risk to rise or fall. The trend 3106 provides an indication of the risk levels rising due to major events.

The risk decay and threat expiry can also be studied in detail using the risk dashboard capabilities (e.g., the threat expiration and risk decay as shown and described with reference to FIG. 22 and elsewhere herein).

Referring to FIG. 29 and FIG. 31, historical risk and their evolution when threats are impacting the assets is shown. FIG. 29 particularly shows risk dynamics with threat expiry and decay factors. It should be understood that the baseline risk is also impacted by the introduction of the threats. However, the impact is very small compared to the dynamic risk because baseline risk considers the historical data so sudden changes in the data do not move the chart that much. There is a certain weighting for the history rather than the latest samples.

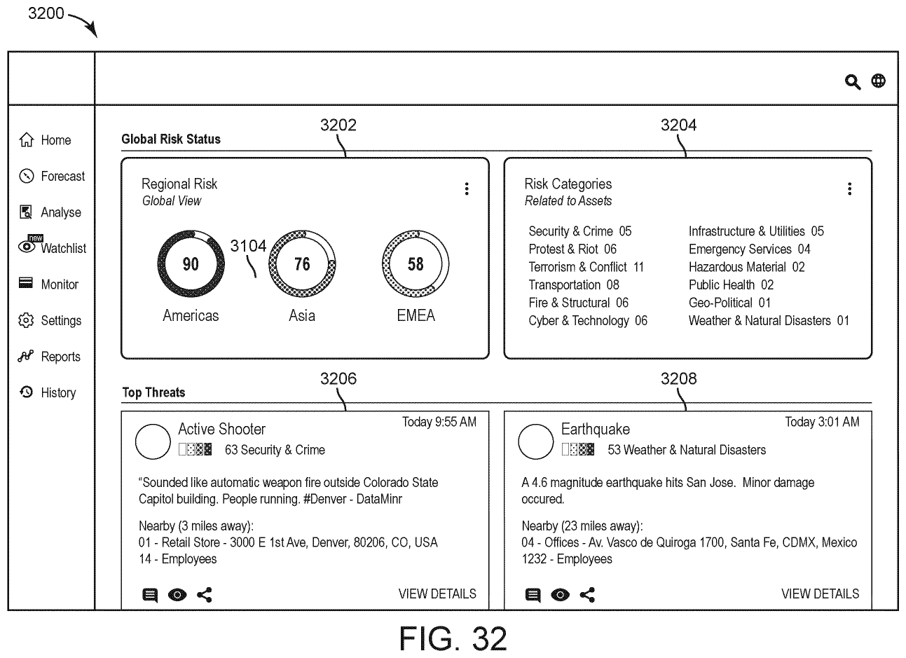

Referring now to FIG. 32, interface 3200 is shown providing analysis tools to study threats impacting the assets by grouping, sorting and/or forecasting, according to an exemplary embodiment. Interface 3200 is shown to include a regional risk element 3202. The risk element 3202 can include an indication of risk scores for particular geographic regions. The geographic regions themselves can be considered assets and therefore the risk score for the geographic region can be determined in the same manner as the risk scores are generated for other assets by the risk analytics system 106. Furthermore, the geographic risk scores can be generated as a composite (e.g., the highest, average risk score, median risk score) for all threats and assets located within the geographic region.

Interface 3200 is shown to include element 3204. Element 3204 includes an indication of a number of threats received from the data sources 102 for each of the number of categories determines for the threats by the risk analytics system 106. The threat categories can be ordered in a list so that the categories with the highest number of threats is at the top and the categories with the lowest number of threats is at the bottom. If a particular category has more than a first predefined number of threats, the category can be shown in red text. If the number of threats for a category is between a second and the first number of threats (a range less than the number of threats for the red text), the threats can be shown in yellow. If the number of threats are less than and/or equal to the second number of threats, the threats can be shown in white. For example, for threat, numbers are equal to and/or between 0 and 5, the categories can be shown in white. For threats equal to and/or between 6 and 11, the threat categories can be shown in yellow. For threat numbers equal and/or more than 12, the categories can be shown in red.

Elements 3206 and 3208 illustrate two threats and the assets that they each affect. The elements 3206 and 3208 are ordered based on the level of the risk that each represents. The elements 3206 and 3208 can be the same as and/or similar to the element 2504 as described with reference to FIG. 25.

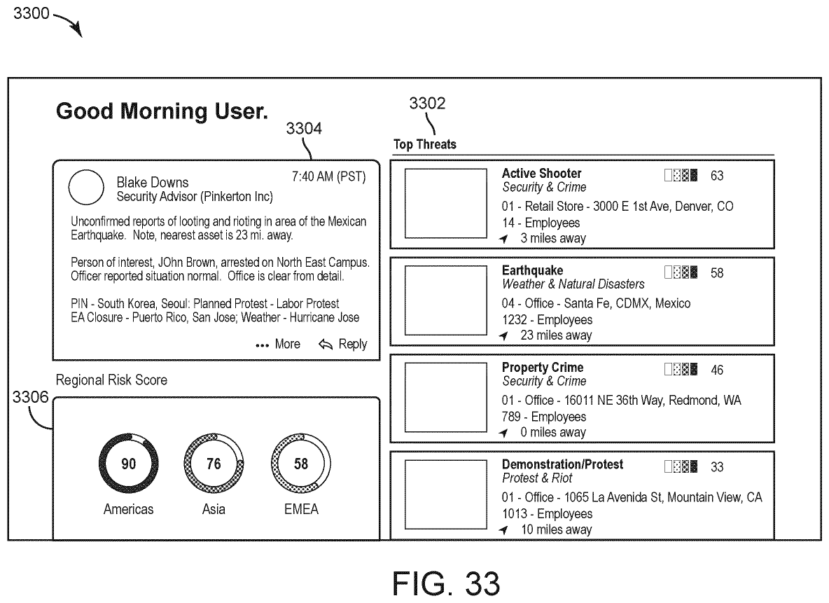

Referring now to FIG. 33, an interface 3300 is shown indicating the risk score, the threats can be studied by grouping and filtering certain categories or locations, according to an exemplary embodiment. Interface 3300 is shown to include comments by particular security operators in element 3304. In this regard, if a new user logins into the risk dashboard 130, they can be presented with the interface 3300 showing the comments of a previous user that the new user may be replacing. A security advisor can see the previous comments and pick up the work right from where others left off with all the information consolidated in one place. The interface 3300 further shows regional risk score in element 3306. The element 3306 may be the same as and/or similar to the element 3202 as described with reference to FIG. 2. Furthermore, the top threats for various assets are shown in element 3302 of the interface 3300.

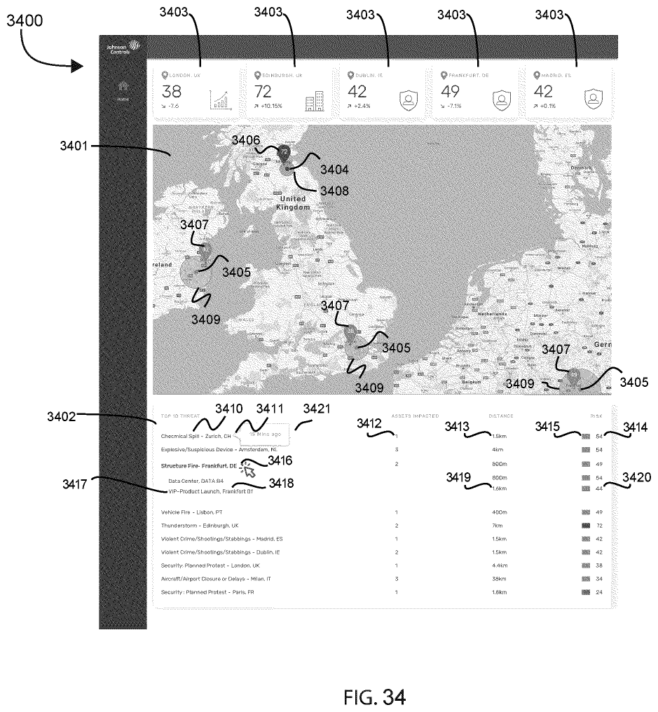

Referring now to FIG. 34, a user interface 3400 for a view of a risk position across a region of monitored asset risk shown. A view of a risk position across a region of the regional risk view may be a global region, a country, or a smaller area, such as a state or city. Regional risk view 3400 includes a region map 3401, a top threats list 3402, displaying the top threats affecting assets in the selected region, and a panel displaying key location summary cards 3403 relating to locations a user may select for ongoing monitoring.

Map 3401 displays asset location points 3406 and 3407 corresponding to the locations of each asset in the selected region, together with one or more threat location points 3404 and 3405. Asset location points 3406 and 3407 and threat location points 3404 and 3405 may be displayed in different colors, indicating different risk levels (for example, using a Red, Amber, and Green (RAG) coloring system). Asset location points 3406 and 3407 also include risk scores, which may be displayed as text (such as a numerical risk score or other description of risk) or icons. Threat location points 3404 and 3405 may include graphical indications 3408 and 3409 of a radius surrounding the threat. In some embodiments, the size of a radius is determined by the maximum area of influence for the threat. Different methods of displaying assets, threats, and risk scores in a regional map view are possible: the primary function of the regional risk view is to give monitoring personnel a single-pane overview of the risk position across a region. In other embodiments of the UI, other functionality may be provided, such as a time slider to view the risk and threat position on the map at different points in time, the ability to turn on or off hidden threats, and functionality for a user to adjust or relax the criteria for overlapping alerts and threats.

Asset risk scores are determined by a risk analysis platform, which uses various techniques to correlate threat data with an asset and aggregate the threat data to calculate a risk score, such as the risk analysis platforms described above in accordance with various example embodiments.

Top threats list 3402, displays a list of the threats associated with assets that have the highest risk score in the selected region. This list of threats associated with assets is an output of the risk analysis platform. The information on the list includes a description of the threat 3410 (e.g., chemical spill, thunderstorm, violent crime etc.), the location (e.g., city and country) of the threat 3411, the number of assets affected by the threat 3412, the distance of the threat from the nearest asset 3413, and an amalgamated risk score for the affected assets 3414, together with a graphical element indicating a risk score 3415, which may be a colored icon (e.g., using a RAG methodology) or some other iconographic representation of risk level. The list of threats 3402 may be ordered in different ways, for example, in order of descending risk score, number of assets affected, alphabetically, by threat type, or may not be in any particular order.

A user may select an individual listed threat 3416, and expand the entry to view the list of assets affected by the threat. In this expanded view, the user may view the asset type or description 3417, a selectable link to view detailed information about the asset in question 3418, the distance of the asset from the relevant threat 3419, and the asset's risk score 3420. Alternative embodiments of the display may use iconography to indicate threat categories and asset types. Regional risk view 3400 may also include useful interactive features, such as a hover-over, transient information element 3421 showing an elapsed time since threat data was received.

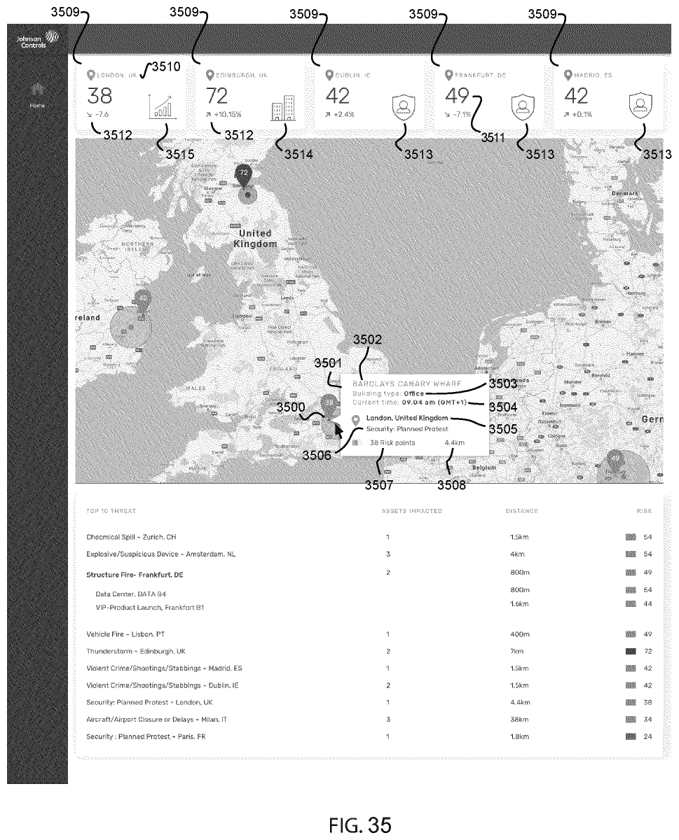

Referring now to FIG. 35, the user interface 3400 of FIG. 34 is further shown with a user's mouse cursor hovering over asset location icon 3500 in the regional risk view, causing asset risk summary panel 3501 to display. Asset risk summary panel 3501 includes the asset's name 3502, type (e.g., office, employee, etc.) 3503, the current time in the time zone applicable to the asset 3504, the asset's location 3505, information about the main threat contributing to that asset's risk score (e.g., the category of the threat, such as ‘security’, and the type of threat, such as ‘planned protest’) 3506, the asset's risk score 3507, which may include various graphical indicators of risk level or change, and the distance of the asset from the threat that the risk analysis platform has determined to be the most significant 3508.

Key asset summary cards 3509 are the same key asset summary cards 3403 of FIG. 34. The illustrated embodiment allows a user to configure the regional user interface view so that summary risk information about one or more key locations is maintained in the display. A user may ‘pin’ and ‘unpin’ key location summary cards 3509 to the display, depending on the information they want to see. This allows the user to navigate through the regional map view, while key asset summary cards 3509 remain on screen, displaying location risk information, such as, location name (e.g., city, country) 3510 and a current risk score for the location 3511. The risk analysis platform scores assets for risk using different risk profiles. Risk profiles are different vulnerabilities of an asset to particular types of outcome (e.g., vulnerability, consequence). Examples of risk profiles include life safety, asset protection, business continuity, and business reputation. Asset risk score 3511 may be a general score or a score for a particular risk profile. Key location summary cards 3509 also display risk trend information 3512, indicating changes in asset risk by using icons (e.g., arrows), numbers, text, or colors. A graphical or textual indication of a risk profile is displayed for each asset. For example, a user may have configured the view to show risk information for some locations in the life safety risk profile category 3513, for other assets in the risk profile category 3514, and for yet other assets in the risk profile category 3515.

In relation to moving assets, a local or regional map view may include a route plan showing anticipated risk at key points along the route, an alternative reroute plan with anticipated risk at key points along the route, a periodic update to the current map location of the moving asset, an overlay of traffic congestion areas on the map, an overlaid transit layer on the map showing nearby public transport stations, and other features useful for travelers and other moving assets. Data from external map provider services may be used.

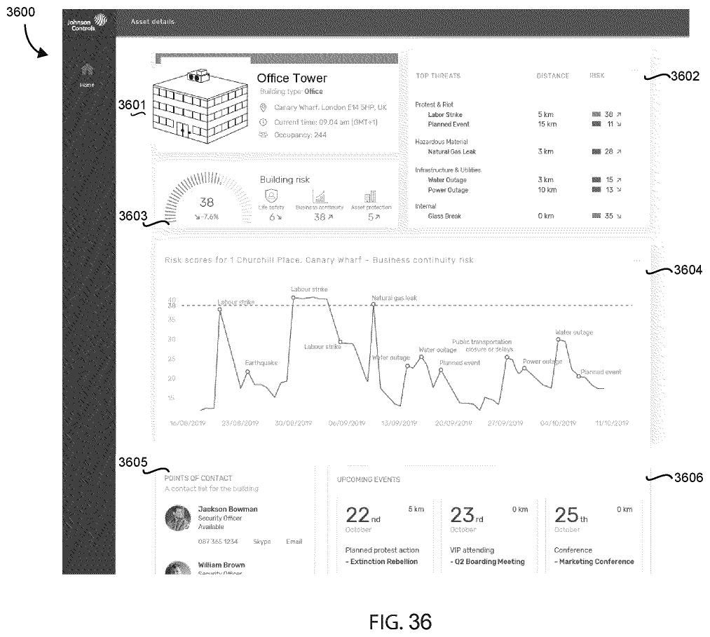

Referring now to FIG. 36, a user interface 3600 displaying detailed asset risk information about a monitored asset is shown. A user may select link 3418 of FIG. 34 to access a detailed view of the relevant asset, or select the asset details view in some other manner through the UI.

Asset risk view 3600 displays comprehensive and detailed risk information for the selected asset. Relevant data is taken from the risk analysis platform and presented on cards displaying the asset's details 3601, information about the top threats affecting the asset 3602, a summary of the asset's current risk status 3603, historical and current risk timeline information 3604, asset point of contact details 3605, and information about planned or forecast events affecting the asset 3606.

Asset detail card 3601 contains information such as asset name, asset image, asset type, asset location or address, current local time, and asset occupancy (e.g., a maximum occupancy value or a dynamic relative occupancy value from an occupancy model).

Top threats card 3602 displays information relating to the top external and internal threats (including alarms) affecting the asset and the asset's general risk scores associated with those threats, as well as risk trend information. Alternatively, top threat information could be filtered by risk profile, so that only top threats relating to, say, life safety could be displayed.

Asset risk card 3603 contains a current asset risk score (which may be the highest of a number of different risk scores for different risk profiles), one or more risk profile icons (indicating a risk profile, such as life safety, business continuity etc.), risk scores for each risk profile, and risk trend information, using icons (e.g., arrows), numbers, colors, or text. Various graphics and iconography may be used, such as risk profile icons and graphical indications of risk level.

Asset risk timeline card 3604 contains a line graph of historical, current, and upcoming threats affecting the asset that impacted the asset's risk score. Asset risk timeline card 3604 shows the changes in an asset's risk score over time, with significant threats marked. Each threat is associated with an asset risk score. A user can filter the information to show risk for one or more risk profiles. For example, a user may wish to view an asset's risk timeline with an interest in understanding the asset's business continuity risk. Alternatively, a user may wish to compare the asset's risk history for business continuity with the same asset's general risk history, or its history in another risk profile, such as life safety. In such cases, the risk timeline card 3604 may show two or more lines on the same graph, for comparison of risk histories. In the example timeline card shown, the current date is to the right hand side of the graph (i.e., Nov. 10, 2019) and the information displayed is historical. In alternative embodiments, the graph may also display future forecast or predicted risk scores and associated threats. The current date may be indicated on such a graph by means of a horizontal line or other indication. The timeline window may be configured by the user. A horizontal dotted line (or some other indication) on the graph may indicate the asset's typical risk score. This could be the asset's mean or median daily risk score for a relevant period. The indication of typical risk score provides the user with information of where an asset's current risk stands in relation to past and future risk. Alternatively, the graph may show a line or other indication showing an asset's minimum or maximum risk score over a relevant period, again for comparison. The user may click on a point on the timeline and the user interface changes to reflect the risk and threat data at that point in time.

Asset point of contact details card 3605 contains information about points of contact, such as photos, names, roles, whether available, contact information with links, etc. Points of contact could include employees or external agencies, such as emergency services or police. In alternative embodiments of card 3605, points of contact could be presented in order of availability or working hours.

Upcoming events card 3606 contains information about future events affecting the asset. Information such as date of event, distance of event from asset, event description, etc., are displayed. This information may be limited to key events in a short time window, such as a week, or may be configured to show information over a longer time period.

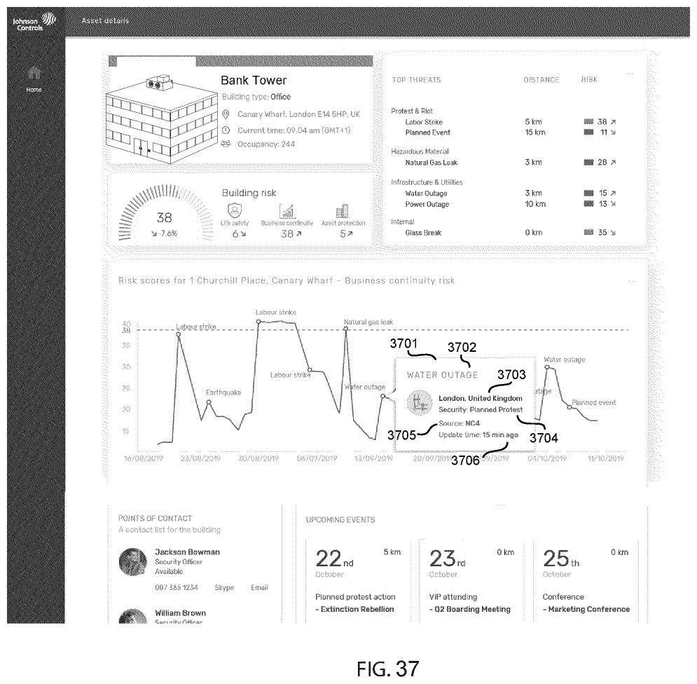

Referring now to FIG. 37, a user interface 3700 for a threat summary information element is shown. User interface 3700 displays when a user's cursor is hovered over an individual threat on asset risk timeline card 3604 of FIG. 36. A threat summary panel 3701 displays, giving a user more information about the key events that contributed to the risk score of the asset at that point in time. For example, threat summary panel 3701 shows a text and icon description 3702 of the threat referred to on the graph and associated with an asset risk score. The panel displays a threat location 3703, a category of threat (e.g., security), a description of the threat 3704, the source of the threat information 3705, and an elapsed time since the last update 3706.

Other useful information may be displayed to the user in the asset risk view of FIG. 36, such as an indication of the threats an asset is most vulnerable to, an asset's normal risk score, a top list of risk scores and associated threats for the past twelve months or other period, a link to a standard operating procedure (SOP) for different threats (e.g., suspicious package, bomb threat, etc.). This information may be derived from the risk analysis platform and displayed in the UI. In addition, the user interface could display links to other systems or information sources that may be configured for each asset or asset type.

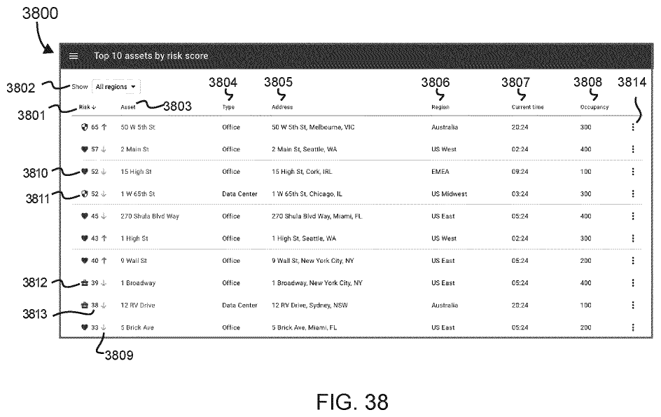

Referring now to FIG. 38, a user interface is shown for list of enterprise assets sorted by descending risk score 3801. Display data may be filtered 3802 in various ways, such as by region or by risk profile category. Each asset or asset class has been mapped in the risk analysis platform to one or more of a set of risk profiles. Asset risk profiles associate an asset with a vulnerability factor in relation to different categories of loss (or cost) arising from different types of threat. Examples of risk profile categories include life safety, asset protection, business continuity, and reputational damage. An asset's risk score in each risk profile category is calculated by the risk analysis platform. These scores may also be aggregated into a single, general risk score for the asset.

The risk analysis platform continually re-calculates risk for each monitored asset. As new risk scores are calculated, the displayed list of assets may update periodically as risk scores and key threat events change.

UI view 3800 displays each listed asset's name 3803, type 3804 (such as office, laboratory, data center, retail premises, employee, service vehicle, employee vehicle etc.), address or location 3805 (City, State, Country), region 3806, current local time 3807, and (where the asset can be occupied) occupancy 3808. The occupancy number may be a static maximum or may be a relative occupancy, calculated from live building data by a relative occupancy model of the risk analysis platform.

The risk column may include various graphical indicators providing additional information about an asset's risk score. For example, icons may indicate a risk profile category, such as life safety 3810, asset protection 3811, or business continuity 3812. The displayed risk profile category, in this example, matches the asset's risk category with the highest risk score. The risk analysis platform has scored the asset for risk across all its risk profile categories, but the highest scoring category is displayed as the asset's risk score. An arrow icon 3809 or other visual indication of risk trend indicates a rising, falling, or stable risk. A numerical risk score 3813 for the asset is displayed. Risk scores and icons may feature colors, such as those used in a Red, Amber, Green (RAG) system, to indicate levels of risk and changes in risk levels. Each asset list element includes an expansion icon 3814, with functionality allowing users to select a more detailed asset risk view.

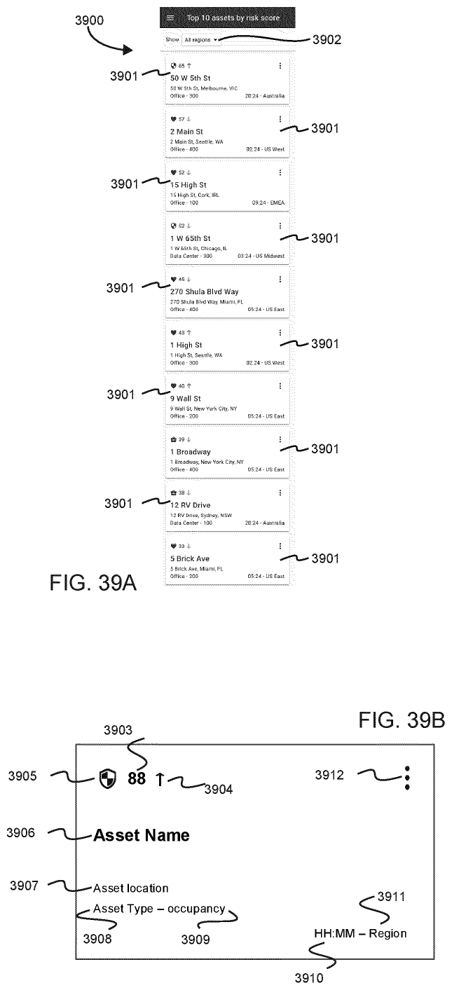

Referring now to FIG. 39A, a user interface 3900 displaying an alternative presentation of the list of enterprise assets of FIG. 38 is shown. This more compact user interface 3900 format may be displayed on a user's mobile device. Each asset list element is displayed in the form of a card 3901. The list of cards may be filtered in various ways 3902, as described in the description of FIG. 38. FIG. 39B is a detail view of card element 3901 of FIG. 39A showing the types of information that may be displayed. Asset card shows the asset's numerical risk score 3903, a visual indication of a risk trend, such as an arrow, 3904, a graphical indication of a risk profile category 3905, such as asset protection, the asset's name 3906, its location or address 3907, the asset's type (data center, office, etc.), the asset's occupancy 3909, the local time for the asset 3910, the asset's region 3911, and an expansion icon allowing a user to select a more detailed asset risk view.

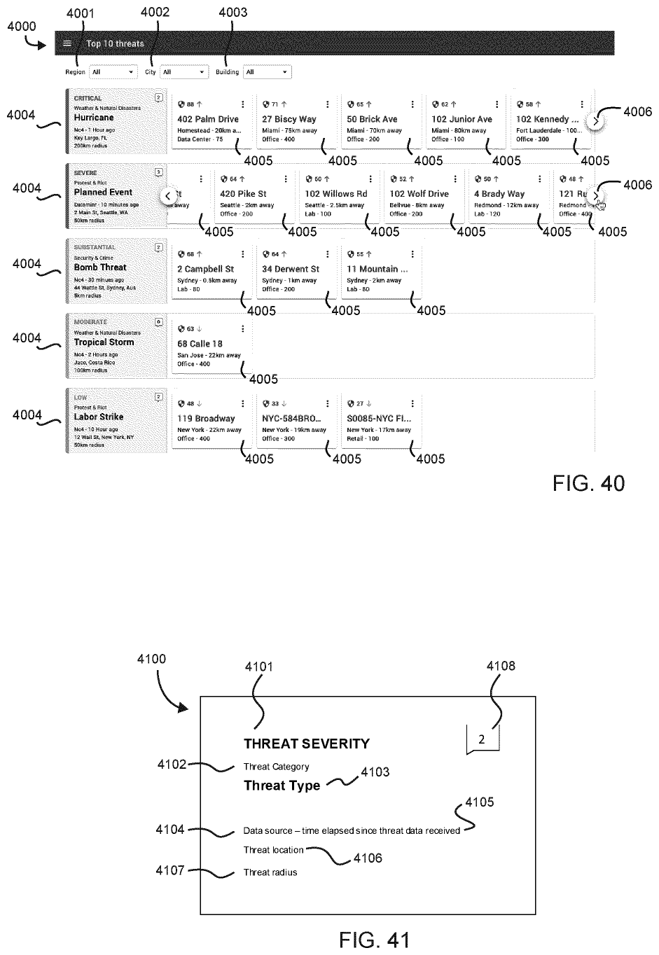

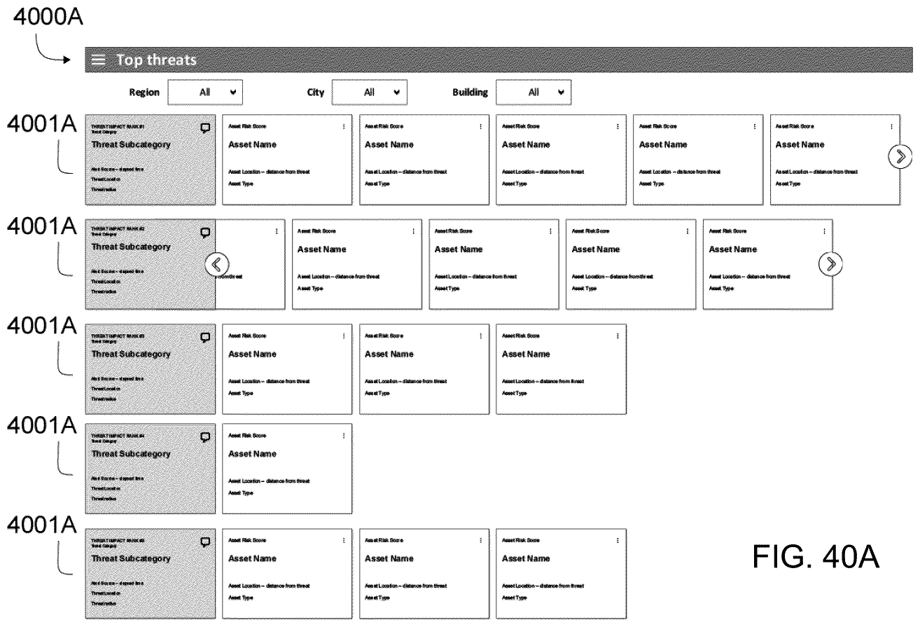

FIGS. 40, 41, 42, and 43 are drawings showing various presentations of a list of the top threats that contribute to overall risk to an enterprise and all its assets, ranked in descending order of its share of asset risk score. Each threat is ranked by the risk analysis platform by calculating the extent to which the threat contributes to the risk scores of the assets it affects. In other words, each threat's shares of individual asset risk scores are aggregated and used to rank the threat against other threats in order to generate a top threats list. For example, Building A has an overall risk score of 70 and there are two threats affecting it: ‘tropical storm’ and ‘labor strike’. Tropical storm threat contributes 65 points to the overall risk score, whereas labor strike threat contributes 5 points. In determining the priority of each of these threats, 65 points are attributed to tropical storm threat. Those points are aggregated with its share of the risk scores of any other affected assets. Similarly, labor strike threat is allotted 5 points from Building A and those points are aggregated with its share of the risk scores of other assets it affects.

Referring now to FIG. 40, a user interface of a top threats user interface display 4000 is shown. Top threats may be filtered in various ways, for example, by region 4001, city 4002, or building 4003. Filtering acts as a scoping function over a geographic region, territory, country, city location, or a defined collection of assets designated by the user, but could also include asset types or a custom collection of assets. Other filter categories may be applied, such as risk profile category (e.g., life safety, business continuity), threat type (e.g., cyber-security threats, weather and natural disaster threats), asset type, etc. For example, a user may filter top threats by selecting to view only ‘top bomb threats in EMEA’ or ‘top cyber-security threats affecting data centers’. The top threats with those attributes will be displayed in the UI. The top threats are displayed vertically in the form of threat summary cards 4004. Threats may be displayed in order of descending severity. Alternative methods of ordering the list of top threats may also be used, such as ordering threats according to the number of assets affected, in order of threat radius, number of assets affected, type or value of assets affected, expected threat duration, or current threat duration.

In some implementations, threats are ordered on the top threats user interface display 4000 using a classification algorithm and system that considers the highest asset risk scores and the number of assets impacted. This ensures that the threat that appears at the top of the top threats user interface display 4000 is more impactful and warrants higher prioritization compared to the threat that appears at the bottom of the list in the user interface display 4000.

Referring now to FIG. 40A, a method for assigning a relative impact score for a threat to an enterprise is shown, according to some embodiments. FIG. 40A shows an example of a user interface display showing top threats to an enterprise. In some embodiments, user interface display 4000A may show a list of threats 4001A in descending order of their impact on an organization, allowing an end user to view the threats that most, and least, impact the organization. The threat impact rankings may be assigned different terms in user interface display 4000A to indicate a degree of overall impact (e.g., high, medium, or low impact, or a number or some other relative impact categorization). In some embodiments, threats displayed in user interface 4000A may be ordered or filtered in various ways, for example, by descending order of threat impact ranking or filtered by risk profile category (e.g., asset protection, life safety, etc.).

Alerts are analyzed and aggregated to produce asset threat data. Asset threat data and asset risk scores are aggregated to produce threat impact scores in respect of assets. From an analysis of the percentiles of a distribution of threat impact scores for a set of assets and threats, a set of threat impact score thresholds with corresponding rankings on an ordinal scale may be derived. In order to assess the general impact of a threat on an enterprise as a whole, a mapping or ranking system is defined in the risk analysis platform that relates aggregated threat impact scores to relative threat impact rankings. In some embodiments, aggregated threat impact scores are numbers between 0 and 1. An example of a mapping structure is shown in Table 40A below, according to some embodiments.

TABLE 40A
example mapping of relative threat impact rankings
to aggregated threat impact score thresholds

| | Percentile | |
|---|---|---|
| Impact Score Threshold | (using sample data) | Relative Impact Ranking |
| >0.677 | >99 | 4 |
| >0.263, <=0.677 | >92.5, <=99 | 3 |
| >0.0667, <=0.263 | >70, <=92.5 | 2 |
| >0, <=0.0667 | >0, <=70 | 1 |
| 0 | 0 | 0 |

In Table 40A, a sample dataset of assets and threats has been analyzed and the distribution of threat impact scores has been divided into five percentile ranges ranked from 4 (most impact) to 0 (least impact). The results of the analysis and mapping may be displayed in the user interface of FIG. 4000A and provide a user of the system with a better understanding of what constitutes a high or low threat impact score in the context of an organization. In some embodiments, the percentiles may automatically be re-calculated based on analysis of new data, and threat impact score thresholds may be updated.

For each threat summary card, a list of affected assets is displayed horizontally, in the form of asset summary cards 4005. Asset summary cards 4005 may be displayed in left-to-right order of descending risk score. A scrolling function 4006 allows a user to scroll back and forth through each list of affected assets.

The list of top threats is an output of the risk analysis platform that ingests and processes alert and threat data, associates threats with monitored assets, aggregates the threat data, and calculates a risk score for each affected asset. Threats processed by the risk analysis platform may come from external data (representing an external threat, such as a threatening weather event) or internal data (representing an internal threat, such as the presence of a VIP in a building asset). The examples of assets shown in FIG. 40 are building assets, however the risk analysis platform may also calculate risk for other assets, such as people, mobile assets, machinery, or intangible assets.

FIG. 41 is a detail view of threat summary cards 4004 of FIG. 40. Threat summary card 4100 displays important information about the relevant threat. This information includes a severity indication 4101. Threat severity may be pre-determined in the system, derived by the risk analysis platform from threat data containing severity metadata, or calculated by the risk analysis platform. Threat summary card 4100 also displays a threat category indication 4102, which may be derived from a pre-determined list of threat categories that have been mapped to one or more threat types, and a threat type 4103, which may also be derived from mapping threat data to a pre-determined list of threat types. Examples of threat categories include ‘weather and natural disasters’ and ‘security and crime’. Examples of threat types include ‘hurricane’ and ‘bomb threat’. Threat summary card 4100 also includes an indication of a data source 4104, such as an online threat alert data provider (e.g. NC4, Dataminr). Also included in threat summary card 4100 is an indication of an elapsed time since the threat data was received 4105, a threat location 4106, and a threat radius 4107. Threat location and radius data may be derived by the risk analysis platform from threat data. Threat summary card 4100 also includes a graphical indication that one or more system users have added comments about the threat 4108. In the example shown, the graphic indicates that two comments have been added in relation to the threat.

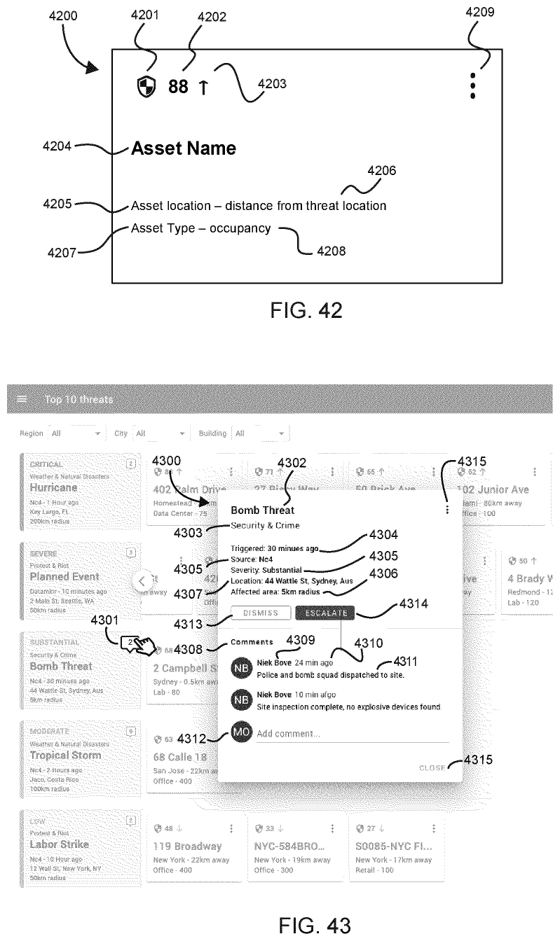

FIG. 42 is a detail view of an asset summary card 4005 of FIG. 40. Asset summary card 4200 displays an icon 4201 indicating a risk profile category (e.g., asset protection), being the risk profile category with the highest risk score applicable to that asset. A numerical risk score 4202 is displayed for the relevant asset. A graphical indication of a risk trend 4203 is also displayed. In the example shown, an upwards arrow is used to indicate that the risk score of the relevant asset is increasing. Asset risk scores and trend information are derived from the risk analysis platform. Asset summary card 4200 also displays an asset name 4204. Assets can be buildings, moving assets (e.g., vehicles), people, or intangible assets, such as goodwill or intellectual property. Also displayed are the asset's location 4205 and the distance of the asset from the threat 4206, being the threat summarized in the corresponding threat summary card 4004 of FIG. 40. The asset's type 4207 (such as building, vehicle, or employee category) and, where relevant to the type of asset, occupancy 4208 are also displayed. For a building asset, occupancy figures are provided by the risk analysis platform and may be a static maximum building occupancy or a dynamic relative occupancy, calculated by an occupancy model. An icon 4209 indicates that the asset summary card may be selected by a user to access a detailed view of the asset's risk score and other information. The detailed asset view is described further in another invention disclosure.

FIG. 43 is a detail view of a threat information panel that may be accessed by a user from interacting with the threat summary card 4004 of FIG. 40. A user may hover a cursor 4301 over a comments icon of the threat summary card (indicating a number of comments) and view a threat information panel 4300 showing important information about the threat. The information displayed in threat information panel 4300 is taken from the risk analysis platform, and includes the threat type 4302, threat category 4303, the time elapsed since the threat information was received 4304, the source of the threat data 4305, the severity of the threat 4306, and the location of the threat 4307. In addition, threat information panel 4300 displays a comments section 4308. A comment is displayed with a user identity 4309, an elapsed time since the comment was entered 4310, and the text of the comment 4311. Comments section 4308 also includes an input field for a user to enter a comment 4312. Finally, threat information panel 4300 displays buttons to dismiss 4313 or escalate 4314 the relevant threat. A link 4315 to a more detailed view of the threat is also displayed.

Interface 4000 of FIG. 40 may alternatively be displayed to users on mobile devices in a mobile-formatted fashion. Threat insight information may be viewed on a mobile device by impacted staff, travelers, visitors, and vehicles. The user interface may additionally allow a user to tag a threat to indicate that it is being watched.

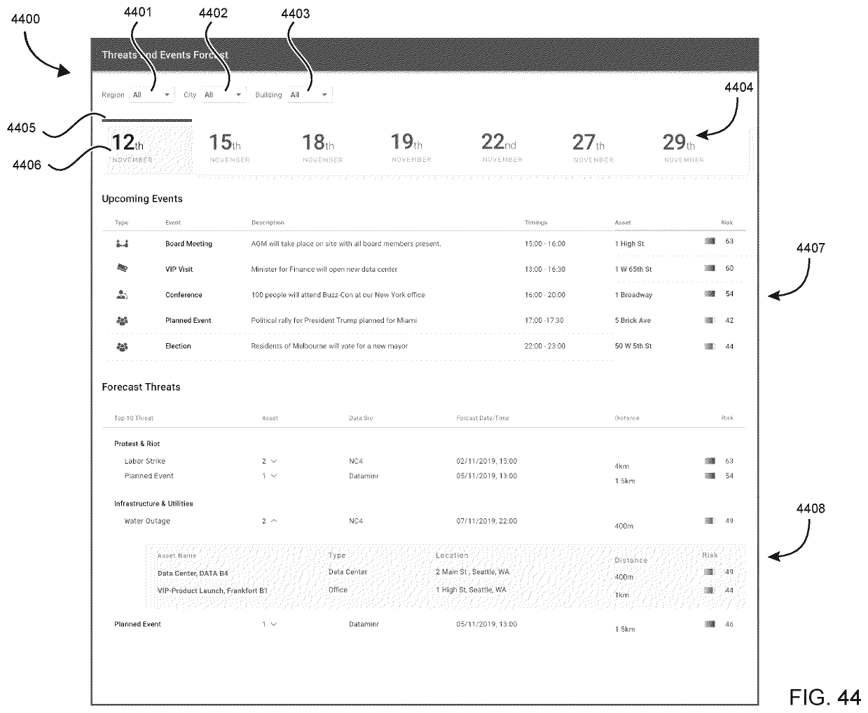

Referring now to FIG. 44, a user interface 4400 for the presentation of risk forecasts is shown. The risk forecast can be part of a system that monitors a large number of assets that are geographically dispersed. Users may want to see risk forecasts for all assets, or they may want to only see the information that applies to specific geographical regions or individual assets. In some embodiments, filtering options are provided in the user interface to select a geographical region 4401, a specific city 4402, or a specific building 4403. In some embodiments, filtering options may include limiting the displayed forecasts to asset types other than buildings, to an individual asset, to user-definable regions, to user-definable lists of assets, to assets within a specified time zone, or to use other criteria. Filtering may be applied in the user interface through the use of drop-down lists, groups of radio buttons or check boxes, or another user interface element. After a user selects filtering options, the user interface may refresh immediately to present the filtered information, or may require the user to manually apply the filters by interacting with a user interface element.

In some embodiments, the risk forecasts are grouped by calendar date. This may be presented in the user interface by a horizontal list of calendar dates 4404, where each calendar date is presented in a date format appropriate for the user's region 4406. The currently selected day may be indicated by a horizontal bar 4405 that is placed directly above the date 4406, by using color to shade or highlight the foreground or background, by changing properties of the font used to display the date, or by some other method. In some embodiments, the user clicks a date to view the risk forecast for that day.

In some embodiments, the list of dates 4404 includes only those dates that have relevant data associated with them. For example, days that do not have either events or threats associated with them may be removed from the list. In this way, the user does not need to navigate through the calendar to look for significant information. Instead, the user interface displays only significant information.

In some embodiments, the list of dates 4404 includes only dates that are in the future, at the time when the list is viewed. In some embodiments, the current date is included, and may be included even if there are no associated events or threats. In some embodiments, one or more dates in the past may be included, as compared to the time when the list is viewed. The user interface may include clear indication of which dates are past, present, and future, through the use of color, shading, labelling, or other visual method.

In some embodiments, the list of dates 4404 is scrollable, such that the list of dates can move either horizontally or vertically to display additional dates. The user controls this scrolling through interaction with the UI. For example, the user may click and drag the dates to scroll them. In some embodiments, the user can adjust the number of dates that are included in the list, either by quantity of dates to include, specifying a date range, or through some other method. In some embodiments, there is a representation of a larger time period, which includes an indication of which dates have relevant data associated with them, and also indicates which portion of the larger time period the list of dates 204 currently represents.

In some embodiments, the user interface features distinct sections to display upcoming events 4407 and forecasted threats 4408 that are associated with the selected date. The functionality of these sections is described in further detail below.

In some embodiments, events are planned occurrences, which are known about in advance. Examples may include board meetings, conferences, political rallies, elections, festivals, or sports matches. Having an awareness of events can aide in planning for and responding to threats. For example, if the road in front of a building will be closed for a parade, fire wardens can be instructed to evacuate people through side and rear exits if the need arises.

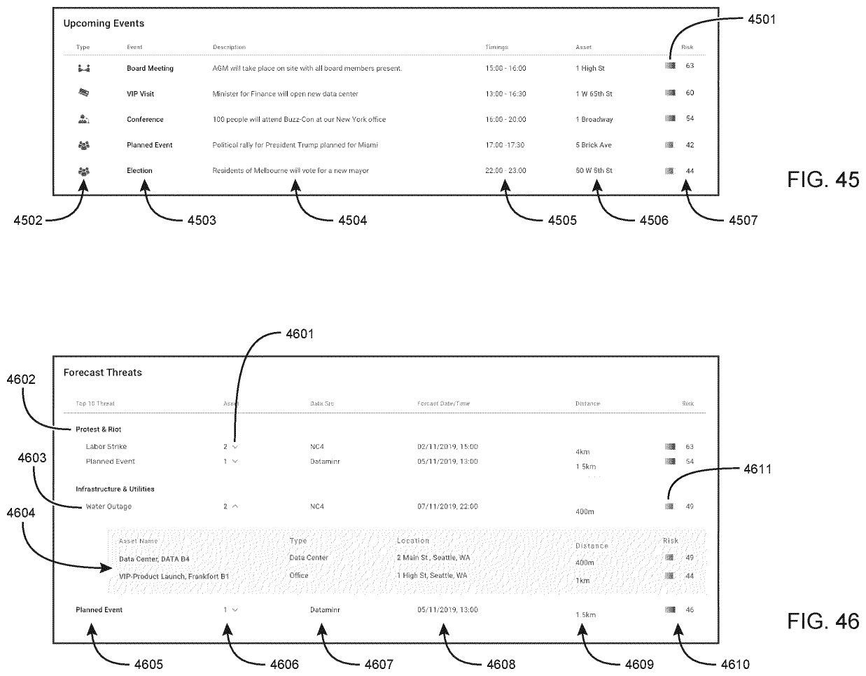

Referring now to FIG. 45, a user interface for upcoming event information is shown according to an example embodiment. Events, for the purposes of this embodiment, are considered to be any known or planned activity that has a date or a date combined with a time and a fixed or rolling duration. In the embodiments, these events are known about in advance. Examples may include board meetings, conferences, political rallies, elections, festivals, or sports matches. Having an awareness of events can aide in planning for and responding to threats. For example, if the road in front of a building will be closed for a parade, fire wardens can be instructed to evacuate people through side and rear exits if the need arises.

Event information may be presented in a tabular format, with a row for each event, and columns for data that may include the type of event 4502, a title for the event 4503, a description of the event 4504, the scheduled time that the event will begin and end 4505, the asset that the event affects 4506, and what the forecasted risk score 4507 is for the duration of the event. In some embodiments, the user is able to configure which columns are displayed. In some embodiments, the risk score 4507 is the maximum score that is predicted to occur during the event. The risk score 4507 may also be derived from an average of predicted risk scores during the event, or through some other mathematical method calculated by the risk analysis platform. If the event is scheduled across more than one day, the calculation of the risk score 4507 may be limited to the portion of the event that will occur on the selected day. In some embodiments, in addition to a numerical risk score, the user interface displays a graphical representation of risk 4501. For example, a colored rectangle may be displayed, where the color used is chosen from a gradient color scale.

Referring now to FIG. 46, a user interface for a forecasted threat for which there is prior warning is shown. These may be scheduled or forecasted events that are determined to result in a calculable change in the risk score of an asset, and may have an external or internal source. In some embodiments, forecasted threats may be presented in a tabular format, with a threat on each row, and columns for information that may include threat categorization 4605, the number of assets that are affected by the threat 4606, the data source that provided the threat information 4607, the forecasted start date and time 4608, the distance between the threat and the asset 4609, and the forecasted risk score 4610. In some embodiments, in addition to a numerical risk score, the user interface displays a graphical representation of risk 4611. For example, a colored rectangle may be displayed, where the color used is chosen from a gradient color scale.

Forecasted risk scores are calculated with regard to affected assets. The system determines which assets are affected by each threat type. The distance 4609 and risk 4610 attributes for a forecasted threat are derived from the assets associated with that threat. The attributes may be taken from the asset with the highest risk score, the closest asset, or from an asset selected by another means. One or more attributes may also be derived mathematically from the attributes of the associated assets. For example, the attributes displayed for the forecasted threat may be averages of the attribute values of the associated assets.

Temporal decay may be calculated as occurring between the anticipated start time of a threat and the start of the date that is being viewed, the anticipated start time of a threat and the middle of the date that is being viewed, the anticipated start time of a threat and the midpoint of the overlap between the threat and the date that is being viewed, or two other temporal points.

In some embodiments, the table of forecasted threats displays a fixed number of threats. The threats may be selected for inclusion based on their forecasted risk scores for the assets with which they are associated. For example, the table may display the ten threats that have the highest forecasted asset risk scores.

In some embodiments, rows for threats 4603 are grouped by threat category, and displayed under a heading for that threat category, for example, 4602. The order of threat categories in the table may be determined from the forecasted risk scores of threat types within that category, and be based on summing the risk scores, averaging the risk scores, taking the highest value risk score, or use some other mathematical method.

In some embodiments, the user interface includes a feature to display information about the assets that are affected by the forecasted threat. The user may click on an icon 4601 adjacent to the asset count to toggle the display of the asset data, or they may use some other user interface element. A table that contains information about the assets 4604 may be displayed. This table may be nested within the forecasted threats table and placed adjacent to the forecasted threat with which the assets are associated. The information included in the nested table may include the asset's name, the asset's type, the asset's location, the distance between the asset and the threat, and the forecasted risk score.

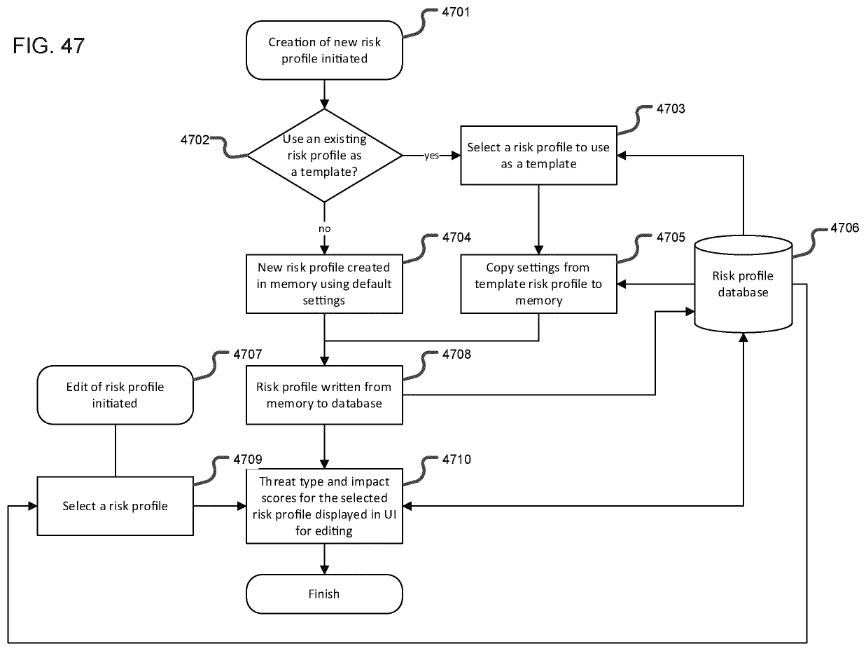

Referring now to FIG. 47, a process to create a new risk profile is shown. The user chooses to create a new risk profile by selecting a control in a UI, or through some other method (4701). If the user decides to copy settings from an existing risk profile (4702), then the user selects the risk profile to use as a template (4703), and the data for that risk profile is loaded from the database (4706) and stored in memory (4705). Alternatively, the user may instruct the system to create default data in memory for the new risk profile (4704), such as setting all numerical values to be halfway between their minimum and maximum values or set to zero to 100. In some embodiments, the representation of the new risk profile stored in memory is written to the database (4708). After the new risk profile has been created, the user is presented with a UI, in which they can edit the risk profile (4710), and save the risk profile back to the database (4706).

A risk profile may be edited after it is created (4707). In some embodiments, the risk profiles that a user has permission to modify are retrieved from a database, and presented in the user interface as a list. An individual risk profile is then selected for editing (4709).

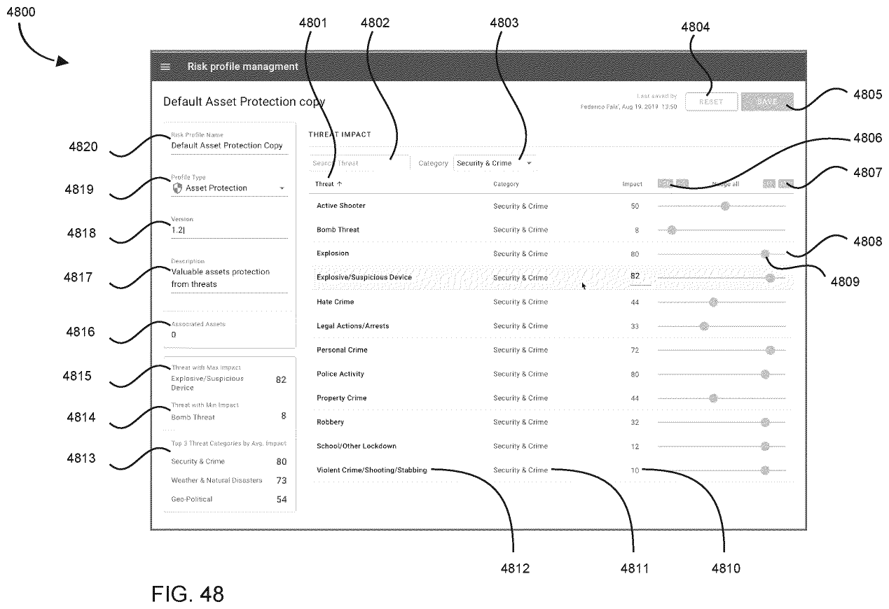

Referring now to FIG. 48, a user interface for editing one or more risk profiles is shown. In some embodiments, all threat types that are part of a risk profile are retrieved from a database, along with associated impact values, which relate to the vulnerability component of the TVC model. In some embodiments, the user selects a threat category from a user interface element 4803, which causes the information for threat types in that category to be displayed in the user interface as a list 4800. The information displayed for each threat type may include the name of the threat type 4812, the threat category that the threat type is part of 4811, and the impact value 4810 associated with the threat type. In some embodiments, the impact value associated with each threat type can be adjusted through the UI. For example, a slider control may be provided for each threat type, consisting of an impact value index mark 4809 that the user can select and drag to a new position, and a track 4808 that conveys the limits and direction of the path that the impact value index mark 4809 can be dragged along. The position of the impact value index mark 4809 along the track relates to the numerical value 4810 of the impact value. The relationship may be linear, such that when the impact value index mark 4809 is at one end of the track, the impact value is set to its minimum value; when the impact value index mark 4809 is located at the opposite end of the track, the impact value is set to its maximum value; and when the impact value index mark 4809 is located halfway along the track, the impact value is halfway between the minimum and maximum values. The relationship may be logarithmic, exponential, or use some other mathematical conversion. In some embodiments, adjusting the position of the thumb causes a numerical representation of the impact value 4809 to display an equivalent value.

In some embodiments, the numerical representation of the impact value 4810 can be modified directly, for example, by selecting the value in the user interface and entering a new value through a keyboard or other method. Entering a numerical value may cause the thumb 4809 to move to an equivalent position along the track 4808.

In some embodiments, individual impact values can be increased or decreased by clicking on-screen buttons, placing the mouse pointer at a specified location on the screen and using the mouse's scroll wheel, clicking a location on a linear or radial graphic, or by some other means.

In some embodiments, the user can simultaneously increase or decrease the impact values for all threat types in a chosen threat category. In doing so, the user increases or decreases the impact of the threat category as a set. In some embodiments, the functionality is provided through a pair of buttons in the user interface 4806 and 4807, with one to increase and one to decrease the impact values. Each pair of buttons may modify all of the impact values by the same defined amount. For example, there may be a button that the user can click to increase the impact value of all threat types by 10 units 4807, and a button that the user can click to reduce the impact value of all threat types by 10 units 4806. Multiple buttons may be provided, with each pair adjusting the impact values by a different amount. In some embodiments, the values for the impacts may be modified by a percentage of their maximum value, by a percentage of their current value, or by some other fixed or variable amount. In some embodiments, the user may adjust all of the impact values in a threat category through a user interface control other than a button. For example, there may be a slider, whereby dragging a graphical element along the length of the slider increase or decreases the impact value for all threat types within a category by an amount proportional to the distance that the graphical element is moved.

In some embodiments, a search string can be entered into a field in the user interface 4802, which causes the list of threat types to be filtered, such that only threat types with names that partially or fully match the search string are displayed. In some embodiments, headings 4801 at the top of the list of threat types can be clicked to display the data in ascending or descending order, with the sorting performed on the attribute that corresponds to the heading.

Impact values that have been adjusted in the user interface may be transferred to the database automatically when any impact value is adjusted, automatically at regular intervals, manually through the use of a feature in the user interface such as a save button 4805, or through some other method. In some embodiments, a user interface element 4804 can be used to reset the impact values to the values that are stored in the database. In some embodiments, a user interface control can be used to reset the impact values to match the values in a chosen risk profile template or other default values.

In some embodiments, after the updated impact values are written to the database, all risk scores are recalculated for a selected asset associated with the risk profile as a part of validating the effect of the change. In some embodiments, updated risk scores are calculated and presented to the user for review. This review process enables a user to verify the suitability of the updates before they are applied. If the user approves the updates, they are applied system wide and all users see the recalculated scores from that time onwards. In some embodiments, when the user is editing a risk profile, the user can select one or more assets that are associated with that risk profile. The risk scores related to the selected assets may be displayed in the risk profile editor UI. When impact values are adjusted, risk scores are recalculated based on the updated impact values and the recalculated risk scores are displayed in the user interface for comparison purposes.

In some embodiments, the user can specify a time and date when the modified risk profile will become active. For example, a user may be aware of a future event that will alter the risk profile for an asset, such as the installation of flood defenses, and pre-emptively define a new risk profile to come into effect on the date of scheduled completion. In some embodiments, multiple risk profiles can be defined and applied on a schedule. For example, a school may have separate risk profiles defined for semester and holiday periods, based on the significant changes in student presence.

The user can enter appropriate metadata, which may include a name for the risk profile 4820, a profile type 4819, a version number 4818, or a description 4817. The metadata may appear in listings of risk profiles 4819.

In some embodiments, the risk profile management user interface displays a count of the number of assets that have been associated with the currently active risk profile 4816. The system may block the deletion of a risk profile that is associated with one or more assets.

In some embodiments, the user interface may display summary data related to the risk profile that is being edited. The summary data supplies information to assist a user in modifying threat impact factors. Example data may include the threat that currently has the highest impact value 4815, the threat that currently has the minimum impact value 4814, and the threat categories that currently have the highest average impact value 4813. The user interface may display the threat type or threat category and a corresponding numerical value. The user can consult this summary data to ensure that threat impact values are appropriately represented, for example, that the most significant threat type has the highest impact value.

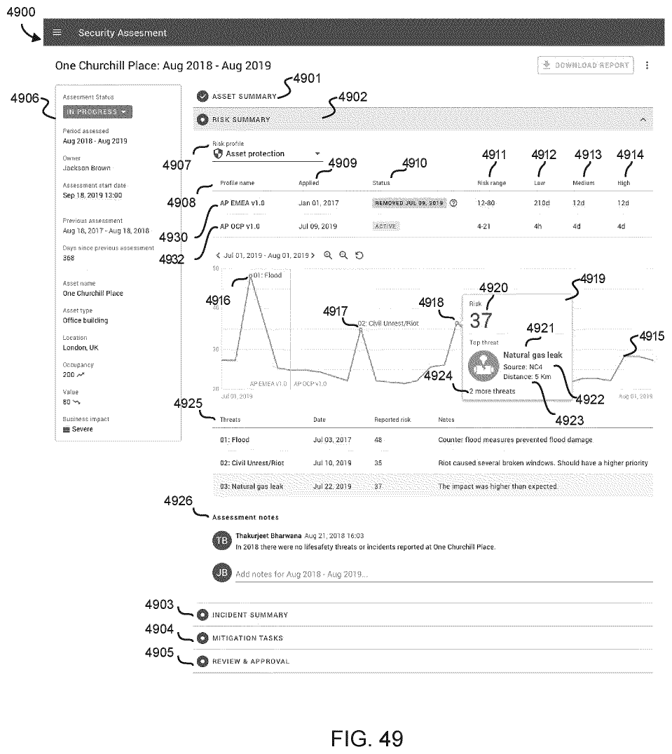

Referring now to FIG. 49, a user interface 4900 for a security posture assessment of an asset is shown. The user interface 4900 for a security posture assessment of an asset provides functionality enabling a user to initiate and edit an assessment, which automatically uses and displays the relevant data and calculations from a risk analysis platform. In the disclosed example, the asset is a building, but other types of assets may be assessed using the user interface 4900 for a security posture assessment of an asset.

UI 4900 displays the following sections of a security posture assessment: asset summary 4901, risk summary 4902, incident summary 4903, mitigation tasks 4904, and review and approval 4905.

Asset summary section 4901 is not shown in an expanded form in user interface 4900, but may include relevant information about the asset, such as asset name, asset description and key attributes, a summary of key changes for the asset since the last risk review, user comments on asset summary changes (e.g., “sublet floors one and two from July”, “reduction in staff of 4900 PAX”, “new security turnstiles requiring employees to use badges on entry and exit”.), and other risk-relevant information. For a building asset, an asset summary section may also include information such as the number of direct employees and contractors, total square footage of the building, the percentage of space occupied by the enterprise in a shared building, whether there is branded signage on or in a building. The summary may also include information about the activities carried on in the building, such as trading, financial, call center, datacenter, etc. Information may also include details about physical risk mitigation factors, such as vehicle barriers, pedestrian barriers, security offices, security dog patrol, and other similar information. Technical risk mitigation information may be included, such as the number of access controls on a perimeter and the number and locations of closed circuit television (CCTV) cameras. Information about a facility's preparedness may be included, such as evacuation procedures, device health data (e.g., security blind spots), and whether equipment inspections are up to date. Such information may be taken from various systems, such as the building access control system, security system, business data and records, as well as from security operators, who may enter such asset details using the tool.

The user interface 4900 for a security posture assessment of an asset allows a user to select an asset to assess, select a review type (e.g., annual, half-yearly, interim.), configure basic security posture assessment attributes, and set a status of the security posture assessment (e.g., ‘in progress’, ‘paused’, ‘ready for approval’, ‘completed’.). The tool automatically records who is conducting the review (based on a user's account), when it started, when it completed, and the date of the last security posture assessment for the relevant asset.

An assessment status card 4906 displays high level details about the assessment and asset under review. For example, assessment status card 4906 shows the progress of the review, the period assessed, the start date of the assessment, the period of any previous assessment and elapsed time since it took place, the asset name, type, location, occupancy (and trend), value (and trend), and business impact. An asset value may be a number representing the monetary value of an asset and may be normalized and be accompanied by some graphical indication of a change in value, e.g., a downward arrow indicating depreciation.

Risk summary section 4902 may present historical risk data aggregated by campus, city, country, region, or asset geofence, over a given date range, broken down by risk profile (e.g., asset protection). A user may select a risk profile category (e.g., asset protection risk) from the drop down menu 4907. A list of risk profiles 4908 is displayed. A risk profile may be for a region 4909, country, city, campus, or asset 4910. For each listed profile, summary information is displayed, such as the date the profile was applied 4909, profile status 4910 (e.g., ‘active’), a risk score range applicable to the profiles 4911, and the elapsed times since the lowest 4912, medium 4913, and highest 4914 risk scores were recorded.

Risk summary section 4902 displays a line graph 4915 showing historical risk summary information about the asset over a pre-defined or user-selectable period. Line graph 4915 displays key risk scores for the asset over the selected time period, and each key risk score is labelled with an associated top threat (see 4916, 4917, and 4918). By hovering a cursor over a risk score point, such as risk score 118, a risk and threat summary panel 4919 is displayed. Summary panel 4919 displays the risk score 4920, basic information about its associated top threat 4921, threat information source 4922, distance between asset and threat 4923, and a selectable link to information about other threats 4924, if applicable. Risk summary section 4902 additionally displays a list of the applicable risk scores and associated top threats for the asset 4925, showing the threat description, date of threat, reported risk, and notes or narratives from users.

Risk summary section 4902 also displays assessment notes 4926 that can be entered by users, giving more information or context to a building's risk review. The information display of risk summary section 4902 is shown only as an example. In other embodiments, risk summary section 4902 may also display other useful information about risk, such as average actual risk scores over a period for different risk profiles, indications of whether actual risk scores were higher or lower than an average for another period, benchmark comparisons of actual average risk for an asset compared to other assets in the same or other regions, data relating to current risk profiles for an asset and when they were applied, information showing when and why a risk profile changed for an asset, etc.

Incident summary section 4903, allows a user to search and view single incident history, search closed incidents by date and location to find and select an incident, view an incident's history and how it was responded to, view a summary of all incidents and threats for a single building, campus, city, country, or arbitrary geofence (which may be selected through a map view). Summary incident information may be selected by a user within a date range, with breakdown by incident type and outcome. A user can access the history from an incident list (closed incidents) or from a building profile page that shows summary information for a selected building.

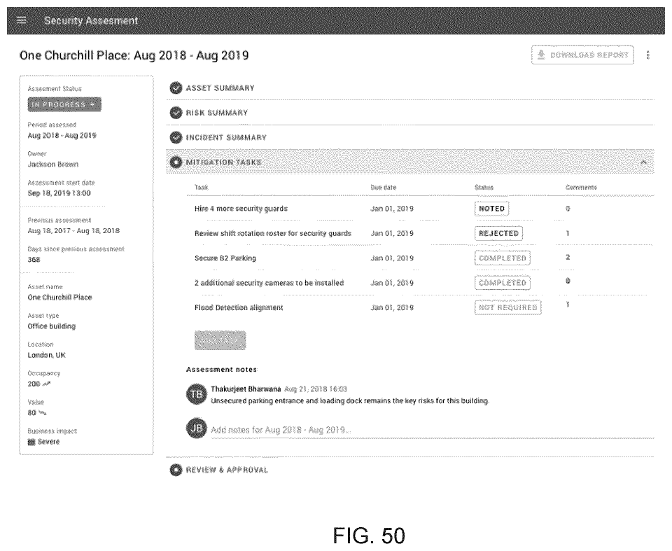

Mitigation tasks section 4904 allows a user to review the risk mitigation tasks for an asset, and is described further below in relation to FIG. 50.

Review and approval section 4905, may contain a section allowing a user to mark the security assessment as reviewed and approved, record who reviewed and approved the assessment, change the status to ‘completed’, record who reviewed and approved the security assessment, and download a copy of or email a link to the security assessment review.

Referring now to FIG. 50, the user interface of FIG. 49 is shown with an expanded view of the mitigation tasks section 4904 of FIG. 49. Mitigation tasks section 4904 of FIG. 49 allows a user to review a list of risk mitigation tasks for an asset, review comments on those tasks, view or edit the status of tasks (e.g., drop down list with values ‘noted’, ‘completed’, ‘not implemented’, ‘not required’, ‘reviewed’, ‘rejected’), enter comments on tasks (e.g., ‘N/A’, ‘implemented on mm/dd/yy’, etc.), and add new risk mitigation tasks. A user may also enter comments about the risk assessment for the asset.

Other information delivered through the security posture assessment tool includes the number and type of incidents in a building, national crime index scores, breakdowns of events in different crime categories, information about points of interest and their proximity, information about nearby infrastructure (e.g., fire stations, hospitals, police stations), transportation information (e.g., bridge or tunnel, bus station, ferry terminal, train station), and nearby facilities.

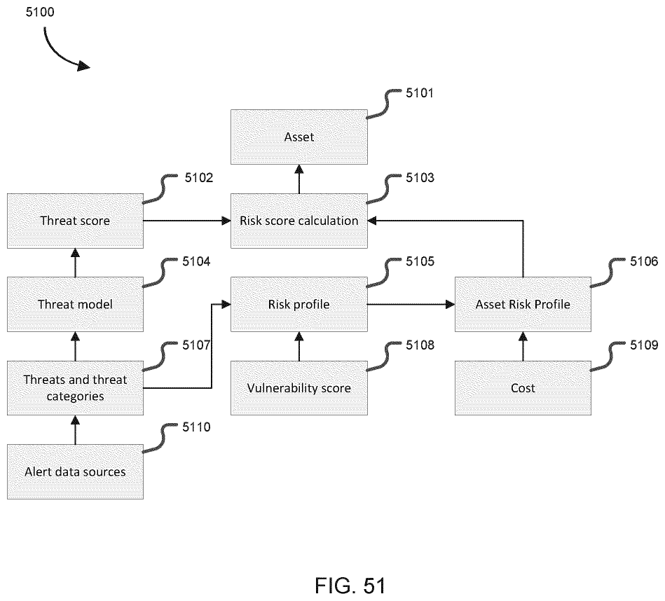

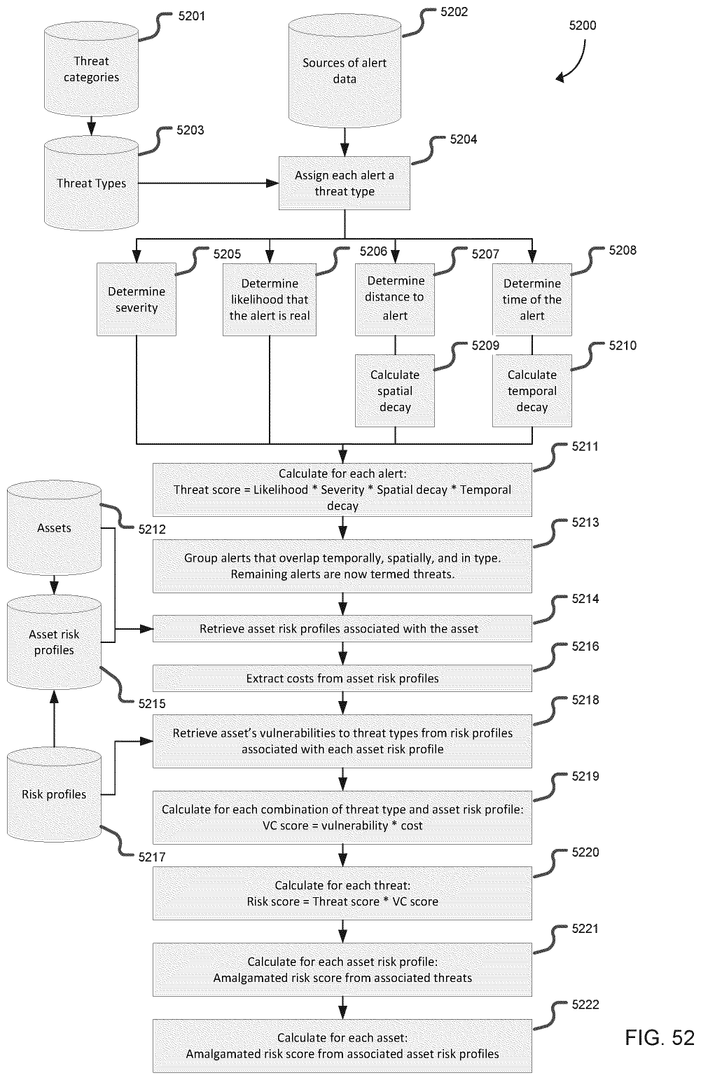

Referring generally to FIGS. 51 and 52, systems and methods are shown for dynamic analysis of threat to assets and calculation of a threat score and risk score for an asset.

The components that contribute to the calculation of risk scores for assets are shown in FIG. 51, according to some embodiments. A risk score is calculated by multiplying the factors for threat 5102, vulnerability 5108, and cost 5109, as they apply to an asset 5101. This is termed the threat-vulnerability-cost (TVC) model.

Alerts and other threat-related data are ingested from a variety of data sources 5110. These may include police reports, traffic reports, and social media posts. Alerts and other threat event information may originate from within an asset. For example internal events originating from alarms or incidents within a building. Alerts and other threat-related data may be ingested directly from the source or obtained from a third-party provider, which may process and amalgamate the data in advance.

Alerts are mapped to a preconfigured threat type 5107. The system may use natural language processing (NLP) to analyze the description of the alert, and then identify an appropriate corresponding threat type. In some embodiments, similar threat types are grouped into threat categories. For example, the threat types of robbery, bomb threat, and drug seizure may be grouped into a threat category named Security and Crime.

The threat model 5104 calculates a threat score based on the likelihood that the threat referred to by the alert is real, and the severity of the threat that it poses. Both likelihood and severity parameters may be normalized to a scale between 0 and 1, such that they can be multiplied together to calculate a threat score in the range of 0 to 1. The threat model deduces appropriate values for the likelihood and severity parameters by analyzing the alert metadata.

Threat scores may decay according to multiple factors. Threat scores may decay spatially 5209, such that as the distance between the asset and the alert increases, the amount of decay increases. The fact that different threats exhibit different spatial decay characteristics is factored into the calculation of spatial decay. Threat scores may decay temporally 5210, such that as more time passes since the alert was generated, the amount of decay increases. Each decay factor may include a lower boundary, below which there is effectively no decay. Each decay factor may include an upper boundary, above which the decay is absolute, and the resulting threat score is effectively zero. Between the upper and lower bounds, the severity may decay linearly, discretely, polynomially, or through some other method. Decay factors may be configured independently, and vary between threat types.

Threat score=Likelihood×Severity×Spatial decay×Temporal decay

In some embodiments, if any threats that originated from alerts overlap in space, time, category and sub-category then the system groups these similar threats together 5213. Threats overlap in space if their maximum radii of effect intersect. Threats overlap in time if their originating alerts occur within the time window defined by the upper boundary for that threat type'. Threats overlap in category and sub-category if their system calculated values for these parameters match. Threats that are grouped together are processed as a single, combined threat with a single threat score. If a threat does not overlap with any other threats, then it is processed as a single unique threat.

An asset 5101, for which risk scores are calculated, may be any entity that can be exposed to threats. Assets may be both static and mobile. Example assets include buildings, equipment, vehicles, animals, and people. Assets may also be non-physical, such as a company's reputation. The calculation of risk for a building may include an assessment of threats in relation to the physical building, as well as the equipment and people within that building.

A risk profile 5105 is a preconfigured mapping of threats and threat categories to vulnerability scores. For each threat type, or each threat category, that is configured in the system, a vulnerability score is assigned. The vulnerability score is a measure of the impact that a particular threat type or threat category could have on an asset for that risk type. In some embodiments, the vulnerability is normalized to a scale between 0 and 1.

In some embodiments, risk profiles 5105 are associated with assets 5101 through the use of asset risk profiles 5106. This enables a single risk profile to be defined, which is then associated with all assets. It also enables groups of similar assets to share a common risk profile, each asset to have its own unique risk profile, multiple risk profiles to be associated with multiple assets, or any other mapping of assets to risk profiles.

The asset risk profile 5106 associates threat types and threat categories with a cost 5109. The cost is a measure of the maximum potential loss that could be incurred. The cost may represent a financial loss, a loss of life, a loss of productivity, or some other measure. If a single risk profile is associated with an asset, the cost may quantify the total loss of the asset. Where multiple risk profiles are associated with a single asset, each risk profile may represent a category of potential loss. Example focuses for risk profiles include life safety, business continuity, asset protection, business reputation, and investment value. For example, if the risk profile relates to life safety, then the cost is a measure of the total loss of life that could occur. If the risk profile is related to asset protection, then the cost may be a measure of the maximum financial cost that could be incurred if the asset were completely destroyed. In some embodiments, the cost is normalized to a scale between 0 and 1. The asset risk profile generates a vulnerability-cost (VC) value 5219 for each combination of asset and threat.

VC score=Vulnerability×Cost

In some embodiments, the risk score 5103 is calculated as a product of the threat score and the VC score.

Risk score=Threat score×VC score

Risk scores 5220 are calculated for each threat. These risk scores are aggregated to produce a single risk score for each asset risk profile 5221. The risk score for the asset risk profile may be based on the highest risk score, an average of the risk scores, or calculated through some other mathematical process. Similarly, the risk scores for all asset risk profiles that are associated with an asset may be aggregated to produce a single representative risk score for the asset.

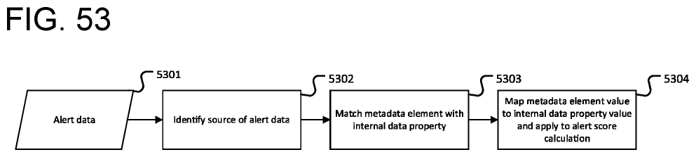

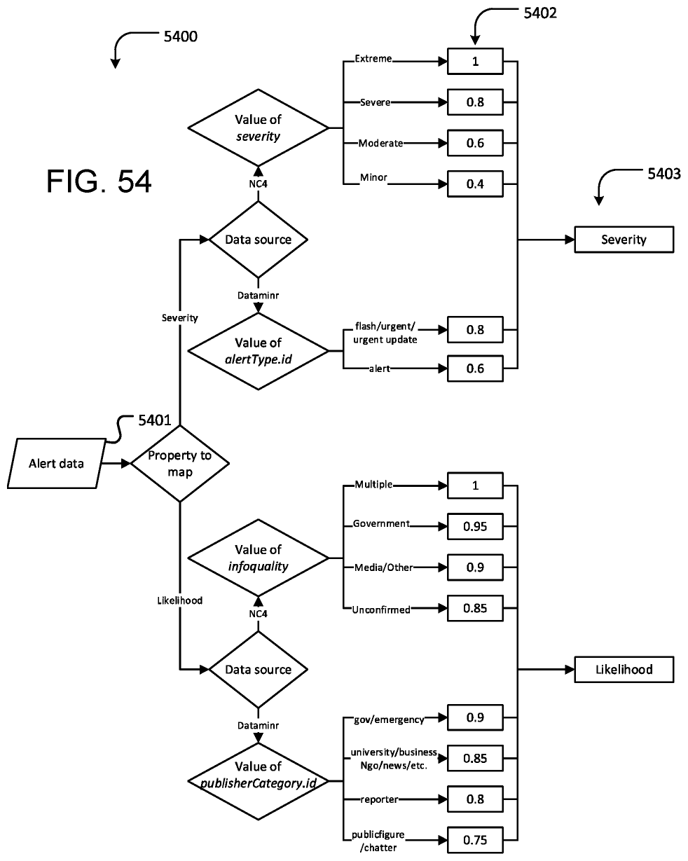

Still referring to FIG. 51 and FIG. 52 and now also referring generally to FIG. 53 and FIG. 54, further methods of deducing appropriate values for the likelihood and severity parameters of an alert are shown, according to some embodiments. The determination by threat model 5104 of severity 5205 and likelihood 5206 for an alert may further comprise the independent but equivalent sub-processes shown in FIG. 53. Data for each alert 5301 includes metadata elements and values. Each external data provider may use different metadata to describe alerts, including alert severity and an indication of the source of information used by the external data provider (e.g., government or media sources, multiple sources, social media chatter, etc.). Threat model 5104 may identify the external data provider of the alert 5302, identify, based on the identified external data provider, each appropriate alert metadata element of the alert to map to an internal data property 5303 of threat model 5104, and then map the value of the selected metadata element of the alert to a pre-determined value for the corresponding internal data property 5304 of threat model 5104. An example of a mapping of metadata elements of an alert to internal data properties of threat model 5104 is shown in Table 53A below. In the example shown, the external data providers are NC4 and Dataminr and the internal data properties relate to a severity property and a likelihood property.

TABLE 53A
example mapping of alert metadata elements
to internal data properties of threat model

External data provider's metadata element

| NC4 | Dataminr | Internal property |
|---|---|---|
| severity | alertType.id | Severity |
| infoquality | publisherCategory.id | Likelihood |

An example of a set of mappings 5304 of metadata values to internal property values are shown in Table 53B (in respect of alert severity) and Table 53C (in respect of alert likelihood) below. In these examples, the metadata elements use discrete category labels, which are mapped by threat model 5104 to pre-determined numerical values. In some embodiments, not all possible internal threat model property values have an equivalent metadata element value. In Table 53B and Table 53C, threat model property values that do not have an equivalent metadata element value are represented by an en dash (−). In some embodiments, a pre-determined numerical value in respect of the likelihood property is based on a measure of reliability of the external data source together with the value of the metadata element that is mapped to the internal data property for likelihood. For example, in Table 53C, where an alert received from external data source NC4 has a metadata element mapped to the internal data property for likelihood (indicated by NC4 by the metadata label ‘infoquality’) and that metadata element has value ‘Multiple’, the pre-determined numerical value for likelihood has been set to 1 (certain). Where the NC4 value for the same metadata element is ‘Government’, a lower numerical value (0.95) for likelihood has been set.

TABLE 53B
example mapping of alert metadata values
to threat model's severity value

| Metadata element values | | Value for |
|---|---|---|
| [NC4] severity | [Dataminr] alertType.id | severity |
| Extreme | — | 1 |
| Severe | flash/urgent/urgent update | 0.8 |
| Moderate | alert | 0.6 |
| Minor | — | 0.4 |

TABLE 53C
example mapping of alert metadata values
to threat model's likelihood value

| Metadata element values | | |
|---|---|---|
| [NC4] | [Dataminr] | Value for |
| infoquality | publisherCategory.id | likelihood |
| Multiple | — | 1 |
| Government | — | 0.95 |
| Media/Other | gov/emergency | 0.9 |
| Unconfirmed | university/business/ngo/news/ | 0.85 |
| | majorblog/localnews/blog | |
| — | reporter | 0.8 |
| — | publicfigure/chatter | 0.75 |

In some embodiments, the process shown in FIG. 53 is performed in a different order, by combining the sub-processes of FIG. 53, by splitting those sub-processes, or by some combination thereof. In some embodiments, the process shown in FIG. 53 is performed as a single action through a method similar to that shown in FIG. 54. A decision tree 5400 may be used by threat model 5104 to determine data property values 5402 from alert data 5401 and then map values 5402 to the appropriate internal properties 5403.

In some embodiments, where the metadata element values of an alert are represented numerically, there may be a mathematical relationship between the metadata element values and the threat model's internal data property values. The mathematical relationship may vary depending on the supplied metadata element value.

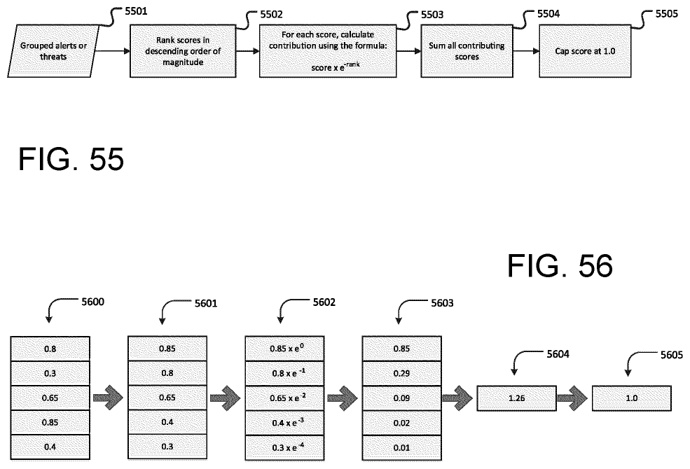

Still referring to FIG. 52, and now also referring generally to FIG. 55 and FIG. 56, further methods of aggregating groups of alerts, which are termed ‘threats’, to calculate threat scores and aggregating threat scores and asset risk scores are described, according to some embodiments.

Risk analysis system may aggregate data at various levels in order to calculate threat scores and risk scores. For example, multiple threat scores 5211 may be aggregated to calculate a single risk score 5220 in respect of a threat. Similarly, multiple risk scores may be aggregated to calculate amalgamated risk scores for each asset risk profile 5221 and amalgamated risk scores for each asset 5222. At each level of aggregation, individual threat or risk scores must be combined to produce a single score.

Referring now to FIG. 55, a process for amalgamating scores is described, according to some embodiments. The process may be applied at multiple levels within the risk analysis system, and may be used to amalgamate both threat scores and risk scores.

A group of scores 5501 in respect of grouped alerts or threats is created through some method. For example, it may be determined that a set of alerts relate to the same threat, and so should be amalgamated. The alerts may be scored, for example using alert severity and source metadata, and those scores may be amalgamated to create a threat score. The scores are ranked in the group in descending order of magnitude 5502. The contribution of each score is then calculated by multiplying it by e^{-rank}, where the highest magnitude score is assigned the rank of zero, the second highest score is assigned the rank of 1, and so on 5503. The individual contributions are then summed 5504 to calculate the amalgamated score. In some embodiments, scores are restricted to a range between 0 and 1. Any amalgamated scores that exceed 1 are reduced to 1.

Where (a₁, a₂, . . . aₙ) is a list of scores in ascending order, the process of calculating an amalgamated score can be described mathematically as follows:

$$amalgamated score = min \{ 1 , {\sum }_{i = 1}^{n} {a}_{i} {e}^{- ( i - 1 )} \}$$

Referring now to FIG. 56, an example of an application of the process of FIG. 55 is shown, according to some embodiments. Each of a group of scores 5600 is ranked in descending order 5601, multiplied by e^{-rank} 5602 to calculate their individual contributions 5603, and then summed 5604. In this example, the amalgamated value is greater than 1.0, and is therefore reduced to 1.0 5605. The method of aggregation described in relation to FIG. 55 and FIG. 56 beneficially combines scores in a manner that enables each contributing score to be appropriately represented in the amalgamated score.

In some embodiments, the assets may be mobile assets, such as people or vehicles. The location of the mobile asset may be tracked through the use of GPS, GSM/GPRS, WiFi, or other known method. The dynamic risk system may be continuously updated as to the asset's changing location, or the updates may be more periodic. In some embodiments, a user manually updates the location of an asset. For example, an individual that is travelling may themselves be considered as an asset, and they may manually update the system with their location by accessing the system through their mobile device. As an asset moves, the distances change between that asset and threats, and risk scores are recalculated in response to the changing distances. The asset's movements may take it outside of the effective radius of some threats, and into the effective radius of other threats.

In some embodiments, part, or the entirety, of a mobile asset's planned route may be known. The dynamic risk system may analyze both existing threat data and data about known future threats to predict risk scores for part, or the entirety, of the journey. The system may incorporate information about the speed of the asset, transport schedules, road traffic reports, or similar, in order to add predicted times to points along the route. The system can then predict threats that may coincide with the asset's location at a point in time. For example, the system may have access to an individual's flight details, and use that anticipated time and location information to identify any relevant threats, such as extreme weather or worker strikes.

In some embodiments, some or all of the features available in the dynamic risk system are accessible through a mobile device. In situations where a person is linked to a mobile asset in the system, that person can review information, such as the current and predicted threats that apply to them, as well as their overall risk score.

In some embodiments, hypothetical assets can be defined in the system. These are processed by the system as though they were standard assets, but they do not have any real-world equivalent. One use for hypothetical assets is in the creation of simulations. For example, when determining whether to construct a new building on a specific site, a hypothetical asset can be defined at that location first. The system can identify threats and calculate a risk score for the asset. A user can adjust risk profile parameters and view their effect on the calculated risk. The adjusted risk profile parameters can then be used to inform the design of the building. For example, it may be determined that to achieve an acceptable level of risk for the building, it must be designed with a reduced vulnerability to floods and loss of power. When risk is being assessed in relation to a new construction, or a similar project that has an extended lifetime, additional data sources may be harvested to identify longer-term threats. For example, planning applications, political manifestos, and low-frequency natural disasters.

In some embodiments, the dynamic risk system is integrated into other systems. Methods of integration include, but are not limited to, the dynamic risk system reading or writing to a database that is shared with another system, the dynamic risk system providing an API that is accessed by another system, and the dynamic risk system accessing an API that is provided by another system. Integrations may allow the dynamic risk system to accept data input at any stage in its processes, and to output data at any stage in its processes.

In some embodiments, the dynamic risk system receives data from an external system that then modifies cost calculations. For example, an access control system could provide a building occupancy count, which would affect loss of life calculations. In some embodiments, the dynamic risk system receives data from an external system that then modifies vulnerability parameters. For example, a fire alarm system could notify the dynamic risk system that the fire alarms are currently disabled, which could increase the building's vulnerability to fire. In some embodiments, the dynamic risk system accepts structured threat data that bypasses part or all of the risk calculation process. A security system within a building could detect a broken window, and then access the dynamic risk system's API to provide data about the threat; bypassing the alert categorization and overlap tests. A similar security system could fully assess the risk of a threat, and then provide the dynamic risk system with a risk score and accompanying threat data.

In some embodiments, the dynamic risk system identifies a situation that should be acted upon, and communicates the information to an external system. Example external systems include incident management systems, systems that coordinate the execution of standard operating procedures (SOPs), mass notification systems, and security systems. The determination to act upon a situation includes calculating a threat score that exceeds a specified threshold value and calculating a risk score that exceeds a specified threshold value. Thresholds may vary depending on the type of threat or risk profile. For example, the dynamic risk system could determine that a threat score for a burglary has exceeded a threshold, communicate the information to an SOP system, which then initiates an investigation from a security guard. In some embodiments, the decision to initiate communication with an external system is made by a user. The user interface provides functionality to communicate relevant information to an external system when viewing risk information, threat information, or some other part of the system. For example, upon seeing that a building's risk score relating to loss of life is unacceptably high, a user may command the dynamic risk system to communicate with an alarm system, which would then initiate an evacuation of the building. Where affected assets are individual people, the dynamic risk system can instead communicate with a mass notification system, which would then send SMS messages to the affected users.

In some embodiments, the dynamic risk system is used to run simulations. This may include commanding the full system to enter a simulation mode. Alert data may also be tagged to indicate that it is simulated. Simulated alert data may be created in an external system, and ingested into the dynamic risk system in the same manner as other alert data, or it may be created within the dynamic risk system. When operating in a simulation mode, or when processing simulated data, some functionality may be disabled. For example, during simulation, alerts may be displayed on screens and alarms may be triggered within a building, but the system may block automatic notifications that would be sent to emergency services. Running a simulation may cause additional log data to be generated, which can be used to review information such as what actions were taken and at what times.

In some embodiments, an output of the dynamic risk system may be a “what if” analysis feature. For example, a user may select an arbitrary geo-location for a fictitious asset, and data and calculations from the risk analysis platform may be used to provide historical and current risk perspectives. This type of analysis may be used for making real estate or other asset investment decisions, for assessing the risk in planning a corporate event at a new venue, or for travel advisories.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

While the present disclosure is directed towards risk management systems and methods involving assets, e.g. buildings, building sites, building spaces, people, cars, equipment, etc., the systems and methods of present disclosure are applicable to risk management systems and methods for responding to alerts, collection, aggregation, and correlation of alerts and threat data, analysis of alerts as indications of threats, other risk analytics, and risk mitigation for functions, operations, processes, enterprises for which risks can be profiled based on risk related characteristics and parameterized.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A risk management system comprising:
one or more computer-readable storage media having instructions stored thereon that, when executed by one or more processors, cause the one or more processors to:
receive threat data indicating potential threats to one or more of a plurality of assets located in a plurality of geographic locations, the plurality of assets comprising at least one of buildings, spaces, equipment, or people;
calculate asset risk scores for the plurality of assets indicating estimated risk levels for the assets using asset risk profiles for the assets and using the threat data, the asset risk profiles reflecting characteristics of their respective assets; and
generate a graphical user interface comprising a map providing visual representations of one or more of the assets, the visual representations of the one or more of the assets indicating locations of the assets and asset risk scores of the assets.

2. The risk management system of claim 1, wherein the map further comprises a visual representation of one or more of the potential threats, the visual representation of the one or more potential threats comprising a radius representing an estimated spatial impact of the threat.

3. The risk management system of claim 1, wherein the graphical user interface further comprises a portion providing an asset summary for a first asset of the plurality of assets, the asset summary providing the asset risk score of the first asset and a trend indicating a change in the asset risk score of the first asset.

4. The risk management system of claim 3, wherein the graphical user interface further comprises a portion providing a current asset risk score for the asset and a risk score trend for the asset illustrating the asset risk scores for one or more prior times of the plurality of times of the timeframe.

5. The risk management system of claim 1, wherein the graphical user interface includes a portion displaying an ordered list of one or more of the potential threats, the list comprising a threat location and a risk score of the potential threats in relation to the assets affected by the potential threats.

6. The risk management system of claim 1, wherein the asset risk score for the asset is calculated over a plurality of times over a timeframe, the asset risk score indicating estimated risk levels for the asset at the plurality of times, the asset risk profile reflecting characteristics of the asset.

7. A risk management system comprising:
one or more computer-readable storage media having instructions stored thereon that, when executed by one or more processors, cause one or more processors to:
receive threat data indicating potential threats to one or more of a plurality of assets, the potential threats associated with a plurality of threat categories and the plurality of assets comprising at least one of buildings, spaces, equipment, or people;
generate risk scores indicating estimated risk levels for the plurality of assets using the threat data, wherein the risk scores are calculated based on data registered in one or more asset risk profiles configured for each of the plurality of assets, the one or more asset risk profiles containing a plurality of characteristics of the asset, the plurality of characteristics of the assets being parameterized in a risk score calculation process; and
generate a first graphical user interface comprising, within a single interface, a consolidated view of risks and threats displaying two or more of the plurality of threat categories and, for each of the two or more categories, a list of one or more assets impacted by a potential threat associated with the threat category and a risk score for each of the one or more assets, the list of one or more assets ordered based on the risk scores of the assets.

8. The risk management system of claim 7, wherein the asset risk profile for an asset further comprises an impact weight for each threat type.

9. The risk management system of claim 7, wherein the risk management system determines a resources dispatch recommendation responsive to a threat to an asset, wherein the resources dispatch recommendation is scaled according to a risk score for the asset and threat data correlated to the asset, the threat data collected from one or more external data sources comprising at least one of a social media source, an emergency services communication source, a data subscription source, and a building management system sensor report source.

10. The risk management system of claim 9, wherein the risk management system modifies
the first impact weight according to the user modification to generate a first modified impact weight, wherein the first modified impact weight is applied through the risk profile to the generation of a first risk score for a first asset.

11. The risk management system of claim 7, wherein the graphical user interface further comprises a risk score trend visualization, the risk score trend visualization displaying indications of events corresponding to particular historic risk scores under a selected risk profile.

12. The risk management system of claim 7, wherein the risk management system further generates, using the threat data and an asset risk profile for an asset, a first risk score for an asset at a present time, the first risk score indicating an estimated risk level for the asset based on the potential threats associated with the asset at the present time.

13. The risk management system of claim 7, wherein the risk management system further generates, using the threat data and an asset risk profile for the asset, a second risk score for the asset at a future time, the risk scores indicating an estimated risk level for the asset based on the potential threats associated with the potential threats at the future time.

14. The risk management system of claim 7, wherein the risk management system for a particular timeframe including the future time, a list of the potential threats and the associated risk scores of the potential threats for the asset.

15. The risk management system of claim 7, wherein the risk management system further generates a second graphical user interface, the second graphical user interface comprising a map providing visual representations of one or more of the assets, the visual representations of the one or more of the assets indicating locations of the assets and asset risk scores of the assets.

16. The risk management system of claim 7, wherein the risk management system further generates a third graphical user interface, the third graphical user interface comprising a map providing visual representations of one or more of the assets, the visual representations of the one or more of the assets indicating locations of the assets and asset risk scores of the assets, the asset risk scores indicating, for a particular timeframe including the future time, the asset risk scores indicating potential threats in relation to the assets at the location of the asset at a time of the timeframe.

17. A method for scoring a threat to an asset, comprising:
receiving data for an alert relating to an asset threat;
identifying an external data source of the data for the alert data relating to the asset threat;
mapping, based on the identification of the data source, a metadata element of the data for the alert relating to the asset threat to an internal data property of a threat model; and
associating a value of the metadata element with a pre-determined value for the internal data property of the threat model, wherein the internal data property of the threat model relates to a likelihood of a threat being real.

18. The method of claim 17, further comprising assigning a relative threat impact score to the asset threat, wherein the threat impact score is determined by aggregating threat scores and risk scores for a set of asset threats.

19. The method of claim 17, further comprising grouping of alert data from a plurality of received alerts relating to an asset to define a single threat to the asset, wherein a first received alert is grouped with a second received alert according to a clustering analysis of one or more of an alert spatial parameter and an alert temporal parameter of each received alert.

20. The method of claim 19, further comprising constraining the clustering analysis by applying a set of neighbor parameters, the set of neighbor parameters defined in respect of a pre-defined threat category.
